(19) United States
(12) Patent Application Publication
(10) Pub. No.: US 2023/0276111 A1
(43) Pub. Date: Aug. 31, 2023

(54) VIDEO PROCESSING

(71) Applicant: Nahum Nir, Tel Aviv (IL)

(72) Inventor: Nahum Nir, Tel Aviv (IL)

(21) Appl. No.: 18/091,365

(22) Filed: Dec. 29, 2022

Related U.S. Application Data
(63) Continuation-in-part of application No. 17/412,216, filed on Aug. 25, 2021.
(60) Provisional application No. 63/294,403, filed on Dec. 29, 2021.

(51) Int. Cl. H04N 21/81; G06T 3/40; G06T 7/70; G06T 17/00; G06V 10/25; H04N 19/172

(52) U.S. Cl. CPC H04N 21/816; G06T 3/40; G06T 7/70; G06T 17/00; G06V 10/25; H04N 19/172; G06T 2207/10024; G06T 2207/20132

(57) ABSTRACT

A method and a computer product for processing video streams. The computer product is a virtual camera configured to: obtain a sequence of video frames from the video source; generate a sequence of alternative frames; the virtual camera computer product is implemented using program instructions that are executable by a processor, the virtual camera computer product comprises: an areas determination module, said area determination module is configured to: obtain a first frame from the video source; determine a first interesting area comprised by the first video frame displaying an image of an object, whereby determining a first non-interesting area, wherein the first non-interesting area is a complement, in the first video frame, of the interesting area; a first processing channel configured to: process the first video frame based on the first interesting area, whereby determining a first interesting alternative frame; write the first interesting alternative video frame to a shared memory location; a second processing configured to: process the first video frame based on a non-interesting area, whereby determining a first non-interesting alternative frame; write the first non-interesting alternative video frame to the shared memory location, whereby generating the first alternative frame of the alternative video stream, wherein the video stream, when encoded, is associated with a first footprint, wherein the alternative video stream, when encoded, is associated with a second footprint, wherein the second footprint is smaller than the first footprint, wherein a video software is configured to obtain the alternative video stream frame by frame.

### CROSS-REFERENCE TO RELATED APPLICATION

The present application is a continuation in parts patent application and claims the benefit of provisional patent applications No. 63/294,403 filed Dec. 29, 2021, titled “Video Processing” which is hereby incorporated. The provisional application No. 63/294,403 claims priority benefit with regard to all common subject matter, of earlier-filed U.S. patent application Ser. No. 17/412,216, filed Aug. 25, 2021, titled “VIDEO COMPRESSION AND STREAMING” which is hereby incorporated by reference in its entirety without giving rise to disavowment.

### TECHNICAL FIELD

The present disclosure relates to video streaming in general, and to reducing video streaming bandwidth, in particular.

### BACKGROUND

Media stream may be a multimedia that is constantly produced by a provider and received by a recipient. The received media stream may be presented to an end-user while being delivered by the provider. The verb “to stream” may refer to the process of delivering or obtaining media in this manner; the term may refer to the delivery method of the medium, rather than the medium itself, and may be an alternative to file downloading, a process in which the recipient may obtain the entire file for the content before watching or listening to it.

A recipient end-user may use their{HYPERLINK “https://en.wikipedia.org/wiki/Media_player_(software)” \h} to start playing{HYPERLINK “https://en.wikipedia.org/wiki/Digital_video” \h} or digital audio content before the entire file has been transmitted. Distinguishing delivery method from the media distributed applies specifically to{HYPERLINK “https://en.wikipedia.org/wiki/Telecommunications_network” \h}, as most of the delivery systems are either inherently streaming (e.g. radio, television, streaming apps) or inherently non-streaming (e.g. books,{HYPERLINK “https://en.wikipedia.org/wiki/Videotape” \h}, audio CDs). For example, in the 1930s,{HYPERLINK “https://en.wikipedia.org/wiki/Elevator_music” \h} was among the earliest popular music available as streaming media; nowadays{HYPERLINK “https://en.wikipedia.org/wiki/Internet_television” \h} is a common use case of streamed media.

Live streaming may be the delivery of content in real-time such as live television broadcasts, online lectures, online meetings, or the like. Live internet streaming may require a phone or more of source media (e.g. a video camera, an audio interface, screen capture software), an encoder to digitize the content, a media publisher, and a content delivery network to distribute and deliver the content. Live streaming does not need to be recorded at the origination point, although it frequently may.

### BRIEF SUMMARY

One exemplary embodiment of the disclosed subject matter is a virtual camera computer product retained a non-transitory computer readable medium, wherein the virtual camera is configured to: obtain a sequence of video frames from the video source, whereby obtaining a video stream frame by frame; generate a sequence of alternative frames, whereby generating an alternative video stream; the virtual camera computer product is implemented using program instructions that are executable by a processor, the virtual camera computer product comprises: an areas determination module, said area determination module is configured to: obtain a first frame from the video source, wherein the first frame comprised by the sequence of video frames; determine a first interesting area comprised by the first video frame, wherein the first interesting area is displaying an image of an object, whereby determining a first non-interesting area, wherein the first non-interesting area is a complement, in the first video frame, of the interesting area; a first processing channel configured to: process the first video frame based on the first interesting area, whereby determining a first interesting alternative frame; write the first interesting alternative video frame to a shared memory location; a second processing configured to: process the first video frame based on a non-interesting area, whereby determining a first non-interesting alternative frame; write the first non-interesting alternative video frame to the shared memory location, whereby generating the first alternative frame of the alternative video stream, wherein the video stream, when encoded, is associated with a first footprint, wherein the alternative video stream, when encoded, is associated with a second footprint, wherein the second footprint is smaller than the first footprint, wherein a video software is configured to obtain the alternative video stream frame by frame.

Optionally, configured to process the first video frame based on the interesting area comprises cropping the first video, wherein the first interesting alternative frame is of the same width and height as the first interesting area.

Optionally, configured to process the first video frame based on the interesting area comprises upscaling the first interesting area in the first video frame, wherein the first interesting alternative frame is of the same width and height as the first interesting area.

Optionally, wherein said configured to process the first video frame based on the non-interesting area comprises deflating the non-interesting area in first video frame.

Optionally, configured to process the first video frame based on the non-interesting area comprises setting the interesting area in first video frame to a single value.

Optionally, a frame comprised by the video stream is of a raw video format, wherein the raw video format comprises a luminance plane, wherein said configured to determine a first interesting area comprised by the first video frame comprises: determining, based on the luminance plane of the first video frame a partial RGB representation of the frame; providing the partial RGB representation of the frame to an object detection model; and obtaining from the object detection model a definition of a rectangle, wherein an image of the object displayed in the first frame is bounded by the rectangle.

Optionally, the virtual camera computer product is configured to: obtain a second frame from the video source, wherein the second frame comprised by the sequence of video frames, wherein the second frame is ordered after the first frame in the sequence of video frames; determine, to utilize a dimensions of the first interesting area in order to determine a second interesting area comprised by the second video frame, wherein the second interesting area is displaying another image of the object, whereby avoiding to utilize the object detection algorithm; determine, based on the frames per seconds parameter to utilize the first non-interesting alternative frame as an alternative to determining a second non-interesting alternative video frame; write the second interesting alternative area to the shared memory location, whereby generating a second alternative frame of the alternative video stream, wherein the second alternative frame comprises the second interesting alternative area and the first non-interesting alternative area.

Optionally, the virtual camera computer product is configured to: obtain a context information, wherein the context information comprises information regarding utilization of the virtual camera computer product; wherein said configured to determine a second interesting area comprises: determining, based on the context information, that an activity level associated with the object is below a threshold, wherein said determine to utilize the first non-interesting alternative frame as an alternative to determining a second non-interesting alternative video frame is based on the activity level and on the threshold.

Optionally, the virtual computer product is configured to: obtain a context information, wherein the context comprises information regarding utilization of the virtual camera computer product, wherein the second non interesting area is defined as a complement of the second interesting area; based on the context information, determining that an activity level associated with the first non-interesting area and the second non interesting area is below a threshold; and determine to utilize the first non-interesting area as an alternative to the second non-interesting area, whereby avoiding to determine a second non-interesting alternative video frame.

Optionally, the virtual camera computer product, wherein the video source is associated with a frames per seconds parameter, wherein said determining to utilize a dimensions of the first interesting area in order to determine a second interesting area is based on the frames per seconds parameter.

Optionally, the virtual camera computer product, wherein said area determination module is configured to obtain an auxiliary frame from an auxiliary video source; wherein said area determination module is configured to utilize the auxiliary frame to process an area of the frame.

Optionally, The virtual camera computer program product, wherein said first processing channel is configured to replace a person appearing in an area with an avatar.

Optionally, the virtual camera computer program product of Claim 12, wherein replacement of the person by the avatar is performed by a cloud computer, wherein the first processing channel is configured to provide the first interesting area to the cloud server, wherein the first processing channel is configured to obtain the avatar therefrom.

Optionally, the virtual camera computer program product, wherein said video stream is in first format, wherein said alternative video stream is in a second format, wherein the first format and the second format are different.

Optionally, the virtual camera computer program product, wherein the one or more video frames obtained by the area determination module are associated with a frame rate, wherein each video frame comprised by the one or more video frames is associated with a resolution, wherein the one or more alternative video frames are associated with the frame rate, wherein each video frame comprised by the one or more alternative frames is associated with the resolution, wherein encoding a plurality of video frames yields a video stream having a first footprint, wherein encoding a plurality of alternative video frames yields an alternative video stream having a second footprint, whereby the second footprint 20% or less of the first footprint.

Yet another exemplary embodiment of the disclosed subject matter is a method comprising: obtaining, by a virtual camera implemented in a computerized device, a first video frame, wherein the first video frame is comprised by a sequences of video frames; determining a first interesting area comprised by the first video frame, wherein the first video frame comprised by the sequences of video frames, wherein the first interesting area is displaying an object, whereby determining a first non-interesting area; processing the first video frame based on the first interesting area in a first processing channel, whereby determining a first interesting alternative video frame; writing the first interesting alternative video frame to a shared memory location; processing the first video frame based on the first non-interesting area in a second processing channel, whereby determining a first non-interesting alternative video frame; writing the first non-interesting alternative video frame a shared memory location, wherein a video software is configured to utilize the first alternative video frame, wherein utilizing the first alternative video frame comprises encoding the first alternative video frame; obtaining a second video frame from the video source, wherein the second video frame appears after first video frame in the sequence of video frames; determining a second interesting area comprised by the second video frame, wherein the second interesting area is displaying the object; processing the second video frame based on the second interesting area in the first processing channel, whereby determining a second interesting alternative video frame; and writing the second interesting alternative video frame to the shared memory location, whereby the shared memory location comprises a second alternative video frame, wherein the second alternative video frame comprises the second interesting alternative video frame and the first non-interesting alternative video frame, wherein the video software is configured to utilize the second alternative video frame, wherein utilizing the second alternative video frame comprises encoding the second alternative video frame, wherein a video stream comprising the first and second video frames, when encoded, is associated with a first footprint, wherein an alternative video stream comprising the first and second alternative video frames, when encoded, is associated with a second foot print, wherein the second footprint is smaller than the first footprint.

Optionally, the method comprises a video frame comprised by the sequence of video frames is of a raw format, wherein the raw format comprises a luminance plane, wherein said determining the first interesting area comprises: determining, based on the luminance portion of the video frame, a partial Red Green Blue (RGB) representation of the first video frame; providing the partial RGB representation of the first video frame to a computerized apparatus implementing an object detection algorithm; and obtaining, from the apparatus a definition of a rectangle, wherein the first interesting area comprised by the rectangle.

Optionally, processing the first video frame based on the first interesting area comprises replacing an image object with an avatar of the object.

Optionally, replacing an image of the object with an avatar of the object comprises: cropping the first video frame to a cropped video frame, wherein said cropping is based on the first interesting area, whereby generating a first cropped video frame; providing the cropped video frame to a cloud server, wherein the cloud server is configured to generate an avatar based on an image; and obtaining the avatar from the cloud server, whereby obtaining the first interesting alternative area.

Optionally, wherein said processing the first interesting area comprises: cropping the first video frame to a cropped video frame, wherein said cropping is based on the first interesting area, whereby generating a first cropped video frame; upscaling the cropped video frame, whereby determining the first interesting alternative video frame, wherein the first alternative video frame is having the same dimensions as the cropped video frame.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1, 4, 5, 6, 7, 8, 9, 10A and 10B show schematic illustrations of video frames, in accordance with some exemplary embodiments of the disclosed subject matter.

FIGS. 2, 3 and 156 and 11 show flowchart diagrams of a method, in accordance with some exemplary embodiments of the disclosed subject matter; and

FIGS. 11 4 and 135 show block diagrams of an apparatus, in accordance with some exemplary embodiments of the disclosed subject matter.

### DETAILED DESCRIPTION

One technical problem dealt with by the disclosed subject matter is to efficiently compress a video. Efficient compression may be useful for reduction of storage required to retain the video, bandwidth required to transmit the video, or the like. In some cases the video may be streamed to a recipient device. Different challenges may be faced when streaming content over the Internet, and specifically in live streaming. Devices with Internet connection may lack sufficient{HYPERLINK “https://en.wikipedia.org/wiki/Bandwidth_(signal_processing)” \h}bandwidth, may experience stops, lags, slow buffering of the content, or the like. Additionally or alternatively, the connection may suffer from network latency, packet loss, or the like, causing delays in streaming. Devices lacking compatible hardware or software systems may be unable to stream certain content, may be unable to stream the content in a high quality, or the like.

Another technical problem dealt with the disclosed subject matter is to efficiently encode a video frame. In some exemplary embodiments, efficiently encoding a video frame may refer to compressing the video frame as much as possible while losing as little information as possible. In some exemplary embodiments, a Peak Signal-To-Noise Ratio (PSNR) measurement or a Mean Opinion Score (MOS) measurement may measure how much data was lost. Put differently, the PSNR or MOS may measure the difference between the video frame and the decoded encoded video frame.

In some exemplary embodiments, the video may be streamed from a server such as YouTube™, a Video on Demand (VOD) service, or the like. Additionally or alternatively, the video may be streamed from one recipient device to other end devices, such as from a first smartphone to another smartphone, from a first user computing device to another, from one computing device to a plurality of computing devices, or the like. In some exemplary embodiments, the video may be streamed in a video chat such as Zoom™, Skype™, WebEx™ or the like. Additionally or alternatively, the video may be streamed in an online class, such as a Yoga class, an online lecture, or the like.

In some exemplary embodiments, in order to generate the video stream, a capturing device, such as a light sensor, a camera, a webcam, an infra-red camera, or the like, may be utilized. The capturing device may be integrated in a user device, such as a smartphone, a personal computer, a computing device, or the like. Additionally or alternatively the capturing device may be a camera observing an area, such as a street camera, a security camera, or the like. Additionally or alternatively the capturing device may be integrated in an Internet of Things (IoT) device, a satellite camera, or the like. The capturing device may be configured to output a sequence of frames.

In some exemplary embodiments, the video may be streamed to one or more end devices such as a laptop, a smartphone, a personal computer, or the like. Additionally or alternatively an end device may be a server, a satellite, or the like, that provides the video to one or more recipient devices.

Yet another technical problem dealt with by the disclosed subject matter is to reduce the amount of data that may be transmitted in a video stream, without affecting the quality or resolution of the transmitted video, in a manner that can be detected by the end user. In some cases, video content may be available in several resolutions. A lower resolution may be utilized in case that there is insufficient bandwidth while a higher resolution may be utilized in case there is sufficient bandwidth. Videos with lower resolutions may be undesired by the users, as suffering from bad quality, or the like.

In some exemplary embodiments a video stream may be utilized in an online meeting, in an online lecture, or the like. In such embodiments, the background may not change. Additionally or alternatively, slides or an electronic presentation may be displayed in the video, such as a lecturer displaying slides, or the like. The slides may change less frequently, such as every half a minute, every minute, or the like. It may be desired to enhance only the changing portions of a frame, while deflating the unchaining portions of the video frame.

Yet another technical problem dealt with by the disclosed subject matter is to provide a consistent streaming of a video for a recipient having a low download rate. A consistent streaming may refer to a streaming in which the download rate of the media is not larger than the play rate of the media. In those embodiments, a streaming provider may automatically detect the bandwidth available for the media recipient. The streaming provider may change a Frame Per Second (FPS) parameter of the media in order to assure that the streaming is consistent. Such change may affect the quality of the downloaded video.

Yet another technical problem dealt with by the disclosed subject matter is to reduce the amount of data that may be transmitted in a video stream. Such reduction may overcome Internet failures.

Yet another technical problem dealt with by the disclosed subject matter is to process a portion of the video frame that may have changed compared to a previous video frame. In some exemplary embodiments, a video stream may be utilized in an online meeting, in an online lecture, or the like. In those embodiments, the margin may not change, may change at a slower rate compared to a portion of the video frame displaying a participant in an online meeting, or the like. Additionally or alternatively, some portions of video frames comprised by the video stream may change more often compared to other portions of the video stream. It may be desired to stream only the changing portions of a video frame. Additionally or alternatively, it may be desired to stream the changing portion of the video stream more often compared to a non-changing portion of the video stream. As an example, the video stream may comprise two kittens. A first kitten may be asleep while a second kitten may be playing. The changing portion may display the playing kitten.

Yet another technical problem dealt with by the disclosed subject matter is to provide a consistent video stream for a recipient having a download rate below a threshold while maximizing a video Frame Per Second (FPS) rate of portions of the video stream. In some exemplary embodiments, a consistent video stream may refer to a video stream in which a download FPS rate of the media is not smaller than a required FPS play rate of the media. In some exemplary embodiments, it may be desired to process a first portion of the video stream in one FPS rate and a second portion of the video stream in a second FPS rate.

Yet another technical problem is to configure a computerized device to determine a portion of the video frame in an operation duration below a duration threshold. The duration threshold may be 10 milli-second, 12 milliseconds, 7 millisecond, 98 milliseconds, or the like. Additionally or alternatively, it may be required to configure the computerized device to process a video frame in a processing duration below the duration threshold. In some exemplary embodiments, the producer may be operatively coupled with a computerized apparatus with low resources such as a weak CPU, low amount of available RAM, or the like. Additionally or alternatively, in case that processing a video frame comprises providing, there may be a latency above a latency threshold between the producer and a consumer. In some exemplary embodiments, the video frame may be comprised by a video stream. A light sensor may be configured to produce video frames at a rate such as 30 video frames per second, 60 video frames per second, or the like. It may be desired that the time threshold may be smaller than 1/(the rate).

One technical solution is to obtain a video frame and to determine a non-interesting area of a video frame. In some exemplary embodiments, the video frame may be processed. Processing the video frame may comprise deflating the non-interesting area.

Another technical solution is to obtain a video frame and to determine an interesting area. In some exemplary embodiments, the video frame may be processed. Processing the video frame may comprise upscaling the interesting area.

In some exemplary embodiments, a producer may be operatively coupled with a consumer. The consumer may be configured to obtain a video frame from the producer, to obtain a processed video frame from the producer, or the like. Additionally or alternatively, the producer may be configured to write a video frame or a processed video frame to a shared memory area, to a medium, to a socket, or the like. In some exemplary embodiments, the consumer may be configured to periodically obtain the video frame or the processed video frame from the shared memory area, from the medium, from, the socket, or the like. In some exemplary embodiments, a virtual camera may be configured to execute a producer with respect to the disclosed subject matter. The virtual camera may be installed on a user computerized device such as a smartphone, a laptop, a desktop, a tablet, or the like. A user of the user computerized device may utilize the virtual camera in a video chat meeting. In that example, the consumer may be operatively coupled with a video chat application used for the video chat meeting. As an example, the user may be using a camera application running on the user computerized device. In that case, the camera application may comprise the consumer. In some exemplary embodiments, a virtual camera may be a software. The virtual camera may be installed on a computerized device. In some exemplary embodiments, the virtual camera may be a driver, a Dynamic Linked Library (DLL), a plugin, or the like. In some exemplary embodiments, the virtual camera may be registered by an operating system of the computerized device as a camera. A user of the computerized device may use a user interface and may choose the virtual camera as a capturing device of the computerized device. Additionally or alternatively, the user may use another user interface. The other user interface may be associated with the video chat application, with the camera application, or the like. The user may use the other user interface in order to configure the video chat application, the camera application, or the like to use the virtual camera as an input device. In some exemplary embodiments, the virtual camera may be configured to be registered as a default capturing device of the computerized apparatus, as a default camera of the computerized device, or the like. In some exemplary embodiments, registering the virtual camera as the default camera of the computerized apparatus or as the default capturing device of the computerized device may comprise determining a current default camera device of the computerized device. In some exemplary embodiments, the virtual camera may be configured to obtain one or more video frames from the current default camera device, to process a video frame comprised by the one or more video frames, or the like. In some exemplary embodiments, a computerized device, such as a tablet, a smartphone, or the like may be operatively coupled with a default rear camera. The virtual camera may be configured to operate as the default rear camera by obtaining one or more video frames from the default rear camera and processing a video frame comprised by the one or more video frames from the default rear camera. Additionally or alternatively, in a similar manner, the computerized apparatus may be operatively coupled with a front camera. The virtual camera may be configured to operate as the default front camera. As a result, the virtual camera may be the default rear camera, the default front camera, or the like.

Another technical solution is to determine one or more areas of the video frame. an area comprised by the one or more areas of the video stream may be an area of interest.

In some exemplary embodiments, a portion of the video frame may be associated with a portion of an area. In some exemplary embodiments, the portion of the video frame may be a portion to be processed. The area may display one or more objects, a portion of an object, or the like. The portion may be associated with a rectangle in the video frame displaying a portion of the video frame. Additionally or alternatively, the portion of the video frame may comprise the area. The portion may be a rectangle comprising an image of an object as displayed in the video frame. In some exemplary embodiments, it may be determined that the area is an interesting area. Processing the interesting area may comprise upscaling the portion. In some exemplary embodiments, the area may display a non-interesting object, may display the margin of the video frame, may not display no object, or the like. It may be determined that the area is a non-interesting area. Processing the non-interesting area may comprise deflating the portion. In some exemplary embodiments, a margin of the video frame may be determined. The margin of the video frame may be a non-interesting area, an interesting area, or the like. In some cases, such as in the case of a video meeting, the margin of the video frame may be irrelevant to a user. Hence, it may be determined that the margin of the video frame may be a non-interesting area. Additionally or alternatively, such as in the case of a surveillance camera, it may be determined that the margin of the video frame may be an interesting area. As an example, a camera may capture images of a zone. The zone may be a military base, a hospital, or the like. The camera may be placed above the zone. The camera may be placed above the zone, in a drone, on a street pole, or the like. As the margin of the video frame may be an important area, a portion of the video frame displaying a portion of the margin may be processed. Processing the portion may comprise upscaling the portion.

In some exemplary embodiments, determining the one or more areas may comprise determining one or more objects displayed in the video frame. An object may be a person, a dog, a car, a flower, or the like. In some exemplary embodiments, based on the one or more objects, one or more bounding shapes may be determined. A bounding shape comprised by the one or more bounding shapes may comprise an image of a portion of the object. In some exemplary embodiments, a bounding shape may be associated with one or more portions of the video frame. In some exemplary embodiments, the bounding shape may be a minimal bounding shape. one or more bounding shapes may comprise the object. A minimal bounding shape may be the bounding shape with smallest dimensions from the one or more bounding shapes comprising the object.

In some exemplary embodiments an area of interest may comprise a unification of portions of the video frame displaying one or more objects. The margin of the video frame may be determined by subtracting the area of interest from the video frame.

In some exemplary embodiments, one or more processing channels may be determined. In some exemplary embodiments, a processing may be associated with a portion of the video frame, with an area of the video frame, or the like. The portion of the video frame may be processed based on the processing channel, by utilizing the processing channel, or the like. Additionally or alternatively, the area of the video frame may be processed based on the processing channel, by utilizing the processing channel, or the like.

In some exemplary embodiments, a processing channel may be associated with a computerized process, with a deflating operation, with an upscaling operation, with a deflating algorithm, with an upscaling algorithm, with a computerized process parameter, with a deflating parameter, with an upscaling parameter, or the like. The one or more processing channels may be determined based on the one or more portions of the video frame. Determining a processing channel comprised by the one or more processing channels may comprise determining to deflate the portion, determining to upscale the portion, or the like. In some exemplary embodiments, determining the processing channel may comprise determining a deflating algorithm such as bilinear interpolation, bicubic interpolation, Lanczos interpolation, Bit exact bilinear, Bit exact nearest neighbor interpolation, Bit exact bicubic neighbor interpolation, Natural neighbor interpolation, or the like. Additionally or alternatively, determining the processing channel may comprise determining an upscaling algorithm such as Edge-Preserving Image Upscaling, Multi-frame image super-resolution (MISR), Multi-scale dictionary for single image super-resolution, Fast direct super-resolution by simple functions, or the like. In some exemplary embodiments, determining the processing channel, may comprise determining a deflating parameter. The deflating parameter may be indicative to a rate in which the portion should be deflated. Additionally or alternatively, determining the processing channel may comprise determining an upscaling parameter. The upscaling parameter may be indicative of another rate in which the portion should be upscaled. As an example, the deflating parameter may be indicative to a number of colors that may be removed from the portion. Additionally or alternatively, the upscaling parameter may be indicative to an upscaled resolution of the upscaled portion. The upscaled resolution may be larger than a resolution that may be associated with the video frame. Additionally or alternatively, the deflating parameter may be indicative to a deflated resolution of the deflated portion. The deflated resolution may be smaller than the resolution.

In some exemplary embodiments, utilizing the processing channel may comprise processing the portion of the video frame in the computerized process, performing a deflating operation, performing an upscale operation, or the like. applying the computerized process parameter on the computerized process, or the like. In that manner, in case that the video frame is displaying one or more images of one or more objects or a margin, processing the video frame may comprise processing a first portion of the video frame. Processing the first portion may be based on a first processing channel. Additionally or alternatively, processing a second portion of the video frame may be based on a second processing channel.

As an example, the video frame may display a lecture, the object may be a lecturer. Additionally or alternatively, an interesting area in a video frame may comprise an image of the lecturer. Additionally or alternatively, a non-interesting area in the video frame may comprise a margin of the video frame. a first portion of the video frame displaying the lecturer may be determined. Additionally or alternatively, a second portion of the video frame displaying the margin of the video frame may be determined. Additionally or alternatively, a first processing channel may be determined. The first processing channel may be utilized in order to process the first portion based on the first processing channel. Additionally or alternatively, a second processing channel may be determined. The second processing channel may be utilized in order to process the video frame based on the second processing channel.

In some exemplary embodiments, an interest level may be obtained. Additionally or alternatively, the interest level may be determined based on a context information. The interest level may be associated with an object. Additionally or alternatively, an activity level may be determined. The activity level may be associated with the object. In some exemplary embodiments, the interest level or the activity level may be determined based on an input of a user, based on a context information, or the like. In some exemplary embodiments the interest level may be determined based on the activity level. In some exemplary embodiments, the interest level may be indicative of an interest of a user in the object.

In some exemplary embodiments, the producer may be configured to determine whether to process an object based on the associated interest level. Processing an object may refer to processing one or more portions of one or more video frames, wherein each portion may display a portion of the object. In those embodiments, a video frame may be obtained periodically. The producer may be configured to detect objects displayed by a portion of the video frame. Additionally or alternatively, the producer may be configured to process a portion of the video frame displaying an object having an interest level above a threshold. Additionally or alternatively, the producer may be configured not to process a portion of the video frame displaying another object that may be associated with another interest level below the threshold. Additionally or alternatively, the producer may be configured to periodically not process a portion of a video frame displaying the other object. In some exemplary embodiments, one or more interest thresholds may be obtained. Each object may be associated with an interest threshold. The producer may be configured to process a portion of the video frame that may be associated with an object, wherein the object is associated with an interest level that may be above an interest threshold.

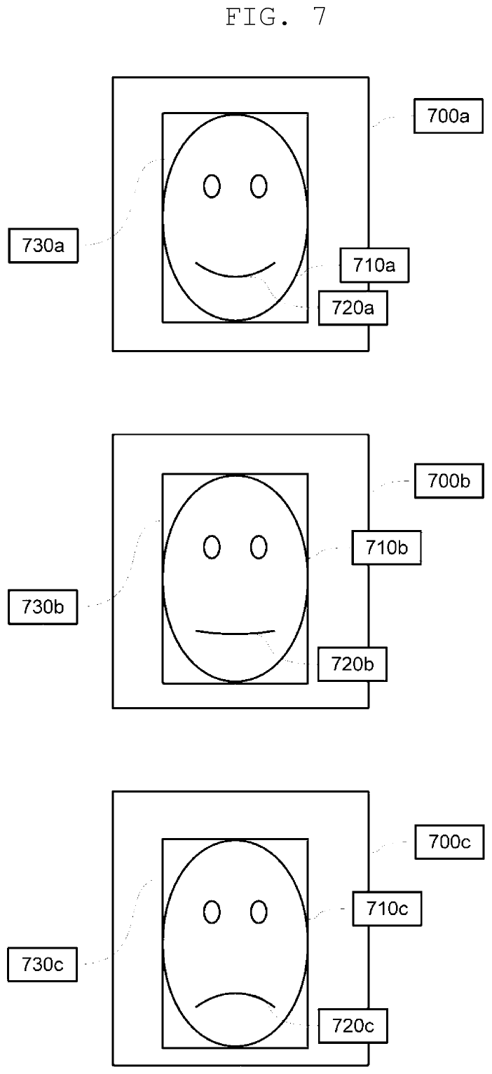

In some exemplary embodiments, an activity level may be obtained. The activity level may be associated with a portion of the video frame, with an object displayed by the video frame, or the like. Additionally or alternatively, an activity level may be determined. In some exemplary embodiments, the activity level may be determined based on a sequence of video frames. Each video frame comprised by the sequence of video frames may comprise an image of a portion of the object. Put differently, the sequence of video frames may comprise a set of sequences of different objects. As may be exemplified in FIG. 7, in which the sequence of video frames comprises three images of a same object.

In some exemplary embodiments, for each object or for each sequence, an activity level may be determined. As may be exemplified by FIG. 7, the activity level may be a difference between Bounding Shape 730b and Bounding Shape 730a. As another example, the sequence of video frames may comprise a first sequence of images of a first person and a second sequence of images of a second person. The first person may talk and move while a second person may sit still. In that example, the first person may be associated with a first activity level and the second person may be associated with a second activity level. The first activity level may be higher than the second activity level.

In some exemplary embodiments, an activity level of an object may be determined based on a statistical difference between bounding shapes comprising the sequence of images of the object. Additionally or alternatively, the activity level may be determined based on a sequence of minimal bounding shapes, each of which comprises an image of the object.

In some exemplary embodiments, a context information may be obtained. The context information may comprise information regarding hardware capabilities of a computerized device that may be configured to execute the one or more instances of a computerized device configured to execute the disclosed subject matter. In those embodiments, the context information may comprise information regarding one or more CPUs utilized by the computerized device, information regarding Random Access Memory (RAM) that may be utilized by the computerized device, a load that may be associated with the computerized device, or the like.

In some exemplary embodiments, a context information may comprise one or more consumer context information. A consumer context information may comprise a user information regarding a demographic information of a user utilizing the consumer. Additionally or alternatively, the consumer context information may comprise a computerized device information. The computerized device may be configured to execute the consumer. The computerized apparatus information may comprise information regarding one or more CPUs that may be operatively coupled with the consumer, with RAM that may be operatively coupled with the consumer, with an operating system installed on the computerized device, or the like.

In some exemplary embodiments, obtaining the context information may comprise obtaining one or more consumer context information from the one or more consumers. In some exemplary embodiments, a consumer may be comprised by the one or more consumers. Additionally or alternatively, the consumer may be operatively coupled with the producer. Additionally or alternatively, the consumer and the producer may be installed on the computerized device, may be executable by the computerized device, or the like. Additionally or alternatively, the consumer may be associated with another computerized device configured to obtain a video stream that was produced by the computerized device. In some exemplary embodiments. The consumer context information may comprise data regarding one or more users watching the video stream. The data may be an age of a user, occupation of the users, family information of the user, watching preferences of the user, data associated with social media regarding the user, or the like. Additionally or alternatively, the consumer context information may comprise data regarding a target screen description. The target screen may be a rendering device. Additionally or alternatively the target screen may be operatively coupled with the other computerized device. Additionally or alternatively the other computerized device may be configured to display alternative video by utilizing the target screen. In some exemplary embodiments the alternative video may be based on the video stream. In some exemplary embodiments the alternative video may comprise a decoded video frame. A decoded video frame may be obtained from the video stream and may be decoded. In some exemplary embodiments, the target screen may be associated with a size, such as width, height, or the like. Additionally or alternatively, the target screen may be associated with a DPI information, number of colors information, or the like. The producer may be configured to process the frame based on the target screen information. As an example, in case that the capturing device is configured to produce a 1600×1400 frame, and in case that the target screen is of size 320×240, only an interesting area of the video frame may be processed.

In some exemplary embodiments, detecting an object displayed in the video frame may utilize an object detection algorithm such as Single Shot MultiBox Detector, R-FCN (Object Detection via Region-based Fully Convolutional Networks), or the like. In some exemplary embodiments, a specific detection algorithm may be utilized. A specific detection algorithm may be an algorithm configured for detection of a specific type of an object such as a face, a dog, a car, or the like. It may be noticed that in those embodiments, a face detection algorithm may be an algorithm configured to detect a face without associating the face to a person. In some exemplary embodiments, a specific detection algorithm may be selected based on a context information associated with the video stream. As an example, in case that the context information comprises an “online meeting” string, the producer may be configured to select a face detection algorithm. Additionally or alternatively, in case that the context information comprises a “birds in nature” string, the producer may be configured to select a bird detection algorithm.

In some exemplary embodiments, utilizing an object detection algorithm may yield one or more minimal bounding shapes. As an example, in the case that the algorithm is a face detection algorithm, the face detection algorithm may yield a minimal bounding shape displaying a face. The minimal bounding shape may display a person face. Additionally or alternatively, the person's forehead, the person's hair, the person's neck, the person's shoulders, or the like may not be displayed in the minimal bounding shape. In those embodiments, a bounding shape may be determined based on the minimal bounding. The bounding shape may display the person's forehead, the person's hair, the person's shoulders, the person's neck, or the like.

In some exemplary embodiments, a face detection algorithm configured to detect a face and associate the face with a person may be determined and utilized. The producer may be configured to determine an interest level of an object based on the face detection algorithm. As an example, the video stream may display images of a famous movie star in a crowd of people. The famous movie star may be more interesting to a user than a person in the crowd of people. Additionally or alternatively, one or more users watching the video stream may wish to see images of the famous movie star in high definition. The producer may be configured to determine objects displayed in the video frame. Additionally or alternatively, the producer may be configured to associate an object comprising images of the movie star with an interest level that may be higher compared to another interest level associated with another object. As a result, by utilizing the disclosed subject matter, areas of the video frame displaying images of the famous movie star may be upscaled. Additionally or alternatively, areas of the video frames not displaying images of the famous movie star may be deflated, may be upscaled in a lower rate, or the like.

In some exemplary embodiments, the object detection algorithm may be configured to accept a specific type of input. The specific type of input may be Red Green Blue (RGB), Red Blue Green, a gray scale of the video frame, or the like. In those embodiments, the video frame may be transformed to the specific type of input.

In some exemplary embodiments, a Machine Learning (ML) algorithm may be trained based on raw video data. Training the ML algorithm based on raw video may yield better performance as there may not be a need to transform the video frame to another format. In some exemplary embodiments, the raw video may be represented in a YUV, or the like. A raw video format may comprise different channels for different types of colors, of gray, of light, or the like. The ML algorithm may be trained based on one channel. Training the algorithm based on one channel may yield faster training time compared to an algorithm that is configured to work on an input comprising all channels. Additionally or alternatively, detecting an object comprised by a video frame may be performed faster by an algorithm that is configured to work on one YUV channel compared to an algorithm that is configured to work on an entire video frame comprising all YUV channels.

In some exemplary embodiments, a path of an object within a sequence of video frames may be determined. Another frame may be obtained and portions of the other video frame may be determined based on the previously detected objects and based on the path instead of re-detecting objects that may be displayed in the other video frame. As an example, a person may be moving from one side of a room to the other side. In those embodiments, a path of the person may be determined and portions of the video frame may be determined based on a prediction of the person's location.

In some exemplary embodiments, the number of the portions may be a predetermined number of portions. As an example, in case that the video frame is comprised by a video stream displaying a movie, the predetermined number may be determined by an editor of the movie. Additionally or alternatively, in case of an online lecture, the predetermined number of portions may be determined based on one or more video frames. In that case, the predetermined number may be valid for a duration of seconds, for a number of future video frames, or the like. As an example, the producer may be configured to periodically detect objects displayed in a subset of video frames comprised by the one or more video frames. Based on the detection of objects, it may be determined that one lecturer is lecturing in the online lecture. As a result, two portions may be determined. a first portion may comprise the lecturer. Additionally or alternatively, a second portion may comprise a margin of the video frame. Additionally or alternatively, during the lecture, another lecturer may join the lecturer. Based on another object detection it may be determined to determine a third portion of another video frame. The third portion of the other video frame may display the third lecturer. The producer may avoid determining another portion for another time duration.

In some exemplary embodiments, for each portion it may be determined if the portion is an interesting portion or a non-interesting portion. In some exemplary embodiments, for each portion, an interest level may be obtained. Additionally or alternatively, for each portion, an activity level may be obtained. Determining whether to process a portion may be based on the interest level, on the activity level, or the like. In some exemplary embodiments, a portion may be an interesting portion in case that the activity level is above a threshold, in case that the interest level is above a threshold, or the like.

In some exemplary embodiments, deflating a portion may be based on the interest level. In those embodiments, the portion may be associated with an interest level below a threshold. Based on the interest level, based on the threshold, or the like, the ratio of deflating may be determined. Additionally or alternatively, another portion of the video frame may be associated with another interest level. The other interest level may be smaller than the interest level. In that case, another ratio for deflating the other portion may be determined. Additionally or alternatively, the other ratio may be larger than the ratio.

As an example, in an online lecture, a lecturer may display slides. The slides may change every half a minute, every minute, or the like. A first portion of the video frame displaying the lecturer may be associated with an interest level above a threshold. Additionally or alternatively, the first portion may be associated with a first processing channel. Additionally or alternatively, the first processing operation may comprise a first processing operation. The first processing operation may comprise an upscaling operation. Additionally or alternatively, a second portion of the video frame may be associated with an area of the video framed displaying the slides. A second processing channel may be associated with the second portion. The second processing channel may be un associated with another processing operation yielding that the second portion is neither deflated nor upscaled. In some exemplary embodiments, the second processing channel may be associated with a computerized process yielding that the second portion may be copied to a shared memory location by utilizing the computerized process. Additionally or alternatively a third portion of the video frame may be associated with a margin of the video frame. The third portion may be associated with a third processing channel. The third processing channel may comprise a second processing operation. The second processing operation may comprise deflating the third portion. Additionally or alternatively, a first processed portion may result from processing the first portion. The first processed portion may be copied to the shared memory location based on the first processing channel. Additionally or alternatively, processing the second portion may yield a second processed portion. The second processed portion may be copied to the shared memory location based on the second processing channel.

Yet another technical solution is to determine one or more areas of interest comprised by the video frame based on an input of a user. A computerized user device may be configured to obtain one or more video frames and to display the one or more video frames to a user. Additionally or alternatively, the computerized user device may be configured to display one or more alternative video frames to a user. The computerized user device may be a PC, a laptop, a smartphone, or the like. Additionally or alternatively, the computerized user device may be another computerized device. The user may point a screen in a location in order to provide input regarding an area of interest. The user may point the screen by touching the screen, by utilizing a mouth, or the like. Based on the location of the point of the user, an area of interest may be determined. In some exemplary embodiments, determining the area of interest may comprise detecting an object displayed in an area comprising the location of the point. Based on the area of interest one or more portions of the video frame may be determined.

In some exemplary embodiments a portion of the video frame may be associated with an interest level that may be higher than another interest level associated with another portion of the video frame. The portion of the video frame may be processed. In some exemplary embodiments, another video frame may be obtained and processed based on the location of the portion of the video frame in the other video frame. In some exemplary embodiments, the user may double tap the screen in order to determine another area of interest. In some exemplary embodiments, the other area of interest may be associated with another interest level. The other interest level may be lower than the interest level. Additionally or alternatively, the other interest level may be higher than an additional interest level associated with an additional portion of the video frame. In some exemplary embodiments, the producer may periodically obtain a video frame and process the video frame based on one or more points of the user. As an example, the disclosed subject matter may be utilized by a camera application. The camera application may be configured to generate a video frame and to retain the video frame on a medium, to attach the video frame to a message, or the like. By utilizing the disclosed subject matter, less bits may be required to retain an output video frame compared to a video frame taken by another camera application, not utilizing the disclosed subject matter.

In some exemplary embodiments, determining the one or more portions of the video frame may comprise determining one or more sets of portions of the video frame. In those embodiments, a set of portions comprised by the one or more sets may be a portion of the video frame. In some exemplary embodiments, determining the set may comprise determining portions of the video frame. Additionally or alternatively, one or more priorities may be obtained. Additionally or alternatively, a priority may be associated with a portion of the video frame. In those embodiments, the set may comprise a first portion of the video frame and a second portion of the video frame. The first portion of the video frame may be associated with a first priority or the second portion of the video frame may be associated with a second priority. In those embodiments, a difference between the first priority and the second priority may be below a threshold. As an example, the first priority may be 5, the second priority may be 6, the threshold may be 1.1. Hence, the first portion may be comprised by the set or the second portion may be comprised by the set. Additionally or alternatively, a third portion of the video frame may be associated with a third priority or a fourth portion of the video frame may be associated with a fourth priority. The third priority may be 8 or the fourth priority may be 8.5. In that example, another set may comprise the third portion of the video frame or the fourth portion of the video frame. In some exemplary embodiments, a portion of the video frame may be determined based on an object displayed thereby, based on an area of activity, or the like. In some exemplary embodiments, an area of low priority may be determined. The area of low priority may not display an object, may not comprise an area of activity, or the like. In those embodiments, the area of low priority may be determined by determining a unification over the one or more portions of the video frame. Additionally or alternatively, the unification may comprise a unification of one or more portions of the video frame, each of which may be associated with a priority above a threshold. Additionally or alternatively, the unification may be subtracted from the video frame. The area of low priority may be a difference between the video frame and the unification. In some exemplary embodiments, the area of low priority may be another portion of the video frame.

One technical effect of utilizing the disclosed subject matter is reducing the resources and bandwidth utilization required for video streaming in general and in live streaming in particular, without massively affecting the quality of the viewer's experience. As video frames that may be provided to the consumer may comprise less information.

Another technical effect of utilizing the disclosed subject matter is an improved user experience as areas of the video frame displaying an interesting area may be seen better.

Another technical effect is enabling to encode static content, such as content available for downloading, saving a video statically to a computing device, or the like, frame by frame, utilizing the disclosed solution, thereby reducing the amount of downloaded data. The size of the downloaded video file may be smaller than the original static content without utilizing the disclosed subject matter.

It is noted that human vision is imperfect, and focus of attention is of importance to the manner in which an image is perceived. In some cases, peripheral information may be ignored by the human mind and may be completed even if absent. The disclosed subject matter may make use of such properties of the human vision mechanism to reduce information used to present the video to the human viewer without adversely affecting her experience.

Yet another technical effect of the disclosed subject matter is an improvement of a consumption of hardware resources that may be needed for transmitting a packet comprising an encoded video frame, for routing the packet, or the like. In order to transmit the packet, one or more routers may be required. Each router may be configured to forward the packet to a next hop. In some cases, a packet may be above a Maximum Transmission Unit (MTU), above a maximum frame size that may be transported on the data link layer, or the like. In those cases, the packet comprising the encoded video frame may be fragmented, or the like, by one or more routers. Fragmenting a packet may result in increased memory usage of one or more routers, increased CPU utilization of one or more routers, or the like. By utilizing the disclosed subject matter, the packet size may be below the MTU, below the maximum frame size, or the like. Additionally or alternatively, a consumer may be able to determine a reconstructed video frame without all the portion of the video frame, without all the encoded portion of the video frame, or the like.

Yet another technical effect of the disclosed subject matter is an improvement of a consumption of hardware resources that may be needed for upscaling a video frame. In some exemplary embodiments, the video frame may comprise a first portion and a second portion. First difference may be associated, determined, obtained, or the like. The first difference may be a difference of the first portion. Similarly, a second difference may be associated with the second portion. Similarly, a difference may be associated with the video frame. In some exemplary embodiments, the sum of the first difference and the second difference may be smaller than the difference, yielding that upscaling the first portion and upscaling the second portion may require less hardware resources compared to upscaling the entire video frame. Similarly, less hardware resources may be required to deflate the first portion and the second portion compared to deflating the entire video frame.

The inventor implemented embodiment of the disclosed subject matter, and exemplified that a video meeting using Zoom™ with the implemented embodiment results in an upload video size which is 80% less compared to a video meeting using Zoom™ without the implemented embodiment. In that implemented embodiment, the user conducted a video chat meeting. A first laptop and a second laptop were used to enable the video chat meeting. In a first case the first laptop was utilizing the disclosed subject matter by utilizing a virtual camera. In a second case the first laptop was utilizing a web camera connected to the first laptop. For each case, the inventor took a 10 second capture of the uploaded interest packet. In the first case, with the virtual camera, 24 Megabytes were captured. At the second test, 84 Megabytes were captured. As 80% less bytes were uploaded in the first case, compared to the second case, the output on the second laptop was a lag free video stream in the first case and a video stream with lags. Additionally or alternatively, the audio and video in the first case were much more synchronized compared to the second case

The disclosed subject matter may provide for one or more technical improvements over any pre-existing technique and any technique that has previously become routine or conventional in the art. Additional technical problems, solutions and effects may be apparent to a person of ordinary skill in the art in view of the present disclosure.

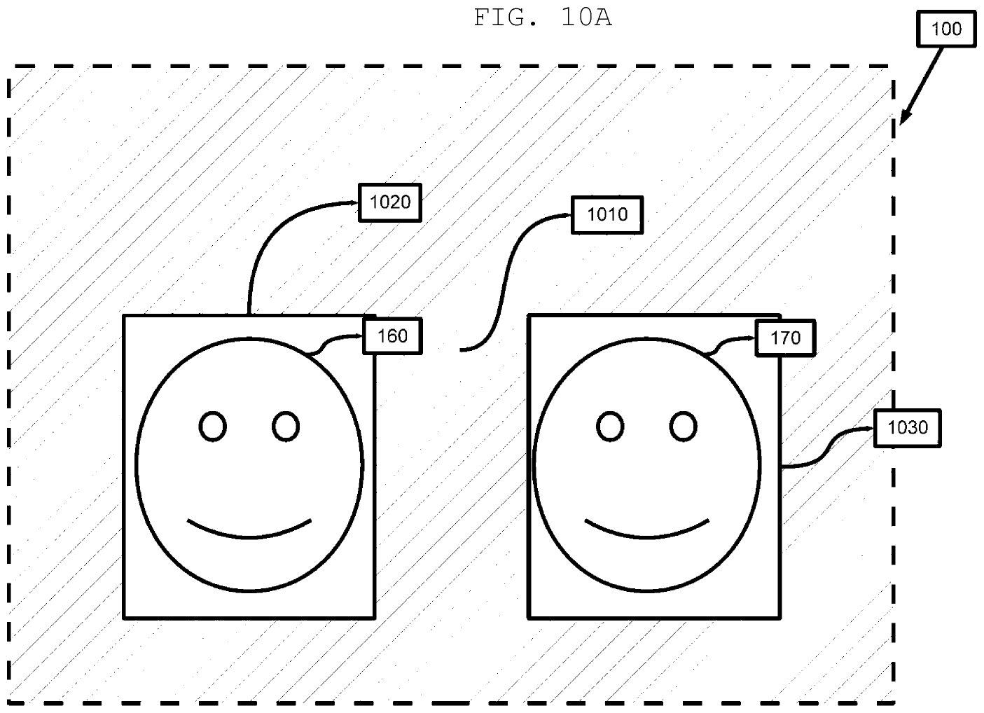

Referring now to FIG. 10A showing an environment, in accordance with some exemplary embodiments of the disclosed subject matter.

FIG. 10A may illustrate Video Frame 100. In some exemplary embodiments, Video Frame 100 may display Face 160 and Face 170. Bounding Shape 1020 may bound Face 160. Additionally or alternatively, Bounding Shape 1030 may bound Face 170. In some exemplary embodiments, Bounding Shape 1020 may be an area of importance, an area of interest, an area of activity, or the like. Additionally or alternatively, Bounding Shape 1030 may be an area of interest, an area of importance, an area of activity, or the like. FIG. 10A may illustrate two images of two people, a video frame comprised by an online lecture given by two lecturers, or the like.

In some exemplary embodiments, a first portion of the video frame may be determined. Additionally or alternatively, a second portion of the video frame may be determined. The first portion of the video frame may comprise Bounding Shape 1020. The second portion of the video frame may comprise Bounding Shape 1030. In those embodiments, Bounding Shape 1020 may be processed in a first processing channel. Additionally or alternatively, Bounding Shape 1030 may be processed in a second processing channel. In some exemplary embodiments, Bounding Shape 1020 may be processed in a first computerized process. Additionally or alternatively, Bounding Shape 1030 may be processed in a second computerized process.

In some exemplary embodiments, determining one or more areas may comprise determining Bounding Shape 1020 as a first area. Additionally or alternatively, a second area may comprise Bounding Shape 1030. Additionally or alternatively, a third area may comprise Dashed Area 1010. Dashed Area 1010 may be determined by subtracting a unification of Bounding Shape 1020 and Bounding Shape 1030 from Video Frame 100. In some exemplary embodiments the first area and the second area may define an interesting area. Additionally or alternatively, Dashed Area 1010 may define the non-interesting. In some exemplary embodiments, The non-interesting area may be determined by subtracting the interesting area from a video frame. Additionally or alternatively, the interesting area may be determined by subtracting the non-interesting area from the video frame.

In some exemplary embodiments, Face 160 may be a face of a first person. Additionally or alternatively, Face 170 may be another face of a second person. In some exemplary embodiments, it may be determined, based on a context information, that the first person is more important than the second person. The context information may comprise an occupation information of one or more people displayed in video frame 100. The first person may be more important to a user watching video frame 100, watching an alternative video frame, or the like. Additionally or alternatively, the first person may be a teacher and the second teacher may be a student. Additionally or alternatively, the first person may be a manager and the second person may be her assistant. In some exemplary embodiments, the user watching the alternative video frame may be a future user, such in the case that video frame 100 may be encoded and retained. As an example, the future user may be the first person.

In some exemplary embodiments, a processing the video frame may comprise processing Bounding Shape 1020 and writing a first processed area to a memory location. The memory location may be a shared memory location. Additionally or alternatively, processing the video frame may comprise processing Bounding Shape 1030 and writing a second processed area to the memory location Additionally or alternatively, processing the video frame may comprise processing Dashed Area 1010 and writing a third processed area to the memory location. In some exemplary embodiments, the consumer may be configured to obtain a processed video frame 100 from the memory location. In some exemplary embodiments, processing Bounding Shape 1020 may comprise upscaling Bounding Shape 1020. Additionally or alternatively, Processing Bounding Shape 1020 may comprise upscaling Bounding Shape 1030. Additionally or alternatively, Processing Dashed Area 1010 may comprise deflating Dashed Area 1030.

In some exemplary embodiments, as the first person is more interesting than the second person, Bounding Shape 1030 may not be processed. Additionally or alternatively, Bounding Shape 1030 may be copied to the shared memory. Additionally or alternatively, processing Bounding Shape 1030 ma comprise copying Bounding Shape to the shared memory,

In some exemplary embodiments, in case that Video Frame 100 may be comprised by a sequence of video frames, another video frame may be obtained. A first other bounding shape may bound Face 160 as may be displayed in the other video frame. Additionally or alternatively, a second other bounding shape may bound Face 170 as displayed in the other video frame. As a result, another dashed area may not be determined. Additionally or alternatively, another dashed area may not be processed. In some exemplary embodiments, processing the other video frame may comprise processing the first other bounding. Additionally or alternatively, a processed first other bounding shape may be written to the shared memory. Additionally or alternatively, processing the other video frame may comprise processing the second other bounding shape. Additionally or alternatively, a processed second other bounding shape may be written to the shared memory. As a result, the memory location may comprise the first processed other portion, the second processed other portion and the processed Dashed Area 1010.

In some exemplary embodiments, as a first interest level may be associated with Bounding Shape 1020. Additionally or alternatively, a second interest level may be associated with Bounding Shape 1030. Additionally or alternatively, a third interest level may be associated with Dashed Area 1010. Additionally or alternatively, the first interest level may be larger than the second interest level. Additionally or alternatively, the second interest level may be larger than the third interest level.

In some exemplary embodiments, in case that Video Frame 100 is comprised by a sequence of video frames, it may be determined that Bounding Shape 1020 may comprise Face 160 in the other video frame prior to obtaining the other video frame. Additionally or alternatively, Bounding Shape 1020 may be determined to be larger than a minimal bounding shape that may comprise Face 160 as displayed in Video Frame 100. As a result, a portion of the interesting area of the other video frame may be determined based on Bounding Shape 1020 without performing object detection, without performing face detection, or the like.

Referring now to FIG. 10B showing an environment, in accordance with some exemplary embodiments of the disclosed subject matter.

FIG. 10B may illustrate Video Frame 100B. In some exemplary embodiments, Video Frame 100B may display Screen 1050. Screen 1050 may be hung on a wall behind the two lecturers.

In some exemplary embodiments, determining the one or more portions of the video frame may comprise determining one or more portions of the video frame. In the illustrated example, a first portion of the video frame comprised by the one or more portions of the video frame may display Face 160. Additionally or alternatively, a second portion of the video frame comprised by the one or more portions of the video frame may display Face 170. Additionally or alternatively, a third portion of Video Frame 100B, comprised by the one or more portions of Video Frame 100B may display Screen 1050. Additionally or alternatively, Bounding Shape 1020 may define the first portion of the video frame. Additionally or alternatively, Bounding Shape 1030 may define the second portion of the video frame. Additionally or alternatively, Screen 1050 may define the third portion of the video frame. In some exemplary embodiments, the first portion of Video Frame 100B, the second portion of Video Frame 100B and the third portion of Video Frame 100B, may be comprised by the interesting area.

In some exemplary embodiments, the producer may be configured to determine whether a portion of the video frame is a high priority portion or a low priority portion. In the illustrated example, the producer may be configured to determine that Bounding Shape 1020 is a high priority portion. Additionally or alternatively, the producer may be configured to determine that Bounding Shape 1030 is a high priority portion. Additionally or alternatively, the producer may be configured to determine that Screen 1050 is a low priority portion. Additionally or alternatively, Dashed Area 1010 may be comprised by the low priority portion. In some exemplary embodiments, the producer may be configured to determine to process the low priority portion and the high priority portion. In some exemplary embodiments a first processing channel may be determined. The high first processing channel may comprise an upscaling operation. Additionally or alternatively, the first portion may be processed based on the first processing channel. Additionally or alternatively, a second processing channel may be determined. The second processing channel may comprise a deflating operation. Additionally or alternatively, the second portion may be processed based on the second processing channel. In some exemplary embodiments, a high priority area may be determined. The high priority area may comprise the first portion. Additionally or alternatively, a low priority area may be determined. The low priority area may comprise the second portion. In some exemplary embodiments, the producer may be configured to determine an area of high priority. The area of high priority may comprise a unification of high priority portions of the video frame. In the illustrated example, the area of high priority may comprise Bounding Shape 1020 and Bounding Shape 1030. Additionally or alternatively, an area of low priority may be determined by subtracting the area of high priority from the video frame. In those embodiments, the area of high priority may be a first portion of the video frame. A high priority processing channel may be determined in order to process the area of high priority based thereon. Additionally or alternatively, it may be determined to process the area of low priority. In that case, a low priority processing channel may be determined in order to process the area of low priority based there on. In some exemplary embodiments, the high priority processing channel may be a processing channel associated with a computerized process and with a computerized process parameter. The computerized process parameter may be indicative to a process priority of the computerized process. In some exemplary embodiments, the low priority processing channel may be a processing channel associated with another computerized process and with another computerized process parameter. The other computerized process parameter may be indicative to another process priority. The process priority may be smaller than the other process priority, yielding that the computerized process may be scheduled to be executed more often than the other computerized process.

In some exemplary embodiments, Video Frame 100B may be comprised by a sequence of video frames, such as in case of a video stream. The sequence of video frames may be obtained by utilizing a light sensor, such as a camera, or the like. The light sensor may be associated with a capturing FPS parameter. The capturing FPS parameter may define a maximal number of video frames per second that may be obtained by the producer. In some exemplary embodiments, a high priority FPS parameter may be determined. The high priority FPS parameter may be smaller than the capturing FPS parameter. Additionally or alternatively, the high priority FPS parameter may be equal to the FPS parameter. Additionally or alternatively, a low priority FPS parameter may be determined. The low priority FPS parameter may be smaller than the high priority FPS parameter. The producer may be configured to process the low priority area based on the low priority FPS parameter. Additionally or alternatively, the producer may be configured to process the high priority area based on the high priority FPS parameter.

In some exemplary embodiments, processing a video frame based on one or more priority FPS parameters may comprise processing a portion of the one or more areas comprising the video frame. Additionally or alternatively, processing an area based on one or more priority FPS parameters may comprise processing a portion of the one or more portions associated with the area. In some exemplary embodiments, a video stream may comprise a sequence of video frames. An area in the video stream may be an area in one or more video frames comprised by the sequence of video frames. A frame comprised by the one or more video frames may comprise the area. The area may display a same object in the video frame. Additionally or alternatively, the area may display the same object in another video frame comprised by the sequence. Additionally or alternatively, the area may display the margin or a portion thereof in the video frame. Additionally or alternatively, the area may display the margin or the portion thereof in the other video frame. In some exemplary embodiments, as the priority FPS parameter is smaller than the FPS parameter associated with the capturing device, the same areas may not be processed while processing the other video frame. additionally or alternatively, the same portion may not be processed while processing the other video frame. In that case, a processed other video frame may comprise a processed same area. The processed same area may be the result of processing the same area while processing the video frame. Similarly, the same portion of the other video frame may not be processed. In that case, the processed other video frame may comprise a processed same portion. The processed same portion may be the result of processing the same portion while processing the video frame.

In some exemplary embodiments, during the lecture, one of the lecturers may utilize Screen 1050 in order to display another video stream. In those embodiments, the producer may be configured to determine that Screen 1050 is displaying the other video stream. The producer may be configured to determine that the Screen 1050 is displaying the other video stream by identifying a change in an activity level that may be associated with Screen 1050. Additionally or alternatively, a lecturer may say “I want to show you a movie”, “let's look at a video”, or the like. The producer may be configured to obtain audio of users, analyze the audio and determine that Screen 1050 is displaying the other video stream. In response to determining that Screen 1050 is displaying the other video stream, the producer may be configured to determine a new area of interest. The new area of interest may comprise the area of interest and Screen 1050. Additionally or alternatively, the new area of interest may comprise the area of interest and another shape. The other shape may comprise Screen 1050, may be a minimal bounding shape comprising Screen 1050, or the like. Additionally or alternatively, the producer may be configured to determine a new area of high priority. Additionally or alternatively, the producer may be configured to determine a new area of low priority. The new area of high priority may comprise Bounding Shape 1020 and Screen 1050. In that example, a first lecturer displayed in Bounding Shape 1020 may be talking while a second lecturer displayed in Bounding 1030 may be still. As a result, Bounding Shape 1030 may be excluded from the area of high priority. In some exemplary embodiments, Bounding Shape 1030 may not be associated with a portion of another video frame comprised by the sequences of video frames. As a result, Bounding Shape 1030 may not be processed, may not be upscaled, may not be deflated, or the like.

In some exemplary embodiments, in order to process the other video stream, the producer may be configured to obtain a copy of the other video stream. The other video stream may be processed. As an example, the other video stream may be provided to one or more consumers. Providing the other video stream to one or more consumers may be performed by utilizing the disclosed subject matter.

As another example, the disclosed subject matter may be utilized in order to provide a Remote Desktop Software (RDS). In some exemplary embodiments, the producer may be configured to obtain one or more video frames, wherein a video frame may display a portion of a desktop of a computerized device. In those embodiments, the consumer may comprise the RDS software. In some exemplary embodiments, a video frame may display one or more open windows. Each of which may be associated with a software running on a remote machine. In those embodiments, the producer may be configured to be executed on the remote machine. Additionally or alternatively, the remote machine may be utilizing the RDS. Additionally or alternatively, a consumer may obtain one or more portions of the video frame. Each open window may be associated with a bounding shape. Based on points of a user, a window of interest may be determined. The window of interest may be the window that a user is currently utilizing. Dashed Area 1010 may be considered as the seen portion of the desktop background. In some exemplary embodiments, an area of the video frame displaying (1010)? the window that the user is currently utilizing may be comprised by the interesting area. Additionally or alternatively, the current window may be associated with an interest level. Additionally or alternatively, another area of the video frame displaying another, non-active, window may be associated with another interest level. Additionally or alternatively, a third area of the video frame not displaying any window may be associated with a third interest level. Additionally or alternatively, the interest level may be above an interest threshold. Additionally or alternatively, the other interest level and the third interest level may be below the interest threshold. Additionally or alternatively, the third interest level may be smaller than the other interest level. In that case, the area displaying the active window may be enhanced. Additionally or alternatively, the other area, displaying the non-active window, may be deflated. Additionally or alternatively, the third area may be deflated more than the other area.

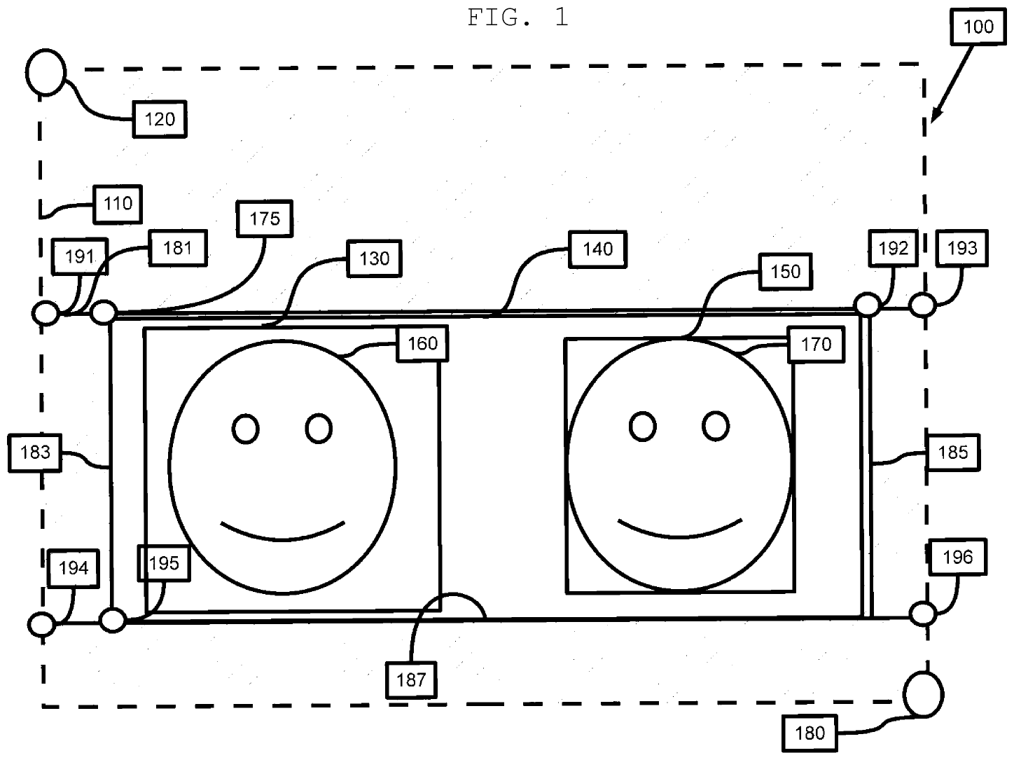

Referring now to FIG. 1 showing an environment, in accordance with some exemplary embodiments of the disclosed subject matter.

Dashed line 110 may define a boundary of Video Frame 100. In some exemplary embodiments, the video frame may be of width w and of height h. In a coordinate system, the video frame may be defined by a quadruplet. The quadruplet may be (0, 0, w, h).

Point 120 may illustrate a top left corner of Video Frame 100. In the illustrated figure, Point 120 may be described by the 2-tuple (0,0). Additionally or alternatively, Point 180 may illustrate the bottom right corner of Video Frame 100. Point 180 may be described by the 2-tuple (w, h).

Video frame 100 may display First Object 160. Additionally or alternatively, Video Frame 100 may display Second Object 170.

Bounding Shape 130 may define a bounding shape of First Object 160. Additionally or alternatively, Second Bounding Shape 150 may define a bounding shape of Object 170. Additionally or alternatively, Bounding Shape 140 may define a bounding shape of First Object 160 and of Second Object 170. As can be seen, Bounding Shape 150 may be a minimal bounding rectangle. Bounding Shape 150 may be the rectangle having the smallest area out of all rectangles that may comprise Object 170. As can be seen, Bounding Shape 130 may be a non-minimal bounding rectangle.

In some exemplary embodiments, the producer may be configured to determine one or more bounding shapes as one or more closed curved areas comprising the one or more objects. In some exemplary embodiments, an object comprised by the one or more objects may be associated with a closed curved area defining a bounding shape. In some exemplary embodiments, there may be a one-to-one relation between the one or more objects and the one or more curved areas. In some exemplary embodiments, the term margin of the video frame may be used in order to reference a portion of the video frame without any objects. Additionally or alternatively, the margin may coincide with Dashed Line 110. Determining the margin may comprise determining a rectangle that may be defined by Top Left Point 175 and Bottom Right Point 177. The rectangle may comprise Object 160 and Object 170. Additionally or alternatively, the margin may be determined by subtracting the rectangle from Frame 100.

In some exemplary embodiments, the margin of Video Frame 100 may be defined by a quadruplet of portions of the video frame. A first portion of the quadruplet may be defined by Point 120 and Point 193. Additionally or alternatively, the first portion of the quadruplet may be a first area of Video Frame 100 that may be between the top border of Video Frame 100 and line 181. A second portion of the quadruplet may be defined by Point 192 and Point 196. Additionally or alternatively, the second portion of the quadruplet may be a second area of Video Frame 100 that may be between Line 181, the right border of Video Frame 100, Line 187 and Line 185. A third portion of the quadruplet may be defined by Point 194 and Point 180. Additionally or alternatively, the thread portion of the quadruplet may be a third area of Video Frame 100 that may be between Line 187 and the bottom border of Video Frame 100. A fourth portion of the quadruplet may be defined by Point 191 and Point 195. Additionally or alternatively, the fourth portion of the quadruplet may be a fourth area of Video Frame 100 that may be between Line 191, Line 183, Line 194 and the left border of Video Frame 100.

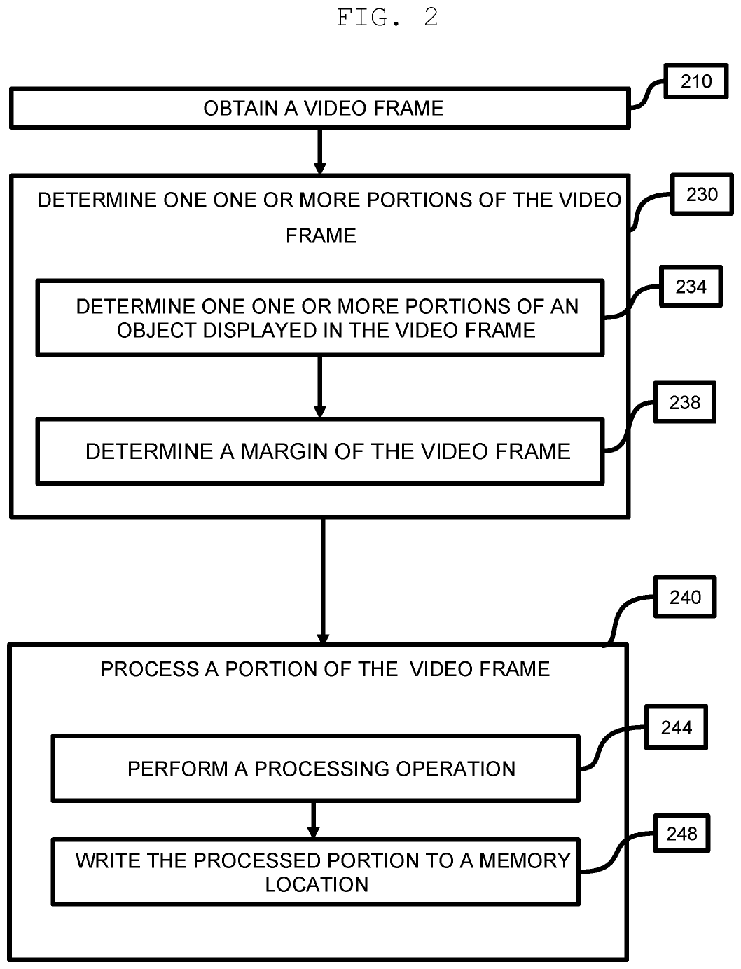

Referring now to FIG. 2 showing a flowchart diagram of a method, in accordance with some exemplary embodiments of the disclosed subject matter.

On Step 210, a video frame may be obtained. The video frame may be obtained by utilizing a sensor, a camera, by reading a portion of a file, or the like.

On Step 230, one or more portions of the video frame may be determined. In some exemplary embodiments, a portion of the frame may display a portion of an image of an object, of two objects, or the like. An object may be a person, a face of a person, a dog, a car, a table, or the like. Additionally or alternatively, the portion of the video frame may comprise an area of importance. In some exemplary embodiments, an area of importance may be important to a user. Additionally or alternatively, the portion of the video frame may comprise an area of interest. In some exemplary embodiments, an area of interest may be an area in which a user may find interest. Additionally or alternatively, the portion of the video frame may comprise an area of activity. In some exemplary embodiments, the area of activity comprises an area of the video frame that may change above a threshold.

In some exemplary embodiments, determining the one or more portions of the video frame may comprise step 234, step 238, or the like.

On Step 234, one or more portions of the video frame may be determined. In some exemplary embodiments, the one or more portions of the video frame may be determined based on one or more objects that may be displayed in the video frame. In those embodiments, each portion of the video frame may be associated with a portion of an object. In some exemplary embodiments, a portion of the video frame may be processed in case that the portion of the video frame is displaying a portion of the object associated with an interest level above a threshold. Additionally or alternatively, the portion of the video frame may be processed in case that the portion of the video frame is displaying a portion of an object associated with an activity level above another threshold.

In some exemplary embodiments, the one or more portions of the video frame may be determined by determining areas of interest. As an example, the context information may be indicative to the video frame displaying a hall in a museum. In that example, an area of interest may be associated with an art item displayed in the video frame.

In some exemplary embodiments, the one or more portions of the video frame may be determined based on areas of activity. In some exemplary embodiments, the areas of activity may be associated with an activity level. In those embodiments, another portion of the video frame, associated with an activity level above an activity threshold may be processed. Referring again to the above museum example, the video frame may be comprised by a video stream displaying an online tour in the museum. Another portion of the video frame may display an image of a tour guide that may be moving from one picture to another picture. An activity level associated with the portion of the video frame displaying the tour guide may be larger than the activity threshold. As a result, the portion of the video frame displaying the tour guide may be processed.

In some exemplary embodiments, a portion of the video frame may not be processed. As an example, the producer may be configured to process one or more areas of interest associated with one or more interest levels above an interest threshold, of one or more areas of activity associated with one or more activity levels above a threshold, or the like, requiring computational resources above a threshold. The portion of the frame may be associated with a priority below a priority threshold. In case that there are not enough computerized resources to process the one or more portions of the video frame, the portion of the video frame may not be processed. Additionally or alternatively, another portion of the video frame may be associated with another priority. The other priority may be larger than the priority threshold. As a result, the other portion of the video frame may be processed.

On Step 238, a margin of the video frame may be determined. In some exemplary embodiments, determining one or more portions of the video frame may comprise determining the margin of the video frame. In those embodiments, an area of interest comprising a unification of portions of the video frame displaying one or more objects may be determined. Additionally or alternatively, the area of interest may comprise a unification of the one or more areas of activity. Additionally or alternatively, the area of interest may comprise an area between two portions of the video frame. In those embodiments, the area of interest may comprise an inner portion of the video frame. The margin of the video frame may be a difference between the inner portion and the video frame. In some exemplary embodiments, the video frame may be comprised by a sequence of video frames, such as comprised by a video stream. In those embodiments, the inner frame may be processed per each video frame while the margin may be processed periodically. Additionally or alternatively, the margin may be determined periodically.

On Step 240, a portion of the video frame comprised by the one or more portions of the video frame may be processed. In some exemplary embodiments, the portion of the video frame may be processed by utilizing a processing channel. In some exemplary embodiments, the processing channel may comprise a computerized process. In some exemplary embodiments, a computerized process parameter may be determined for the computerized process. As an example, the computerized process parameter may comprise a process priority, yielding that the portion of the video frame may be processed in the computerized process with a different process priority than other portions of the video frame.

In some exemplary embodiments, the one or more portions of the frame may comprise another portion of the video frame. The other portion may be processed in a different computerized process than another computerized process in which the producer is running in, associated with, or the like. In some exemplary embodiments, processing the portion of the video frame may comprise performing step 244, performing step 248, or the like.

On Step 244, a processing operation may be performed, yielding a processed portion. The processing operation may comprise a deflating operation. Additionally or alternatively, the processing operation may comprise an upscaling operation.

On Step 248, the processed portion may be written to a memory location. The memory location may be comprised by a socket, to a medium, or the like. In some exemplary embodiments, a portion may not be processed. The portion may not be processed in case that an interest level that may be associated with the portion is below an interesting threshold. Additionally or alternatively, the interest level may be above a non-interesting threshold. Put differently, an area that may be associated with the portion may not be interesting enough for upscaling. Additionally or alternatively, the area may be interesting enough in order not to be deflated.

In some exemplary embodiments, a context information may comprise a resolution of an input device from which the video frame may be obtained. In some exemplary embodiments, based on the resolution, it may be determined not to process the video frame. In some exemplary embodiments, the resolution may be above a threshold, such as 3840×2160 pixels, 4096×2160 or the like. In that case, a portion associated with an interesting area may not be upscaled. Additionally or alternatively, in case that the resolution is below another threshold, such as 360×240 pixels, 480×360 pixels, or the like, another portion associated with a non-interesting area may not be deflated.

In some exemplary embodiments, determining the portions of the video frame may comprise determining one or more bounding shapes.

In some exemplary embodiments, a first processed portion of the video frame may be obtained by the consumer. Additionally or alternatively, a second portion of the video frame may be obtained by the consumer. Additionally or alternatively, a first portion of the video frame on another video frame may be obtained by the consumer, Additionally or alternatively, a second portion of the other video frame may not be obtained by the consumer. The second portion of the other video frame may not be provided by the consumer, may get lost, may be delayed, or the like. In those embodiments, the consumer may determine another reconstructed video frame based on the first processed portion of the other video frame and base on the second portion of the video frame.

In some exemplary embodiments, the disclosed subject matter may be utilized while editing a movie. The movie may comprise a video frame. In those embodiments, the producer may be configured to remove an object displayed in the movie, to blur a portion of the object, to add an image to the object, to add an object to the video frame, or the like. Processing an image of the object may be followed by retaining a processed portion of the video frame comprising a representation of the object. In those embodiments, the producer may be utilized by one or more computerized devices configured to edit the video frame. A first computerized device may be configured to process an image of the object and a second computerized device may be configured to process another image of another object. Additionally or alternatively, two or more human editors may work separately, each may edit a portion of the video frame displaying a portion of the one or more objects.

In some exemplary embodiments, one or more final operations may comprise one or more providing operations. In those embodiments, one or more sockets may be obtained. Different final operations may utilize different sockets. In some exemplary embodiments, a first encoded portion of the video frame, associated with a portion of the video frame, may be provided by utilizing a first socket. Additionally or alternatively, a second encoded portion of the video frame, associated with a second portion of the video frame, may be provided by utilizing a second socket. Additionally or alternatively, the margin may be provided by utilizing the second socket, by utilizing a third socket, or the like.

In some exemplary embodiments, the producer may be executed in a computerized process. Additional computerized processes may be determined in order to process a portion of the video frame displaying an object, in order to process the margin of the video frame, or the like. Additionally or alternatively, the portion of the video frame may be processed in a first computerized process and the margin of the video frame may be processed in a second computerized process. In some cases, a first priority may be determined and applied on the first computerized process. The first priority may be higher than a second priority that may be associated with a second computerized process. Additionally or alternatively, the second priority may be determined and applied on the second computerized process. The first priority may be higher than the second priority, yielding that the first portion of the video frame may be processed faster than the margin of the video frame.

In some exemplary embodiments, the video frame may be comprised by a sequence of video frames, such as in case that a consumer in accordance with the disclosed subject matter is utilized by a streaming application, by a video chat application, or the like. In those embodiments, each video frame comprised by the sequence of video frames may display one or more images of one or more objects. For each video frame, one or more portions of the video frame may be determined. A portion of the video frame may be associated with an object, yielding a sequence of portions of the video frame, wherein each portion comprised by the sequence of portions is associated with the same object. Each portion comprised by the sequence may be processed in a same computerized process. In some exemplary embodiments, processing different portions in different computerized processes may yield that processed portions that are associated with a first object may be available for the consumer at a different rate than processed portions that may be associated with the second object. Additionally or alternatively, processed portions of the margin of the video frame may be available at a slower rate than the processed portions that may be associated with the first object.

In some exemplary embodiments, the producer may be configured to eye track the eyes of one or more users in order to determine one or more points of gaze of the one or more users. Additionally or alternatively, the producer may obtain one or more points of gaze of one or more users. Additionally or alternatively, the consumer may be configured to provide to the producer one or more points of gaze. In some exemplary embodiments, the producer may provide video frames to one or more rendering devices used by one or more users. The producer may be configured to determine one or more points of gaze. Based on the one or more points of gaze, the producer may determine interesting portions of the video frame. Additionally or alternatively, another computerized device may be configured to track the eyes of one or more users. The other computerized device may be configured to provide to the producer one or more points of gaze of the one or more users. In some exemplary embodiments, a context information may comprise a point of gaze comprised by the one or more points of gaze.

As an example, two or more users may be watching a video stream, utilizing different consumers. The first user may be utilizing, directly or indirectly, a first consumer. Additionally or alternatively, a second user may be utilizing, directly or indirectly, a second consumer. The first user may be interested in a first object displayed in the video stream. Additionally or alternatively, a second user may be interested in a second object displayed in the video stream. Put differently, the first user may be interested in a first portion of the sequence of video frames. Additionally or alternatively, the second user may be interested in a second portion of the sequences of video frames. In some exemplary embodiments, the first consumer may be configured to track the eyes of the first user or to determine a first point of gaze of the first user. Additionally or alternatively, the second consumer may be configured to track the eyes of the second user in order to determine a second point of gaze of the second user. The first consumer may provide the first point of gaze to the producer. Additionally or alternatively, the second consumer may provide the second point of gaze to the producer. The producer may be configured to process the first portion twice. Processing the first portion twice may comprise deflating the first portion, writing the deflated first portion to a first memory location, or the like. Additionally or alternatively, processing the first portion twice may comprise upscaling the first portion, writing the upscaled first portion to a second memory location, or the like. Additionally or alternatively, the producer may be configured to process the second portion twice. Processing the second portion twice may comprise upscaling the second portion, writing the upscaled second portion to the first memory location, or the like. Additionally or alternatively, processing the second portion twice may comprise deflating the second portion, writing the deflated second portion to the second memory location, or the like.

As an example, the video stream may display a lion hunting a zebra. The first user may be interested in the zebra. Additionally or alternatively, the second user may be interested in the lion. The producer may be configured to deflate a portion of the video frame displaying the zebra and to write the deflated portion displaying the zebra to a first memory location. Additionally or alternatively, the producer may be configured to upscale the portion displaying the zebra and to write the upscaled portion displaying the zebra to a second memory location. Additionally or alternatively, the producer may be configured to upscale another portion of the video frame displaying the lion and to write the upscaled portion of the video frame displaying the lion to the first memory location. Additionally or alternatively, the producer may be configured to deflate the portion displaying the lion and to write the deflated portion displaying the lion to the second memory location. In some exemplary embodiments, the first consumer may be configured to obtain one or more processed video frames from the first memory location. Additionally or alternatively, the second consumer may be configured to obtain one or more video frames from the second memory location

The producer may be configured to deflate a portion of the video frame displaying the zebra, to write the. Additionally or alternatively, the producer may be configured to upscale another portion of the video frame displaying the lion.

In some exemplary embodiments, based on a point of gaze, an object may be low processed, high processed, or the like. As an example, the disclosed subject matter may be utilized by a camera. The camera may be stationed at a safari. The camera may capture a sequence of video frames, comprising images of a zebra and a lion. A video frame comprised by the sequence of video frames may display a portion of the image of the zebra and a portion of the image of the lion. A first researcher may remotely utilize the camera. Additionally or alternatively, a second researcher may remotely utilize the camera. Based on a point of gaze of the researcher it may be determined that the first researcher is interested in the lion. Additionally or alternatively, based on a point of gaze of the second researcher it may be determined that the second researcher is more interested in the zebra. The producer may be configured to process the video frame twice. A first processing of the video frame may comprise high processing of the lion and low processing of the zebra. Additionally or alternatively, a second processing of the video frame may comprise high processing the zebra and low processing the lion.

In some exemplary embodiments, the method exemplified by FIG. 2 may be a recursive method. In those embodiments, the video frame may comprise a number of objects above a threshold, may have a size above a threshold, a footprint above a threshold, or the like. In those embodiments, a processing operation with respect to a portion may comprise performing Step 230 with respect to the portion. Put differently, Step 230 may be performed again, wherein the video frame is the portion.

Referring now to FIG. 43 showing a flowchart diagram of a method, in accordance with some exemplary embodiments of the disclosed subject matter. In some exemplary embodiments, a computerized device configured to perform or more the method exemplified in FIG. 43 may be configured to execute a consumer such as a video chat application, a camera application, or the like.

On Step 4300, a context information of the video frame may be obtained. In some exemplary embodiments, the context information may comprise information regarding the capturing device such as a frame per second capability, a width of the video frame, a height of the video frame, a maximum number of colors, a resolution of the video frame, or the like. Additionally or alternatively, the context information may comprise information regarding hardware capabilities of an encoding device such as CPU, RAM, or the like. In some exemplary embodiments, the encoding device may be a computerized device that may be operatively coupled with the producer. Additionally or alternatively, the context information may comprise a consumer information indicating that a single video frame may be processed, indicating that the video frame may be comprised by a movie, or the like. Additionally or alternatively, the consumer context information may comprise information indicating that the video frame may be comprised by an online meeting video stream, comprised by an Augmented Reality (AR) content, comprised by a Virtual Reality (VR) content, or the like. Additionally or alternatively, the consumer context information may comprise information indicating whether the video frame is to be provided online, offline, or the like. Additionally or alternatively, in case that the video frame may be provided online to one or more consumers, the context information may comprise one or more remote consumer context information. As an example, the consumer may be configured to execute a video chat meeting between a first user and a second user. The first user may be using the consumer. Additionally or alternatively, the second user may be using a remote consumer. The remote consumer may also be configured to execute the video chat meeting. In some exemplary embodiments, a remote computerized device may be configured to execute the remote consumer. Additionally or alternatively, the context information may comprise one or more latency measurements, each of which may be a measurement of latency between the producer and a consumer. Additionally or alternatively, in case that the video frame is to be retained on one or more remote mediums, the context information may comprise one or more latency measurements, each of which may be a latency between the producer and a remote medium. Additionally or alternatively, the context information may comprise information regarding a demographic attribute of one or more users such as users that may watch the video frame, people that may be displayed in the video frame, or the like. Additionally or alternatively, the context information may comprise one or more user context information. A user context information may comprise a demographic information of a user that may be using a consumer, whereby indirectly may be using the producer. The user may be the first user, the second user, or the like. The demographic information may comprise an age of the user, an address of the user, a family status information, a marital status information, information regarding an occupation of the user, information regarding financials of the user, information regarding an online behavior of the user, or the like. In some exemplary embodiments, an information regarding the online behavior of the user may comprise browsing history of the user, application that the user may use, or the like.

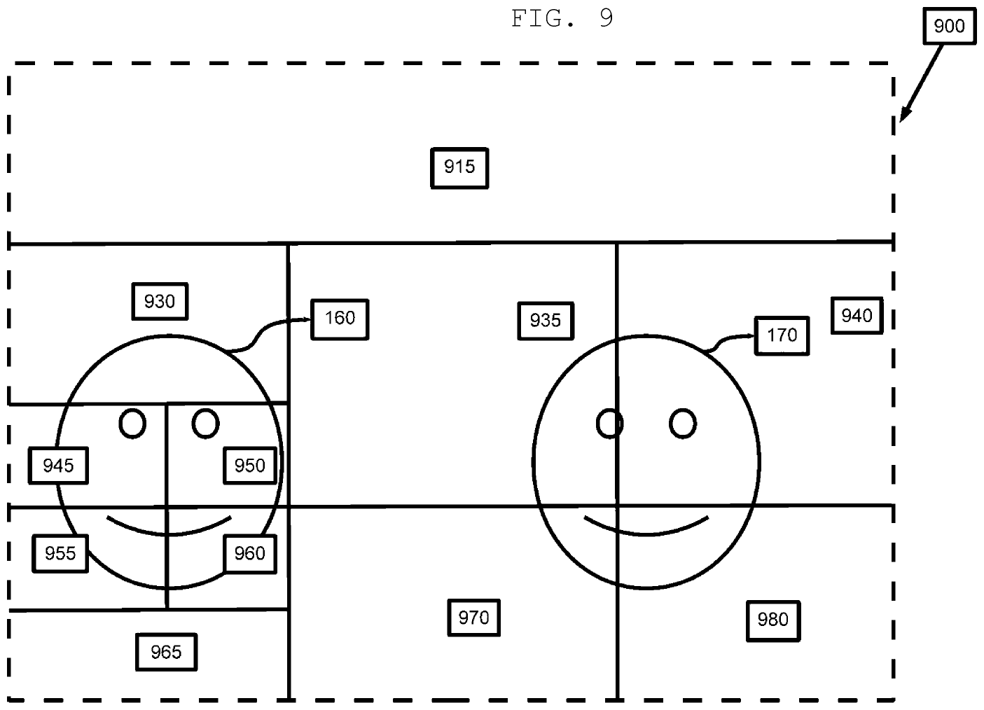

In some exemplary embodiments, the video frame may be comprised by a video stream, by a sequence of video frames, or the like. In those embodiments, the context information may be re-obtained while streaming the video stream. Based on the re-obtained context information, the producer may be configured to change its operation. As an example, a first latency may be obtained. Additionally or alternatively, a second latency may be obtained afterwards. The second latency may be smaller than the first latency. In that case, the producer may be configured to increase a priority FPS parameter, to perform or more low encoding of the video frame, or the like. As another example, the video stream may be a movie. The movie may comprise an operation scene and a quiet scene in which two characters are still. A first context information may be indicative to the operation scene while a second context information may be indicative to the quiet scene. While processing a video frame comprised by the operation seen, the producer may be configured to operate in a higher priority, to increase the number of rectangles as exemplified by FIG. 9:160, or the like. Additionally or alternatively, while encoding a video frame comprised by the quiet scene, the producer may be configured to operate in a lower priority, to decrease the number of rectangles as exemplified by FIG. 9:170, or the like. In some exemplary embodiments, an information comprised by the context information may be determined by the producer.

In some exemplary embodiments, the context information may comprise information regarding a latency between the producer and another producer In those embodiments, in case that the latency is above a threshold, the producer may be configured to perform or more low processing of a portion of the video frame displaying an image of an object associated with an interest level below a threshold. In those embodiments, performing low processing may comprise performing Step 4364. Additionally or alternatively, in case that the interest level is above a threshold the producer may be configured to perform high processing of the portion of the video frame. performing high processing may comprise performing Step 4368.

In some exemplary embodiments, the producer may be configured to determine a type of the video stream such an online meeting, a movie, a sport event, or the like. Determining the type of the video stream may be based on a media packet traffic. A one direction media traffic, from the producer to the consumer may yield that the type of the video stream is a movie, a concert, or the like. Additionally or alternatively, in case that the producer is operatively coupled with a consumer, and in case that on the average, the media ingress volume is similar to the media egress volume, the type of a video stream may be determined to an online meeting, video chat, or the like. As an example, the context information may comprise a tag such as an “on-line meeting” a “movie”, or the like.

On Step 4310, an analyze FPS parameter may be determined. In some exemplary embodiments, by utilizing the analyze FPS parameter the producer may avoid analyzing the video frame, may avoid processing a portion thereof, or the like. As an example, a light sensor may be configured to provide 60 frames per second. Additionally or alternatively, a source file may comprise an encoded video stream. The encoded video stream may comprise a 60 FPS sequence of video frames The analyze FPS parameter may be 30 FPS. The producer may be configured to analyze every second video frame. In some cases, a video frame may be associated with an index. The producer may be configured to analyze one or more frames associated with odd indexes. Additionally or alternatively, a video frame associated with an even index may be processed based on one or more previous video frames.

On Step 4320, it may be determined whether to analyze the video frame. The video frame may be analyzed based on an analyze FPS parameter. In some exemplary embodiments, it may be determined not to determine one or more objects, not to perform or more Step 25, not to perform or more Step 4350, or the like. In some exemplary embodiments, determining not to determine the one or more objects may be based on a plurality of activity levels being below a first activity threshold. In those embodiments, determining the one or more portions of the frame may be based on a previously determined one or more objects. In those embodiments, the producer may be configured to determine, for an object, a portion of the frame that may be larger than the image of the object as appeared in the video frame. In that manner, when utilizing a portion of the previous video frame in order to process the video frame, the image of the object may be comprised by the portion of the frame. In some exemplary embodiments, determining not determine one or more objects may be based on a context information. As an example, a sequence of video frames may display a sport match such as a basketball match, a football match, or the like. The context information may be obtained periodically. An obtained context information may comprise information that the match is paused, such as for a halftime break. The producer may be configured not to determine one or more objects during the halftime break. Additionally or alternatively, during the halftime break the producer may be configured to deflate an entire video frame.

On step 325, The video frame may be analyzed. In some exemplary embodiments, analyzing the frame may comprise performing Step 4330, Step 4340, Step 4345, or the like. In some exemplary embodiments, analyzing the video frame may comprise detecting one or more objects displayed in the video frame. The video frame may display one or more images, each of which may be an image of a portion of an object. An object may be a person, a face of a person, a dog, a car, a flower, a mountain, or the like. In some exemplary embodiments, an object may be detected by utilizing an MIL, algorithm such as Region-based Convolutional Neural Networks (R-CNN), Fast R-CNN, Faster R-CNN, You Only Look Once (YOLO), or the like.

In some exemplary embodiments, based on the context, an MIL algorithm may be determined. As an example, YOLO may not be able to detect objects associated with a portion of the video frame, wherein a size of the portion of the video frame is below a threshold. Additionally or alternatively, in case that a distance between the object and the other object is below a distance threshold, YOLO may not be able to detect the object and the other object. Additionally or alternatively, YOLO may not be able to detect one or more objects in case that the video frame is associated with a rare aspect of ratio such as a width of 1280 and a height of 320. Additionally or alternatively, Fast RCNN may detect the object, may detect the other object, may detect the one or more objects displayed in the video frame in case that video frame shows a rare aspect of ratio, or the like. Additionally or alternatively, applying Fast RCNN on a sequence of video frames, wherein the sequence is obtained in a capture rate above a capture threshold may result in an error rate above an error threshold. Additionally or alternatively, applying YOLO on the sequence of video frames may yield another error rate below the error threshold.

In some exemplary embodiments, detecting the one or more objects may be based on the context information. As an example, the context information may comprise a latency measurement between the producer and another producer. A video application instance may run on a first computerized device. Additionally or alternatively, another instance of the video chat application may run on another device. The first computerized device may be configured to utilize the producer as a virtual camera. The other computerized device may be configured to utilize the other producer as another virtual camera. The latency measurement may be above a threshold. Additionally or alternatively, the context information may comprise a field indicating that the connection between the producer and the other producer is a limited connection. A connection may be limited in case that the connection is configured to reduce the amount of data that may be transmitted such as in case that an end device used by a user may be roaming. Additionally or alternatively, the context information may comprise context information indicating that the producer is utilized in an online video chat. A user utilizing the producer may be outside. As a result, the producer may utilize an unstable network connection. A sensor configured to capture images of the user may capture the user or one or more objects. The producer may be configured to detect one object comprising an image of the user. Additionally or alternatively, as the connection is limited or as the latency is above a threshold, it may be determined, based on the context information, not to detect another object. Put differently, it may be determined that the one or more portions of the video frame may comprise a portion of the video frame displaying a portion of the user. Additionally or alternatively, it may be determined to exclude another portion of the video frame, not displaying any portion of the user, from the one or more portions of the video frame. As a result, only a portion of the video frame displaying an image of the user, may be processed. In some exemplary embodiments, based on the context information, a first deflating rate may be determined. A deflating operation may be performed based on the first deflating. In some exemplary embodiments, during the video chat, the user may enter a building. As a result, the network connection may become stable, may be unlimited, or the like. The producer may be configured to determine another deflating rate. The other deflating rate may be smaller than the first deflating rate, yielding that less information may be lost in the process of processing one or more video frames.

Additionally or alternatively, low processing may comprise determining a priority FPS parameter that may be associated with the object. The priority FPS parameter may be set to a value below another threshold. Additionally or alternatively, the producer may be configured to perform or more enhanced upscaling of a portion of the video frame comprising an image of another object associated with another interest level. The other interest level may be above the threshold. In some exemplary embodiments, enhanced upscaling may comprise a better compression of a portion of the video frame comprising the object compared to a non-strict encoding. It may be noticed that enhanced upscaling may yield higher CPU usage, higher RAM usage, or the like, compared to non-enhanced upscaling. By utilizing the disclosed subject matter, only a portion of the video frame may be enhanced upscaling, yielding less CPU or RAM usage compared to enhanced upscaling the entire video frame.

In some exemplary embodiments, such as for a video stream comprising a sequence of video frames, Step 4325 may be performed periodically, for a portion of the video frames comprised by a sequence of video frames. Determining the one or more objects may be performed every other frame, every other two frames, or the like. In some exemplary embodiments, the producer may be configured to determine a period in which Step 4300 is to be performed. Determining the period may be based on the interest level, on the activity level, on an FPS parameter associated with the capturing device, based on one or more FPS parameters associated with the one or more objects, or the like.

On Step 4330, one or more areas of the video frame may be determined. In some exemplary embodiments, determining the one or more areas may be based on one or more activity levels. In some exemplary embodiments, an area may comprise a portion of the video frame that may change more rapidly compared to another portion of a previous frame. Additionally or alternatively, the area may be a same area of the previous frame, may comprise the other portion, or the like. In those embodiments, the change may be above a threshold. In some exemplary embodiments, the area may display an image of an object that may change more rapidly compared to the previous video frame. In some exemplary embodiments, one or more areas of activity may be obtained.

In some exemplary embodiments, an area may be an area of importance. Additionally or alternatively, the producer may be configured to determine one or more areas of importance comprised by a video frame. An area of importance comprised by the one or more areas of importance may be an area of activity, an area of interest, may display a portion of one or more objects, or the like. The producer may be configured to determine one or more portions of the video frame based on the one or more areas of importance. In those embodiments, the producer may be configured to determine one or more portions of the video frame, each of which may be associated with an area of importance. In some exemplary embodiments, a non-interesting area may comprise the complement of a unification of the one or more areas of importance.

In some exemplary embodiments, another video frame may be obtained. The producer may be configured to determine one or more portions of the other video frame. Determining the one or more portions of the other video frame may comprise determining one or more portions of the other video frame. The one or more portions of the other video frame may comprise a portion of the other video frame and a second portion of the other video frame. Additionally or alternatively, a portion of the other video frame may be associated with the portion of the video frame. In those embodiments, the portion of the video frame and the portion of the other video frame may be located in a same location, may display a same object, or the like.

On Step 4340, one or more priorities may be determined. Additionally or alternatively, one or more priorities may be obtained. A priority comprised by the one or more priorities may be associated with a portion of the video frame. In some exemplary embodiments, a first portion of the video frame may be associated with a first priority. Additionally or alternatively, a second portion of the video frame may be associated with a second priority. The first priority may be larger than the second priority. In those embodiments, the producer may be configured to ensure that the first portion of the video frame can be processed. Additionally or alternatively, the producer may be configured to deflate the second portion of the video frame. As an example, the first portion of the video frame may display an image of a person and the second portion of the video frame may be the margin of the video frame. In some exemplary embodiments, one or more priority thresholds may be obtained. In some exemplary embodiments, a priority threshold comprised by the one or more priority thresholds may be associated with a priority, Additionally or alternatively, the priority threshold may be associated with a portion of the video frame. In those embodiments, the portion of the video frame may be processed in case that the priority is larger than the priority threshold.

In some exemplary embodiments, determining a priority may be based on an interest level. In those embodiments, obtaining the one or more priorities may comprise obtaining one or more interest levels. Additionally or alternatively, one or more interest thresholds may be obtained. In some exemplary embodiments, an object may be associated with an interest level. The interest level may be indicative to the importance of the object. As an example, the video frame may comprise two objects. The first object may be a person and the second object may be a hat. In one case, the person may be sitting alongside the hat. In that case, the hat may be associated with a low interest level. In a second case, the person may be a magician showing a magic show. A viewer of the magic show may wait for a rabbit to come out of the hat. In that case, the hat may be associated with an interest level higher than an interest level associated with the magician. As another example, a first person may be in an online meeting with a second person and a third person. The first person may display her baby and her dog. The producer may be configured to determine, based on the context information, that the second person is more interested in the dog or that the third person is more interested in the baby. The producer may be configured to generate a first video stream for the second person and a second video stream for the third person. In the first video stream a portion of the video frame comprising an image of the baby may be better encoded than a portion of the video frame comprising an image of the dog. Additionally or alternatively, in the second video stream, the portion of the video frame comprising the image of the dog may be upscaled based on a first upscale parameter. Additionally or alternatively, the portion of the video frame comprising the image of the baby may be upscaled based on a second upscaling parameter. The first upscaling parameter may be larger than the second upscaling parameter, yielding that the portion of the video frame comprising the image of the baby is upscaled at a higher rate than the portion of the video frame displaying an image of the dog. As a result, a processed portion of the video frame comprising the image of the baby may be associated with a higher resolution than another processed portion displaying the image of the baby.

In some exemplary embodiments, the producer may be configured to obtain a point of interest. As an example, the second person may point to an area in the screen displaying the baby. The producer may be configured to determine the location of the point of the second user within the screen and to associate an area in the video frame with an image of the baby. The producer may be configured to increase the interest level of the area, resulting in upscaling that area with a higher rate than other areas.

In some exemplary embodiments, the producer may be configured to determine an interest level based on audio. As an example, the third person may say “what a cute dog”, or the like. The producer may be configured to obtain audio from the third user and to analyze the audio in order to determine to increase the interest level associated with the dog in the second video stream. Additionally or alternatively, the consumer may be configured to obtain the audio, analyze it, and provide to the consumer information indicating the interest of the third user.

In some exemplary embodiments, a priority or a priority threshold may be associated with a portion of the video frame. As an example, a video stream may be utilized for security surveillance. Each video frame comprised by the video stream may be sliced to one or more slices. Each slice may represent a portion of a watched area. A slice representing the entrance to the watched area may be associated with a first priority. Additionally or alternatively, a slice representing a garden in the watched area may be associated with a second priority. The first priority may be larger than the second priority.

In some exemplary embodiments, an interest level that may be associated with an object may change during a streaming of the video stream. The producer may be configured to periodically obtain new one or more interest levels, to periodically determine new one or more interest levels, to determine new one or more interest levels based on new one or more activity levels, or the like. As an example, two people may be lecturing. The lecture may be provided on-line to students. In that case, there may be two objects. A first lecturer may be referred to as a first object and a second lecturer may be referred to as a second object. While the first lecturer is talking, the first object may be associated with a higher interest level than the second object. In case that the first lecturer stops talking or that the second lecturer starts talking a new interest level may be determined for the first lecturer or a new second interest level may be determined for the second lecturer. The new second interest level may be higher than the new first interest level.

In some exemplary embodiments, a minimal priority threshold may be obtained by the producer, determined by the producer, or the like. In those embodiments, a portion of the video frame displaying a portion of an object associated with a priority below the minimal priority threshold may be low processed. Additionally or alternatively, a priority FPS parameter above a threshold may be determined for a portion of the video frame displaying the object. Additionally or alternatively, another priority FPS parameter below another threshold may be associated with the other portions of the video frame. Additionally or alternatively, the other portions of the video frame may be excluded from the portions of the video frame. Referring again to the lion and zebra example, a video frame may comprise the lion, the zebra, additional one or more zebras, one or more other animals, or the like. The producer may be configured to low process portions of the video frame displaying the additional one or more zebras, portions of the video frame displaying other animals, or the like. As a result, another image of another zebra may be pixelated when displayed to a user.

In some exemplary embodiments, an activity level of a portion of the frame may be determined based on a sequence of video frames. In that case, the activity level may be a statistical measurement, such as the average, of the one or more activity levels. The producer may be configured to obtain a video frame by video frame from the sequence of video frames and to process one or more video frames. Processing the sequences of video frames may yield a sequence of portions, wherein each portion is associated with a same area in the sequence of video frames. Additionally or alternatively, processing the sequence of video frame may yield a sequence of activity levels. In some exemplary embodiments, processing one or more video frames may comprise determining one or more activity levels associated with the same area. In some exemplary embodiments, another frame may be obtained from the sequence of video frames. Additionally or alternatively, the other video frame may be processed. Processing the video frame may comprise determining one or more areas of the other video frame based on the one or more areas. Additionally or alternatively, a portion of the other video frame may be determined, wherein determining the portion of the other video frame may be based on the sequence of portions. Additionally or alternatively, the activity level of the portion may be determined based on an average of the sequence of activity levels, based on a time series prediction based on the sequence of activity levels, or the like.

In some exemplary embodiments, a minimal activity threshold may be obtained by the producer, determined by the producer, or the like. In those embodiments, other portions of the video frame displaying an object that may be associated with an activity level below the minimal activity threshold may be low processed. Additionally or alternatively, the other portions may be excluded from the portions of the video frame.

In some exemplary embodiments, an object may be associated with a bounding shape, with a minimal bounding shape, or the like. In those embodiments, an activity level of the object may be determined based on the activity level of the bounding shape. In some exemplary embodiments, such as a video stream, one or more bounding shapes may be determined based on the object. A first bounding shape comprised by the one or more bounding shapes may be associated with a first video frame comprised by the sequence. Additionally or alternatively, a second bounding shape comprised by the one or more bounding shapes may be associated with a second video frame comprised by the sequence. The first bounding shape may comprise an image of a first object. Additionally or alternatively, the second bounding shape may comprise the image.

In some exemplary embodiments, two or more objects may be associated with a same bounding shape, with a same portion of the frame, or the like. Additionally or alternatively, a first interest level may be associated with a first object. Additionally or alternatively, a second interest level may be associated with a second object. Additionally or alternatively, a difference between the first interest level and the second interest level may be below a threshold. Additionally or alternatively, the first object may be associated with a first activity level. Additionally or alternatively, the second object may be associated with a second activity level. Additionally or alternatively, a difference between the first activity level and the second activity level may be below a threshold. Additionally or alternatively, a first object comprised by the two or more objects may be associated with a first location within a video frame. Additionally or alternatively, a second object comprised by the two or more objects may be associated with a second location within the video frame. A difference between the first location and the second location may be below a threshold. In those embodiments, the two bounding shapes may be comprised by a same portion of the video frame. In those embodiments, one processing channel may be determined for the two bounding shapes, yielding that the two bounding shapes may be deflated based on a same deflating algorithm, may be upscaled by a same upscaling algorithm, may be processed in a same computerized process, or the like. As an example, Bounding Shape 730a of FIG. 7, Bounding Shape 730b of FIG. 7 and Bounding Shape 730c of FIG. 7 may all be associated with a same area. The same area may be comprised by Video Frame 700a, by Video Frame 700b and by Video Frame 700c. In that example, Video Frame 700a may be analyzed and one or more processing channels may be determined based thereon. Additionally or alternatively, one or more portions and one or more priorities associated therewith may be determined. Additionally or alternatively, Video Frame 700a may be processed based on the one or more processing channels, based on the one or more portions, based on the one or more priorities, or the like. Additionally or alternatively, Video Frame 700b and Video Frame 700c may be processed based on the one or more processing channels, based on the one or more portions, based on the one or more priorities, or the like.

In some exemplary embodiments, in case that the video frame may be comprised by of a video stream, it may be determined whether to perform or more step 4300, or to perform or more step 4310. In those embodiments, the video stream may comprise a sequence of video frames. The video frame may be comprised by the sequences of video frames. A portion of the sequence may be analyzed, by performing step 4300 on one or more video frames comprised by the portion of the sequence. Additionally or alternatively, a decision may be made in order to determine whether a video frame should be analyzed, whether to determine one or more objects, or the like. The decision may be based on the one or more activity levels, on the one or more interest levels, or the like. In those embodiments, a statistical function over the one or more activity levels or over the one or more interest level may be determined. The statistical function may be a maximum, an average, or the like. As an example, in case that the maximal interest level is below an interest threshold only a portion of the video frames comprised by the video stream may be analyzed. Additionally or alternatively, in case that the maximal activity level is below an activity threshold only a portion of the video frames comprised by the video stream may be analyzed. Additionally or alternatively, the statistical function may be a weighted average of the one or more interest levels and the one or more activity levels. In some exemplary embodiments, in case that a video frame is not analyzed, the one or more portions of the video frame may be determined based on one or more portions of a previous video frame. In those embodiments, a portion of the video frame may be associated with an area within a previous video frame. Based on the area, a portion of the video frame may be determined. The portion of the video frame may be associated with a same location and shape as the portion of the previous video frame. In some exemplary embodiments, another video frame may be obtained. In case that the statistical function is below a threshold, the other video frame may not be analyzed.

On Step 4345, one or more portions of the video frame may be determined. In some exemplary embodiments, the one or more portions of the video frame may be one or more rectangles. In those embodiments, determining the rectangles may be based on the size of the video frame. In some exemplary embodiments, the unification of the rectangles may be identical in size and shape to the video frame. Additionally or alternatively, each two rectangles comprised by the one or more rectangles may be disjoint sets. As an example, in the case that the video frame width is 640 pixels and that the video frame height is 480 pixels, 4 rectangles may be determined. A first rectangle may be represented by the coordinates (0,0,319, 119). A second rectangle may be represented by the coordinates (319,0,639,239). A third rectangle may be represented by the coordinates (0,239,319,479). A fourth rectangle may be represented by the coordinates (319,239,639,479). In some exemplary embodiments, a portion of the video frame may be determined by cropping the video frame based on a rectangle.

In some exemplary embodiments, determining the one or more rectangles may be based on the one or more areas of activity. In those embodiments, a sequence of video frames may be obtained. Additionally or alternatively, one or more areas of activity may be determined based on differences between two one or more video frames comprised by the sequence. In those embodiments, a first sequence of video frames may be associated with a first number of areas of activity. Additionally or alternatively, a second sequence of video frames may be associated with a second number of areas of activity. The first number may be larger than the second number. Additionally or alternatively, a number of rectangles that may be determined for the first sequence may be larger than a second number of rectangles that may be determined for the second sequence.

In some exemplary embodiments, one or more objects may be determined. In those embodiments, determining the one or more objects may be based on the one or more rectangles. In some exemplary embodiments, a rectangle may be analyzed in order to detect an object therein, a portion of the object therein, or the like. The rectangle may be analyzed in case that the rectangle comprises an area of activity. Additionally or alternatively, the rectangle may be analyzed in case that the rectangle is comprised by the area of activity. Additionally or alternatively, the rectangle may be analyzed in case that an activity level associated with the area of activity is above a threshold. Additionally or alternatively, another rectangle comprising another area of activity may not be analyzed. The other rectangle may not be analyzed in case that another activity level associated with the rectangle is below the threshold. In some exemplary embodiments, additional one or more rectangles may be determined based on one or more objects, based on the one or more activity levels associated with the one or more objects, based on one or more interest levels associated with the one or more objects, or the like. As an example, the video frame may comprise a first object and a second object. The first object may be associated with a still person. Additionally or alternatively, a second object may be associated with a second person. The second person may be moving. Hence, a first rectangle may comprise a portion of the video frame displaying the first person. Additionally or alternatively, 8 rectangles may be associated with the second person.

In some exemplary embodiments, determining the one or more portions of the video frame may be based on the one or more priorities, on a single priority threshold, or the like. A portion of the video frame, displaying a portion of an object, may be comprised by the one or more portions of the video frame in case that the priority is above the single priority threshold.

In some exemplary embodiments, the portions of the video frame may be determined based on one or more priority thresholds, wherein a priority threshold may be associated with a portion of the video frame. In those embodiments, for each portion of the video frame, the portion of the frame may be comprised by the one or more portions of the video frame in case that the associated priority is larger than the associated priority threshold.

On Step 4350, one or more processing channels may be determined. In some exemplary embodiments, determining the one or more processing channels may comprise determining or obtaining, or the like. Determining the one or more processing channels may be based on the context information, on the one or more priorities, on the one or more priorities thresholds, on the one or more interest levels, on the one or more activity levels, on the one or more interest threshold, on the one or more activity threshold, on the one or more objects, on the one or more portions of the video frame, or the like. In some exemplary embodiments, a producer may be configured to provide a representation of a first object to a consumer by utilizing a first processing channel or to provide a representation of a second object by utilizing a second processing channel. Additionally or alternatively, a representation of the margin frame may be provided by utilizing the second processing channel. Additionally or alternatively, a representation of a third object may be provided by utilizing the second processing channel. In some exemplary embodiments, grouping the one or more objects to the one or more processing channels may be based on the one or more interest levels and on the one or more interest threshold. An interesting object may be associated with an interest level above a first interest threshold. Additionally or alternatively, a first object associated with an interest level above the first interest threshold may be associated with a first processing channel. The first processing channel may not be associated with any other object. Additionally or alternatively, two or more objects associated with an interest level below the first threshold may be associated with a second processing channel. As a result, an interesting object may be processed in a separate processing channel and may be provided in the separate processing channel.

In some exemplary embodiments, the producer may be configured to track the eyes of one or more objects in order to determine one or more points of gaze. The producer may be configured to track an image of the eyes of one or more objects as appeared in a video frame. Additionally or alternatively, the producer may be configured to obtain one or more points of gaze of the one or more objects. Based on the one or more points of gaze, new one or more interest levels may be determined for the one or more object, for another one or more objects, or the like. As an example, a video stream may display a Yoga teacher and a student. The Yoga teacher may be associated with a first interest level and the student may be associated with a second interest level. The first interest level may be higher than the second interest level. The teacher may ask the student to show a pose. Additionally or alternatively, the teacher may look at the student while the student is showing the pose. Based on the point of gaze of the teacher, the producer may be configured to determine a new second interest level that may be higher than the first interest level.

In some exemplary embodiments, a priority FPS parameter may be associated with an object, associated with a processing channel, or the like. The priority FPS parameter may be determined based on a priority that may be associated with the object, based on an interest level that may be associated with the object, based on an activity level that may be associated with an object, or the like. In those embodiments, an interest level may be indicative of an interest of a user in the object. Additionally or alternatively, the activity level may be indicative to movements of the object. In some exemplary embodiments, the first object may be associated with a first interest level and the second object may be associated with a second interest level. The first interest level may be higher than the second interest level. In those embodiments, a first priority FPS parameter that may be associated with the first object may be higher than a second priority FPS parameter that may be associated with the second object. Similarly, in another exemplary embodiment, a first activity level that may be associated with the first object may be higher than a second interest level that may be associated with the second object. In that embodiment, the first priority FPS parameter may be determined based on the first activity level and the second priority FPS parameter may be determined based on the second activity level. The first priority FPS parameter may be higher than the second FPS parameter.

In some exemplary embodiments, the priority FPS parameter may be based on a priority. The priority may be based on the interest level and on the activity level. The interest level and the activity level may each be normalized. The priority may be an average of the normalized interest level and of the normalized activity level may be determined. Based on the priority, an FPS may be determined. A first priority FPS parameter may be determined based on a first priority. Additionally or alternatively, a second priority FPS parameter may be determined based on a second priority associated with a second object. The first priority may be higher than the second priority yielding that the first priority FPS parameter may be higher than the second FPS parameter.

As an example, in case that the context information comprises a “nature landscape” tag, a margin of the video frame may not be deflated. Additionally or alternatively, a first priority FPS parameter may be determined for the margin. Additionally or alternatively, in case that the context information comprises a “movie” tag, a second priority FPS parameter may be determined for the margin. In some exemplary embodiments, the second FPS rate may be higher than the first FPS rate.

In some exemplary embodiments, a sensor may be utilized in order to capture a sequence of video frames. the sensor may be associated with a capturing FPS parameter. Additionally or alternatively, the producer may be configured to determine one or more FPS parameters for one or more portions of the video frame. Additionally or alternatively, a priority FPS parameter may be associated with an object that may be displayed in the sequence of the video frames. Additionally or alternatively, another priority FPS parameter comprised by the one or more FPS parameters may be associated with the margin. A priority FPS parameter comprised by the one or more FPS parameters may be smaller than the capturing FPS parameter associated with the sensor. In those embodiments, the producer may be configured to periodically not process a portion of the frame displaying an object, displaying the margin, or the like. As an example, the sensor may be associated with a 30 FPS parameter and the margin may be associated with a 10 FPS parameter. The producer may obtain 30 video frames per second, out of which the margin frame may be encoded 10 times, may be provided to a consumer 10 times, or the like. The producer may be configured to exclude a portion of the video frame comprising the margin from the one or more portions of the video frame. Additionally or alternatively, the producer may be configured to exclude a portion of the video frame displaying the margin of the video frame every second and third video frames. In some exemplary embodiments, the producer may utilize a previous portion of a margin of a previous video frame. The portion of the margin and the previous portion of the margin may display a same area in the sequence of video frames. Additionally or alternatively, the same area may be the same area of the portion and of the previous portion.

In some exemplary embodiments, a video frame may be analyzed in order to detect one or more objects displayed in the video frame, in order to determine a margin of the video frame, in order to determine areas of activity comprised the video frame, or the like. In some exemplary embodiments, in the case of a sequence of video frames, only a portion of the video frames comprised by the sequence of video frames may be analyzed. In those embodiments, the priority FPS parameter may yield a rate in which video frames may be analyzed. Additionally or alternatively, the priority FPS parameter may yield a rate in which one or more priorities may be obtained, a rate in which one or more priority thresholds may be obtained, or the like.

As an example, a video stream may display a Yoga lesson. The video stream may display a teacher and one or more students. A user may watch the video stream. The user may find the teacher more interesting than the one or more students. The teacher may be associated with a first interest level, a first activity level, or the like. The one or more students may be associated with a second interest level, a second activity level, or the like. The first activity level may be larger than the second activity level. Additionally or alternatively, the first interest level may be larger than the second interest level. A first priory associated with the teacher may be determined. Additionally or alternatively, a second priority associated with one or more students may be determined. The first priority may be larger than the second priority. Based on the first priority, a first FPS parameter may be determined. Additionally or alternatively, based on the second priority a second priority FPS parameter may be determined. The first FPS may be higher than the second priority FPS parameter, yielding that portions of video frames displaying images of the teacher may be processed more often than portions of the video frames displaying images of the one or more students. Additionally or alternatively, portions of the video frame displaying images of the teacher may be processed faster than portions of the video frame displaying images of the one or more students. In some exemplary embodiments, a first computerized process may be determined for processing portions of the video frame displaying the teacher and a second computerized process may be determined for processing portions of the video frame displaying the one or more students. The first computerized process may be associated with a first priority and the second computerized process may be associated with a second priority. The second priority may be smaller than the first priority, yielding that the portions of video frames displaying the one or more students may be processed more slowly compared to portions of video frames displaying the teacher.

In some exemplary embodiments, during the yoga lesson, the teacher may ask a student to show a pose. In that case, a third activity level associated with the student may be determined. Additionally or alternatively, a third interest level associated with the student may be determined. In some exemplary embodiments, based on the third activity level or based on the third interest level, a third priority associated with the student may be determined. The third activity level may be larger than the second activity level. Additionally or alternatively, the third interest level may be larger than the second interest level. Additionally or alternatively, the third priority may be larger than the second priority. Based on the third interest level, on the third activity level, or on the third priority, a third FPS parameter may be determined. The third FPS parameter may be larger than the second FPS parameter, yielding that one or more portions of the video frames displaying images of the student may be processed more often or processed faster compared to portions of the video frames displaying images of other students, portions displaying images of the margins, or the like. In some exemplary embodiments, a new portion of the video frame may be determined. The new portion of the video frame may be associated with the student showing the pose. In some exemplary embodiments, based on determining that the student is showing a pose, another processing channel may be determined. The producer may be configured to utilize the other processing channel for processing portions of the video frame displaying an image of the student. As a result, the one or more portions of the video frame may comprise three portions of the video frame. One portion of the video frame may display an image of the teacher, another portion of the video frame may display the student and an additional portion of the video frame may display images of the other students. In some exemplary embodiments, a fourth portion may display the margin of the video frame.

In some exemplary embodiments, the context information may comprise information regarding a content of the video stream. As an example, the video stream may display a basketball match. A video frame comprised by the video stream may display several objects. A portion of the objects may be associated with one or more basketballers. A first basketballer may be running with a ball and may be associated with an interest level that may be higher than any other interest level that may be associated with other basketballers in the basketball match. Additionally or alternatively, a second basketballer may be closer to the first basketballer compared to a third basketballer. The second basketballer may be associated with a second interest level and the third basketballer may be associated with a third interest level. The second interest level may be higher than the third interest level.

In some exemplary embodiments, an image of the first basket baller may be processed based on a first processing channel. Additionally or alternatively, a second image of the second basketballer may be processed based on a second processing channel. The first processing channel may be associated with a first computerized process, with a first process priority, with a first operation, with a first operation parameter, with a first priority FPS parameter, or the like. Additionally or alternatively, the second processing channel may be associated with a second computerized process, with a second process priority, with a second operation, with a second operation parameter, with a second priority FPS parameter or the like. Put differently or more generally, based on the context information or based on the one or more priorities, one or more processing channels may be determined.

In some exemplary embodiments, for each processing channel, a priority FPS parameter may be determined. Determining the priority FPS parameter may be based on the activity level associated with the processing channel, on the interest level associated with processing channel, or the like. Additionally or alternatively, determining the priority FPS parameter of the processing channel may be based on the context information. In those embodiments, the capturing device may be associated with a capturing FPS parameter. The capturing FPS parameter may be hardware dependent. Additionally or alternatively, the capturing FPS parameter may be a rate in which a capturing device, such as a camera, is configured to capture a sequence of images. The priority FPS parameter associated with the object of interest may be a portion of the capturing FPS parameter such as a half, one third, 90%, or the like. In those embodiments, a video frame counter may be utilized in order to determine whether to process the video frame with respect to the portion of the video frame. As an example, referring again to the magician example, the priority FPS parameter of a portion of the video frame associated with the magician may be one third of the capturing FPS parameter. As a result, every third video frame may be processed with respect to the processing channel associated with the magician.

In some exemplary embodiments, determining the one or more processing channels may be based on the one or more portions of the video frame. In those embodiments, another video frame may be obtained. Additionally or alternatively, a processing channel that may be determined for a portion of the video frame. Additionally or alternatively, the processing channel may be utilized for processing a portion of the other video frame. As an example, the portion of the video frame may display an image of an object. Additionally or alternatively, the portion of the other video frame may display another image of the object. In that example, the processing channel may be utilized for processing the portion of the other video frame.

In some exemplary embodiments, the producer may be configured to perform steps 210, 4300, 4310 at the beginning of the video stream, for a time duration, such as a second, two seconds, or the like. In some cases, the activity level may change above a threshold, or the like at the beginning of the video stream. As an example, in case of an online meeting, a participant of the online meeting may move the camera, may switch on or off a light, or the like. In those embodiments, the producer may be configured to provide, for the time duration, video frames without determining objects, without determining a margin, or the like.

In some exemplary embodiments, a computerized apparatus utilizing the disclosed subject matter may be configured to simultaneously process one or more video streams, one or more audio streams, or the like. In some exemplary embodiments, a same instance of an ML algorithm may be utilized for analyzing two or more media streams. multiple audio streams simultaneously. The ML algorithm may be an object detection algorithm, a face detection algorithm, or the like. One technical effect may be a reduction in required CPUs and RAM for processing a video stream. Additionally or alternatively, a same computerized apparatus utilizing the disclosed subject matter may process more video streams compared to the computerized apparatus not utilizing the disclosed subject matter. As an example, a cloud server may be configured to receive a video stream from a computerized client. Additionally or alternatively, the cloud server may be configured to process the video stream. Additionally or alternatively, the cloud server may be configured to return to the client one or more types of detected objects, one or more locations the one or more detected objects, or the like. Additionally or alternatively, the cloud server may be configured to simultaneously process one or more video streams from one or more computerized clients. Utilizing the disclosed subject matter may allow the cloud server to simultaneously process more streams compared to the cloud server not configured to utilize the disclosed subject matter.

On Step 4360, the one or more portions of the video frame may be processed. In some exemplary embodiments, processing the video frame may comprise performing steps 4362, 4364, 4368, or the like.

On Step 4362, based on a priority that may be associated with a portion, it may be determined if the portion is to be upscaled, deflated, or the like. In some exemplary embodiments, in case that the portion is not upscaled nor deflated, the portion may be copied to a shared memory location. In some exemplary embodiments, the decision of Step 4762 may be used in another video frame. In those embodiments, another portion of the other video frame, located in a same location, may be low encoded or high encoded based on the decision regarding the portion of the video frame. In some exemplary embodiments, on step 4362, two priority thresholds may be utilized, or the like. A first priority threshold may be utilized to determine if to perform Step 4364. In case that the priority is smaller than the first priority threshold, Step 4364 may be performed. Additionally or alternatively, a second priority, may be utilized in order to determine if to perform or more Step 4368. The second priority threshold may be larger than the first priority threshold. In case that the priority is larger than the second priority the portion may be upscaled. Put differently, an interesting portion may be upscaled, a non-interesting portion may be deflated. Additionally or alternatively, another portion, neither interesting nor non interesting may not be processed. In some exemplary embodiments, the other portion may be copied to a shared memory location. In some exemplary embodiments, the other portion may be a processed portion.

On Step 4364, the portion of the video frame may be low processed. low processing the portion of the video frame may comprise deflating the portion of the video frame. deflating the portion of the video frame may be based on a deflating algorithm. see, deflating the portion of the video frame may comprise reducing the number of colors of one or more pixels comprised by the portion of the video frame.

In some exemplary embodiments, deflating the portion of the video frame may be based on a deflating parameter. The deflating parameter may be indicative to the number of colors that may be removed from the portion of the video frame. In some exemplary embodiments, low processing the portion of the video frame may comprise processing the video frame in a computerized process. The computerized process may be associated with a computer process parameter. The computerized process parameter may be indicative to a process priority in which the computerized process may be processing the portion of the video frame. The process priority may be below a threshold. As an example, in Linux, a process may have a process priority between −20 and 19, wherein −20 is a process priority that may be associated with a real time application, with a kernel driver, or the like. The producer may be executed in a process with a process priority of 2. The computerized process may be associated with a larger priority such as 4, 5, 10, 20, or the like. In some exemplary embodiments, as a portion that may be low processed may have [[why is it good]]. The producer may be configured to utilize a previously processed portion.

On Step 4368, the portion of the video frame may be high processed. high processing the portion of the video frame may comprise upscaling the portion of the video frame. upscaling the portion of the video frame may be based on an upscaling algorithm. In some exemplary embodiments, upscaling the portion of the video frame may comprise increasing a resolution of the portion of the video frame.

In some exemplary embodiments, upscaling the portion of the video frame may be based on an upscaling parameter. The upscaling factor may be indicative to the new resolution

In some exemplary embodiments, high processing the portion of the video frame may comprise processing the video frame in a computerized process. The computerized process may be associated with a computer process parameter. The computerized process parameter may be indicative to a process priority in which the computerized process may process the portion of the video frame. The process priority may be above a threshold. The producer may be executed in a process with a process priority of 2. The computerized process may be associated with a larger priority such as −4, −5, −10, −20, or the like.

On Step 4370, a processed portion may be written to a shared memory location. The shared memory location may comprise a RAM, a hard disk, a socket, or the like. In some exemplary embodiments, a consumer may be configured to obtain one or more processed video frames from the shared memory location. In some exemplary embodiments, the video frame may be comprised by a sequence of video frames. A video frame comprised by the sequence of video frames may be obtained. Additionally or alternatively, the video frame may be analyzed. Additionally or alternatively, one or more processing channels may be determined. Additionally or alternatively, the video frame may be processed. Additionally or alternatively, the processed video frame may be written to the shared memory location by writing one or more processed portions of the video frame to the shared memory location. Additionally or alternatively, another video frame may be obtained. The other video frame may be ordered after the video frame in the sequence of video frames. The other video frame may be processed. Additionally or alternatively, processing the other video frame may comprise processing a portion of the one or more portions comprised by the portions of the other video frame. As an example, it may be determined that the video frame may comprise a first area, and second area. Additionally or alternatively, it may be determined that a first portion may be associated with the first area and that a second portion may be associated with the second area. Additionally or alternatively, a first processing channel and a second processing channel may be determined. Additionally or alternatively, the first portion may be processed based on the first processing channel and the second portion may be processed based on the second processing channel. Additionally or alternatively, the two processed portions may be written to the shared memory location. Additionally or alternatively, processing the other video frame may comprise processing the first portion of the other video frame based on the first processing channel. Additionally or alternatively, the processed first portion of the other video frame may be written to the shared memory location. As a result, the shared memory location may comprise a first processed portion of the other video frame and a second processed portion of the video frame.

In some exemplary embodiments, in case that the shared memory location may comprise a RAM, a computerized device may be configured to execute a producer and a consumer simultaneously. The producer may comprise a virtual camera. Additionally or alternatively, the consumer may comprise a video application such a video chat application, a camera application, or the like. Additionally or alternatively, the producer may be configured to obtain one or more video frames from a video stream. The video stream may be obtained from another computerized device, from a local file, or the like. In some exemplary embodiments, the consumer may comprise an editing application, a video chat application, a streaming application, or the like.

In some exemplary embodiments, in case that the shared memory location may comprise a hard disk, the producer may be configured to write the processed portion to a file. As an example, a camera application may be configured to capture one or more video frames. Additionally or alternatively, the one or more video frames may be processed.

In some exemplary embodiments, processing video may comprise encoding the video frame. In those embodiments, the shared memory location may comprise a socket. Additionally or alternatively, the producer may be comprised by a video chat application. Additionally or alternatively, the consumer may be comprised by the video chat application.

It may be noted that the description of high encoding, low encoding, or the like, as described in FIG. 43 may be applied to other embodiments of the disclosed subject matter. As an example, objects may be determined and portions of the video frame may be determined based thereon. Processing one portion of the video frame may comprise high encoding. Additionally or alternatively, processing another portion of the video frame may comprise low encoding.

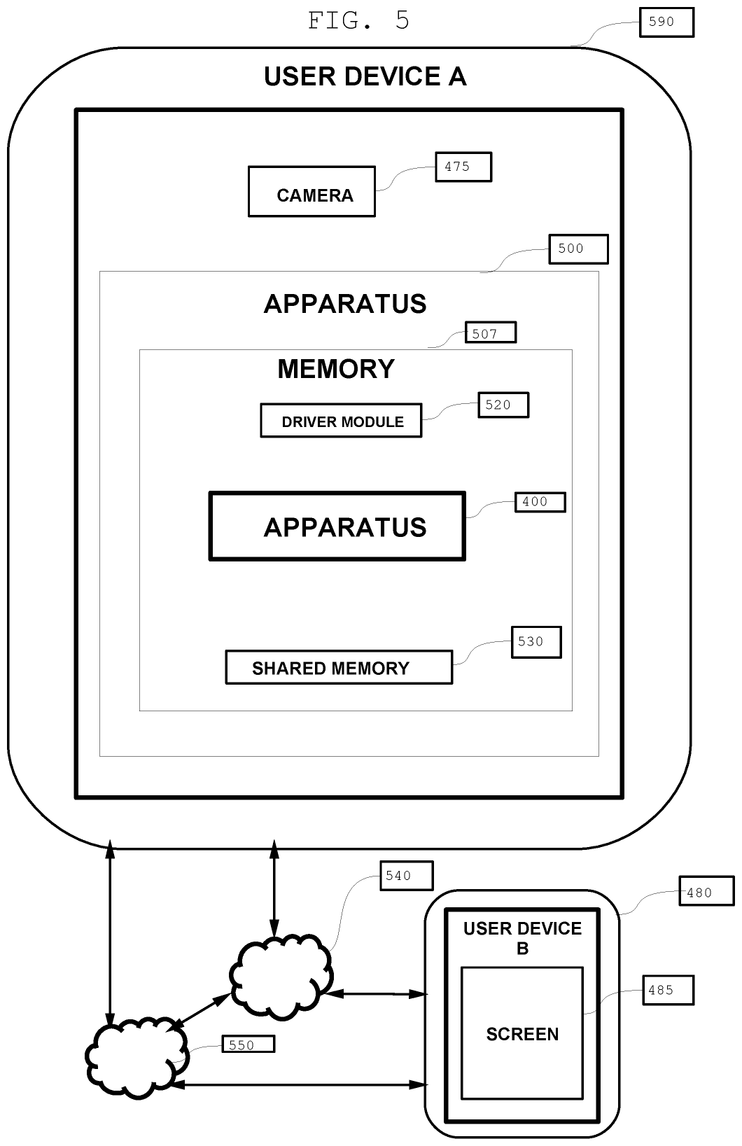

It may be noted that one or more embodiments of the disclosed subject matter may be applied with regards to the embodiment of FIG. 5. As an example, the margin of the video frame may be low processed, an area of low priority may be low processed or an area of high priority may be high processed, or the like.

In some exemplary embodiments, in case that the video frame is comprised by a video stream, the steps of FIG. 43 may be performed a plurality of times, for one or more video frames comprised by the video stream.

Referring now to FIG. 5, showing a flowchart diagram of a method, in accordance with some exemplary embodiments of the disclosed subject matter.

In some exemplary embodiments, the producer may be configured to enforce an age restriction regarding a viewer of the video stream, a content restriction, a privacy restriction, or the like. In those embodiments, a context information may comprise a description of an object displayed in a video frame comprised by the video stream. The description may comprise textual information such as “a person”, “a car”, or the like. Additionally or alternatively, the description may comprise information such as “restricted content”, “sexual content”, or the like. Additionally or alternatively, the context information may comprise a non-textual information such as the age restriction may be associated with one or more bits location in the session description offer. Additionally or alternatively, the context information may comprise a description comprising a numerical value indicating the level of violence that may be associated with the object, a numerical value indicating the level of sexual activity that may be associated with the object, or the like. Additionally or alternatively, the context information offer may comprise a description comprising a numerical value indicating a minimal age that may be recommended for viewing the object. As an example, a numerical value of 10 may indicate that the object may be recommended for viewing by users above the age of 10. As another example a numerical value of 18 may indicate that the content that may be associated with the object may be recommended to view for users above the age of 18. The producer may be configured to set a priority associated with the restricted content to a value below a threshold, yielding that the portion, when processed, is deflated. Additionally or alternatively, a processing channel associated with the portion may comprise an operation parameter. The operation parameter may yield that a deflated portion may not comprise the portion of the object in a manner that a person may see. Additionally or alternatively, the deflated portion may have resolution below another threshold, a number of colors below another threshold, or the like. Additionally or alternatively, an operation parameter may be associated with a processing channel. Additionally or alternatively, a deflating operation may be associated with the processing channel. Additionally or alternatively, the processing channel may be associated with the portion. Additionally or alternatively, the operation parameter may be indicative of a deflation rate such as 95%, 90%, 93%, 98%, or the like.

As an example, the video stream may comprise one or more images of a dog running with a person. Additionally or alternatively, a context information may comprise an age restriction that may indicate that the video stream may be viewed by a child. The child may be 8 years old, 10 years old, or the like. Additionally or alternatively, a first portion of the video frame may comprise a representation of the dog. Additionally or alternatively, a second processed portion of the video frame may comprise a representation of the person. The producer may be configured to process the first portion, the second portion, the margin of the video frame, or the like. In case that the dog is hit by a car, the producer may be configured to omit a portion of the video frame displaying the object associated with the wounded dog, to blur the portion of the video frame displaying the wounded dog, to deflate the portion displaying the wounded dog, or the like.

In some exemplary embodiments, the producer may be configured to determine a priority FPS parameter for an object. The object may be associated with an activity level. A person associated with the object may be still, yielding a low priority FPS parameter compared to a priority FPS parameter that may be associated with the sensor. During the streaming of the video stream, the person may stand, start walking, or the like, yielding a new activity level that may be higher than the activity level. The new activity level may yield that the producer may be configured to determine a new priority FPS parameter for the object.

In some exemplary embodiments, a person may wish to remove her images from a video stream. The video stream provider may be under a privacy regulation such as GDPR or the like. Additionally or alternatively, the producer may be configured to remove the person's images from the video stream. Additionally or alternatively, the video stream may comprise images comprising narcotics, images comprising sensitive security information, or the like. A video stream provider may be forced to remove those images. In those embodiments, in case that the video stream is provided online, the producer may be configured to detect and to blur, to detect and exclude, to detect or to deflate, or the like, such images instead of stopping the video stream. Additionally or alternatively, in case that the video stream is statically provided such as for downloading or in a VOD service, the producer may be configured to detect and to blur, to detect and exclude, to detect and to deflate, or the like, such images instead of re-editing the video stream.

Referring now to FIG. 7 showing an illustration of a sequence of video frames displaying an object, in accordance with some exemplary embodiments of the disclosed subject matter.

Video Frame 700a may display Face Image 710a. Face Image 710a may be associated with an object. The object may be a person, a face of a person, or the like. Face Image 710a may comprise Mouth 720a. Minimal Bounding Shape 730a may be a minimal rectangle comprising Face Image 710a.

Video Frame 700b may display Face Image 710b. Face Image 710b may be associated with the object. Face Image 710b may comprise Mouth 720b. Minimal Bounding Shape 730b may be a minimal rectangle comprising Face Image 710b.

Video Frame 700c may display Face Image 710c. Face Image 710c may be associated with the object. Face Image 710c may comprise Mouth 720c. Minimal Bounding Shape 730c may be a minimal rectangle comprising Face Image 710c.

Video Frame 700a, 700b and 700c, may be a sequence of video frames. Face Image 710a, 710b and 710c may be the results of captures by a sensor of a person at different times. In some exemplary embodiments, between each capture, a time may elapse. The time may be 20, milliseconds, 25 milliseconds, 50 milliseconds, 100 milliseconds, or the like.

As can be seen, the object may change in the sequence. An activity level for the object may be calculated based on Minimal Bounding Shape 730a, Minimal Bounding 730b or Minimal Bounding 730c. The activity level may be calculated by determining an average difference between a first difference and a second difference. The first difference may be the difference between Minimal Bound Shape 730a and Minimal Bounding 730b. The second difference may be the difference between Minimal Bounding Shape 730b and Minimal Bounding 730c. In some cases, there may be more than one object. For each object, an activity level may be determined separately. Additionally or alternatively, for each bounding shape an activity level may be determined separately.

In some exemplary embodiments, the sequence of video frames may comprise video frames 700a and 700b. In those embodiments, a sequence of portions of the sequence of video frames, may be determined. A portion comprised by the sequence of portions may be a portion. In some exemplary embodiments, each portion may be associated with a same area of interest. In some exemplary embodiments, the area of interest may be determined based on areas of importance. An area of interest may be an area in a video frame. Additionally or alternatively, the area of impotence may be important to a user. The area of importance may be an area of activity, an area of interest, may comprise a portion of an object, one or more portions of one or more objects, or the like. Additionally or alternatively, each portion comprised by the sequence of portions may be associated with a same location in the video frames. As an example, the area of importance may display a same object. The same object may be a person displayed in FIG. 7. In this example, Minimal Bounding Shape 730a may be a first portion of the video frame. Additionally or alternatively, Minimal Bounding Shape 730b may be a second portion of the video frame. The sequence of portions of the sequence of video frames may comprise the first and second portions of the video frames. As can be seen, each portion comprised by the sequence is displaying an image of the person. In some exemplary embodiments, one or more processing channels may be determined. In some exemplary embodiments, processing the one or more video frames may utilize the one or more processing channels. In the example of FIG. 7, Minimal Bounding shape 730a and Minimal Bounding Shape 730b may be processed by utilizing a processing channel comprised by the one or more processing channels.

In some exemplary embodiments, another video frame may be obtained. Processing the other video frame may be based on the one or more sequences of portions of the sequence of video frames. In some exemplary embodiments, processing the other video frame may comprise determining one or more portions of the other video frame. In the example of FIG. 7, the other video frame may be Video Frame 700c. A portion of Video Frame 700c may be Minimal Bounding Shape 730c. Minimal Bounding Shape 730c may be processed in the processing channel as Minimal Bounding Shape 730c may display an image of the same object. In some exemplary embodiments, another object (not shown), may be displayed in Video Frame 700c. In those embodiments, another processing channel may be determined. Additionally or alternatively, a portion of Video Frame 700c displaying the other object may be processed by utilizing the other processing channel.

In some exemplary embodiments, Minimal Bounding Shapes 730a, Minimal Bounding Shape 730b and Minimal Bounding Shape 730c may be a same bounding shape. In those embodiments, the three minimal bounding shapes may be associated with a same location within the video frames, may be of a same width, of a same height, of a same dimensions, or the like.

In some exemplary embodiments, a sequence may be determined based on a location within the video frames. As an example, the sequence of low priority may be determined. In the example of FIG. 7, the sequence of low priority may comprise the complement of Minimal Bounding Shape 730a in Video Frame 700a. Additionally or alternatively, the sequence of low priority may comprise the complement of Minimal Bounding Shape 730b in Video Frame 700b. In some exemplary embodiments, another processing channel may be utilized in order to process the sequence of low activity thereby.

In some exemplary embodiments, a priority FPS parameter may be determined. In some exemplary embodiments, the priority FPS parameter may be associated with a processing channel. In those embodiments, determining one or more processing channels may comprise determining one or more priority FPS parameters. Based on the FPS parameter, a portion of the video frame may be excluded from portions of the video frame. In some exemplary embodiments, processing a sequence of portions may comprise excluding a portion from being processed. Excluding the portion may yield less required hardware resources compared to not excluding the portion. As an example, Minimal Bounding Shape 730a may be comprised by the portions of the Video Frame 700a. Additionally or alternatively, Minimal Bounding Shape 730b may be excluded from the portions of the Video Frame 700b. Additionally or alternatively, Minimal Bounding Shape 730c may be comprised by the portions of the Video Frame 700c.

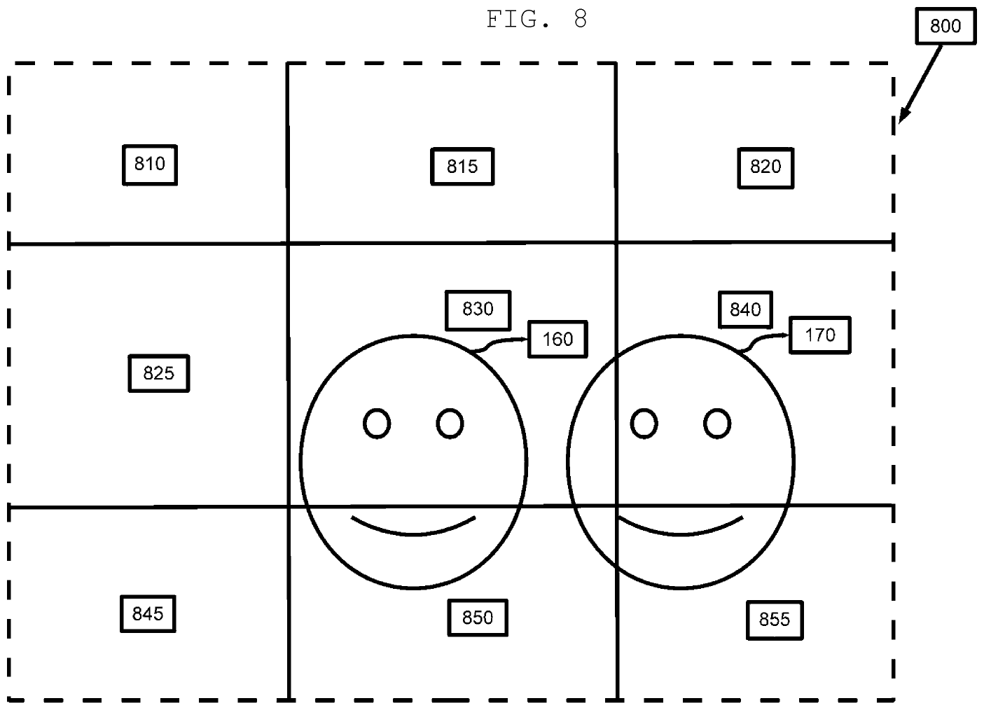

Referring now to FIG. 8 showing an illustration of one or more portions comprised by a video frame, in accordance with some exemplary embodiments of the disclosed subject matter. In those embodiments, the one or more portion of the video frame may be one or more rectangles.

Video Frame 800 may comprise Object 160 and Object 170.

In some exemplary embodiments, a unification of Rectangle 810, Rectangle 815, Rectangle 820, Rectangle 825, Rectangle 830, Rectangle 840, Rectangle 845, Rectangle 850 and Rectangle 855 may comprise Video Frame 800. In those embodiments, a producer may process each rectangle in a different processing channel.

As can be seen, Rectangle 810, Rectangle 815, Rectangle 820, Rectangle 825 and Rectangle 845 display no portion of an object. In some exemplary embodiments, Rectangle 810, Rectangle 815, Rectangle 820, Rectangle 825 and Rectangle 845 may be low processed. Additionally or alternatively, Rectangle 830, Rectangle 840, Rectangle 850 and Rectangle 855 may be high processed as they comprise a portion of an image of an object.

In some exemplary embodiments, processing Rectangle 810, Rectangle 815, Rectangle 820, Rectangle 825 and Rectangle 845 may comprise utilizing one or more deflating algorithms. Additionally or alternatively, processing Rectangle 830, Rectangle 840, Rectangle 850 and Rectangle 855 may comprise utilizing one or more upscale algorithms. As an example, a first encoder may be determined by applying a first encoder parameter. Applying the first encoder parameter on the first encoder may yield that the first encoder is configured to perform two passes on an input video frame. Additionally or alternatively, a second encoder may be determined. The first encoder may be utilized for encoding Rectangle 830, Rectangle 840, Rectangle 850 and Rectangle 855. Additionally or alternatively, the second encoder may be utilized for encoding Rectangle 810, Rectangle 815, Rectangle 820, Rectangle 825 and Rectangle 845. Additionally or alternatively, four instances of the first encoder may be determined, each of which may be utilized to encode one of the rectangles 830, 840, 850, 855. Additionally or alternatively, five instances of the second encoder may be determined, each of which may be utilized for encoding one of the rectangles 810, 815, 820, 825, 845. It may be noted that performing two passes on the entire video frame may take too long, may require hardware resources that may not be available, or the like.

In some exemplary embodiments, in the case that the video frame comprised by a sequence of video frames, another video frame comprised by sequence may be obtained. The producer may be configured to determine a portion of the other video frame based on the portion of the video frame. In some exemplary embodiments, determining the one or more portions of the video frame may comprise determining not to process a portion of the video frame. Additionally or alternatively, other portions may be processed. As an example, the producer may be configured to determine that Rectangle 810, Rectangle 815, Rectangle 820, Rectangle 825, Rectangle 845, may be excluded from the portions of the other video frame as processing the portions of the video frame comprises processing those rectangles.

Referring now to FIG. 9 showing an illustration of rectangles slicing a video frame, in accordance with some exemplary embodiments of the disclosed subject matter.

Video Frame 900 may comprise Object 160 and Object 170. In that example, Object 160 may be associated with a higher interest level than Object 170. Additionally or alternatively, Object 160 may be associated with a higher activity level than Object 170.

In the illustrated embodiment, the producer may be configured to determine one or more rectangles based on the interest level of each object, based on the activity level of each object, based on a context information associated with the video stream, or the like.

As can be seen, Rectangle 915 comprises no object. Hence, Rectangle 915 may have a larger area compared to other rectangles determined by the producer.

As can be seen, Object 160 may be associated with 5 rectangles. In the illustrated embodiment, as eyes or a mouth of a person may move more rapidly compared to a person's forehead, Rectangle 945 may comprise the left eye of the person, Rectangle 950 may comprise the right eye of the person, Rectangle 955 and Rectangle 960 may comprise a portion of the mouth of the person. Additionally or alternatively, one rectangle, Rectangle 930 may comprise the person's forehead.

As can be seen, Rectangle 915 and Rectangle 965 comprise no object. In some exemplary embodiments, Rectangle 915 and Rectangle 965 may be low processed. Additionally or alternatively, Rectangle 930, Rectangle 935, Rectangle 940, Rectangle 945, Rectangle 950 Rectangle 955, and Rectangle 960 may be high processed as they comprise a portion of an image of an object.

In some exemplary embodiments, portions comprising Rectangle 930, Rectangle 945, Rectangle 950, Rectangle 955, Rectangle 960 and Rectangle 965 may be processed based on a first processing channel. The first processing channel may comprise a first operation parameter such as a first upscaling rate. Additionally or alternatively, Rectangle 935, Rectangle 940, Rectangle 970 and Rectangle 980 may be processed based on a second processing channel. The second processing channel may comprise a second upscaling rate. In some exemplary embodiments, Object 160 may be associated with a first interesting level. Additionally or alternatively, Object 170 may be associated with a second interest level. The first interest level may be larger than the second interest level. Additionally or alternatively, the first upscaling rate may be larger than the second upscaling rate. As a result, a processed first portion may be associated with a first resolution larger than a second resolution associated with the second portion.

In some exemplary embodiments, the dimension of the rectangle may be large enough for the rectangle to comprise an object. The object may be a person, an eye of a person, a face of a person, or the like. Additionally or alternatively, the object may be an airplane, a car, a boat, a tree, or the like. In some exemplary embodiments, the dimensions may be large enough to enable the rectangle to comprise one or more objects such as one or more people, one or more cars, or the like. The dimensions may be 128×512 pixels, 313×427 pixels, or the like.

In some exemplary embodiments, dimensions of a rectangle may be determined based on a context information. In some exemplary embodiments, the context information may comprise information regarding a content of the video frame, a content of a video stream comprising the video frame, or the like. As an example, the context information may be indicative to one or more people displayed in the video frame. Dimensions of a rectangle may be above a threshold yielding that the dimension of the rectangle may be large enough so the rectangle may comprise an image of the one or more persons.

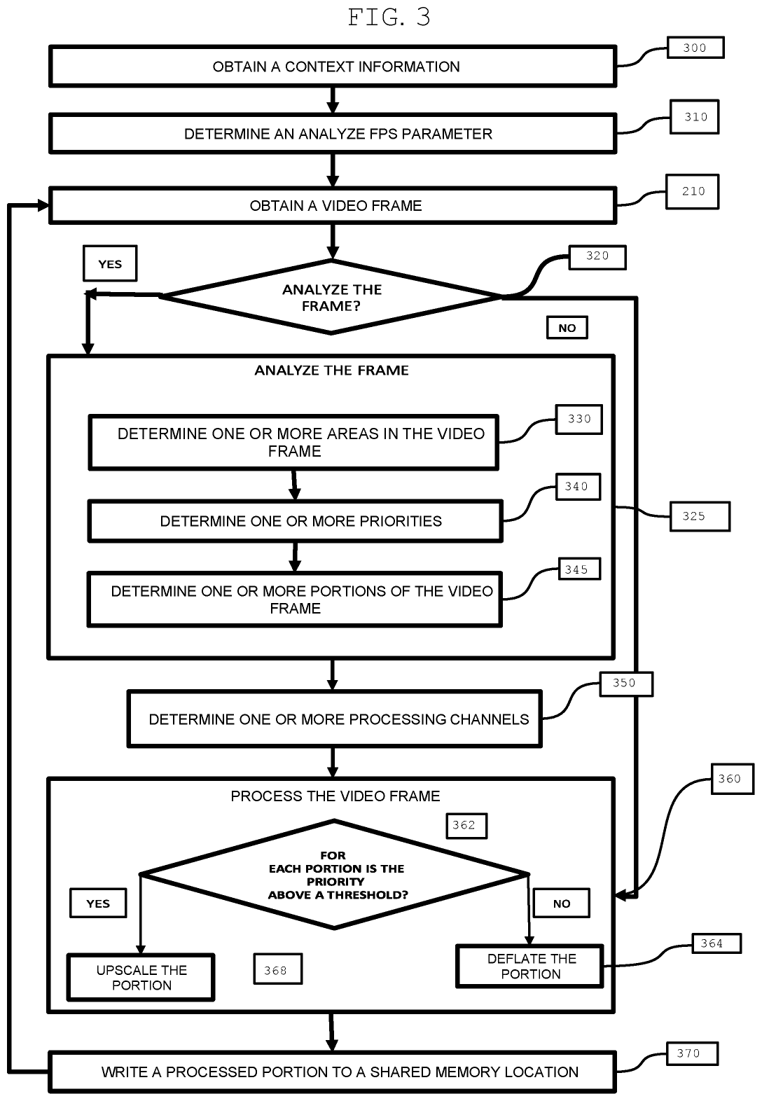

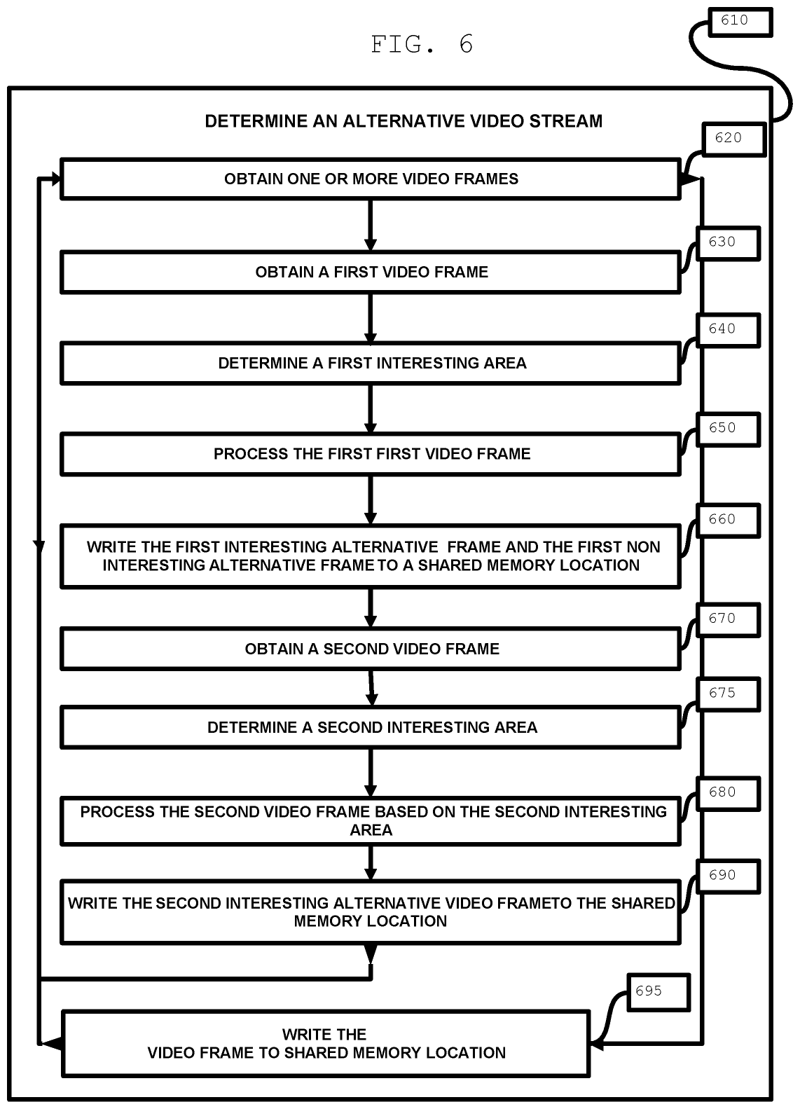

In some exemplary embodiments, a computerized apparatus may be configured to perform or more the steps of FIG. 2, of FIG. 3, of FIG. 46, of FIG. 511, of FIG. 6, or a combination thereof. In some exemplary embodiments the computerized apparatus may be a server, a cloud server, or the like.

In some exemplary embodiments, a computerized apparatus may be configured to determine one or more instances in order to scale the processing of one or more video frames. In some exemplary embodiments, an instance comprised by the one or more instances may be the computerized apparatus, another computerized apparatus, or the like. In some exemplary embodiments, an instance may be associated with one or more hardware capabilities. A hardware capability may comprise a number of one or more CPUs that may be utilized by the instance, a number of cores of a CPU, a clock rate of the CPU, or the like. Additionally or alternatively, the hardware capability may comprise a number of one or more Graphics Processing Units (GPU) that may be utilized by the instance, a number of cores of a GPU comprised by the one or more GPUs, a clock rate of the GPU, or the like. Additionally or alternatively, the hardware capability may comprise one or more characteristics of a RAM that may be utilized by the instance, bandwidth limitations that may be set upon an instance, or the like. In some exemplary embodiments, the computerized apparatus may be configured to obtain a context information. Additionally or alternatively, the computerized apparatus may be configured to determine the one or more instances based on the context information. In some exemplary embodiments, given the context information, the computerized apparatus may be configured to determine a configuration based on the context information. The configuration may comprise a number of instances and one or more hardware capabilities associated with the one or more instances. As an example, a video stream may display an NBA match, requiring a large amount of RAM, CPUs, or the like, compared to an online meeting. The context information may comprise fields such as “NBA”, “online”, or the like. Based on the context information, the computerized apparatus may be configured to determine a configuration to enable streaming the video stream. In some exemplary embodiments, the context information may be obtained periodically. In those embodiments, the context information may be updated in response to a change of a latency, in response to a consumer that may be connecting, in response to the consumer that may be disconnecting, in response to one or more changes in the one or more priorities, wherein a change is above a threshold, or the like.

In some exemplary embodiments, determining the one or more processing channel may comprise determining the one or more instances. In those embodiments, a processing channel may be associated with a portion of the one or more instances. In those embodiments, processing a portion of the video frame by utilizing the processing channel may comprise processing the video frame on the instance.

Additionally or alternatively, the video stream may be provided to a large number of consumers such as 100, 100,000, 1 million, 10 million, or the like. In some cases, users of the one or more consumers may be distributed geographically. The context information may comprise the number of users and the geographical distribution of the consumers. The computerized apparatus may be configured to determine a configuration that may enable the video stream. In some cases, a first portion of the users may be located in North America and a second portion of the consumers may be located in Europe. In those embodiments, the configuration may comprise a geographical distribution of the one or more instances. Additionally or alternatively, the configuration may comprise one or more computerized apparatuses. As an example, the computerized apparatus may be configured to determine a first portion of the one or more instances to be located in North America. Additionally or alternatively, the computerized apparatus may be configured to determine another portion of the one or more instances to be located in Europe.

In some exemplary embodiments, the context information may comprise an indication that the video stream is to be retained for future downloads. The computerized apparatus may be configured to determine one or more instances in order to minimize the processing time, to minimize the costs of the one or more instances, or the like. As an example, the disclosed subject matter may be utilized in order to prepare a movie to be streamed in as a VOD content, as a VR content, or the like. In case that preparing the content is cost sensitive, the producer may be configured to determine a configuration comprising a number of instances below a threshold. Additionally or alternatively, the configuration may comprise a hardware capability. The hardware capability may comprise a combination of CPU, memory capacity, storage capacity, networking capacity, or the like. Additionally or alternatively, the computerized apparatus may be configured to determine a weak one or more instances, or the like. In some exemplary embodiments, a weak instance may be associated with a number of CPUs below a threshold, with a memory capacity below a threshold, with a storage capacity below a threshold, with a network capacity below a threshold may be a weak capacity. Additionally or alternatively, in case that preparing the movie is time sensitive, the producer may be configured to determine a number of instances above another threshold, to determine strong instances, or the like. In some exemplary embodiments, a strong instance may be an instance with capacities above a threshold.

In some exemplary embodiments, the computerized apparatus may be configured to determine a portion of the context information. As an example, the computerized apparatus may be configured to determine a number of one or more consumers consuming the video stream, to measure one or more latencies between the one or more instances and the one or more consumers, between the computerized apparatus and the one or more consumers, or the like.

In some exemplary embodiments, the computerized apparatus may be configured to determine the one or more instances based on the one or more objects. As an example, in case that a number of the one or more objects is above a threshold, more instances may be required in order to process a video frame compared to another video frame comprising another number of another one or more objects, wherein the other number is smaller than the threshold. Additionally or alternatively, stronger instances may be required in order to process the video frame compared to the other video frame. In some exemplary embodiments, the computerized apparatus may be configured to determine one or more instances based on one or more interest levels, based on one or more activity levels, based on one or more objects displayed in the video frame, or the like. Hence, the producer may be configured to determine, indirectly, the one or more instances based on the one or more portions of the video frame, on the one or more portions of the video frame, or the like.

In some exemplary embodiments, the computerized apparatus may be configured to determine the one or more instances based on the one or more interest levels, based on the one or more interest thresholds, or the like. As an example, a video frame may comprise a number of objects above a threshold. Additionally or alternatively, only one object may be associated with an interest level above an interest threshold. In those embodiments, the computerized apparatus may be configured to determine a first number of instances. Additionally or alternatively, another video frame may comprise another one or more objects. In that case, only one object may be associated with an interest level that is smaller than an interest threshold. Additionally or alternatively, all other objects comprised by the other one or more objects may be associated with an interest level that may be larger than an interest threshold. In that case, the computerized apparatus may be configured to determine another number of objects. In those embodiments, the number of instances may be smaller than the other number of instances.

In some exemplary embodiments, the computerized apparatus may be configured to determine the one or more instances based on the one or more activity levels, based on the one or more activity thresholds, or the like. As an example, a video frame may comprise a number of objects above a threshold. Additionally or alternatively, only one object may be associated with an activity level above an activity threshold. In those embodiments, the computerized apparatus may be configured to determine a first number of instances. Additionally or alternatively, in another case, another video frame may comprise another one or more objects. In that case, only one object may be associated with an activity level that is smaller than an activity threshold. Additionally or alternatively, all other objects comprised by the other one or more objects may be associated with an activity level that may be larger than the activity threshold. In that case, the computerized apparatus may be configured to determine another number of instances. In those embodiments, the number of instances may be smaller than the other number of instances.

In some exemplary embodiments, the computerized apparatus may be configured to obtain a context information from one or more consumers. The context information may comprise the one or more consumer context information. The computerized apparatus may be configured to determine a number of instances based on the one or more consumer context information, to determine a required hardware capability that may be associated with the one or more instances, or the like. As an example, in one case, a portion of the one or more consumers may be utilizing a small screen as a rendering device. In another case, the portion of the one or more consumers may utilize a large screen as the rendering device. In both cases, the size of the rendering device may be comprised by the consumer context information and provided to the computerized apparatus. In the first case, less instances may be determined compared to the second case. Additionally or alternatively, in the first case, the required one or more hardware capabilities of an instance may be weaker than one or more required hardware capabilities of the second case, or the like.

In some exemplary embodiments, the computerized apparatus may be configured to determine one or more instances based on the one or more portion of the video frame. Each instance may be associated with a portion of the video frame. As an example, in case that the video frame is a large frame such as 4K frame, 8K frame, or the like, more than one instance may be required in order to determine portions of the video frame, to process the one or more portions of the video frame, or the like.

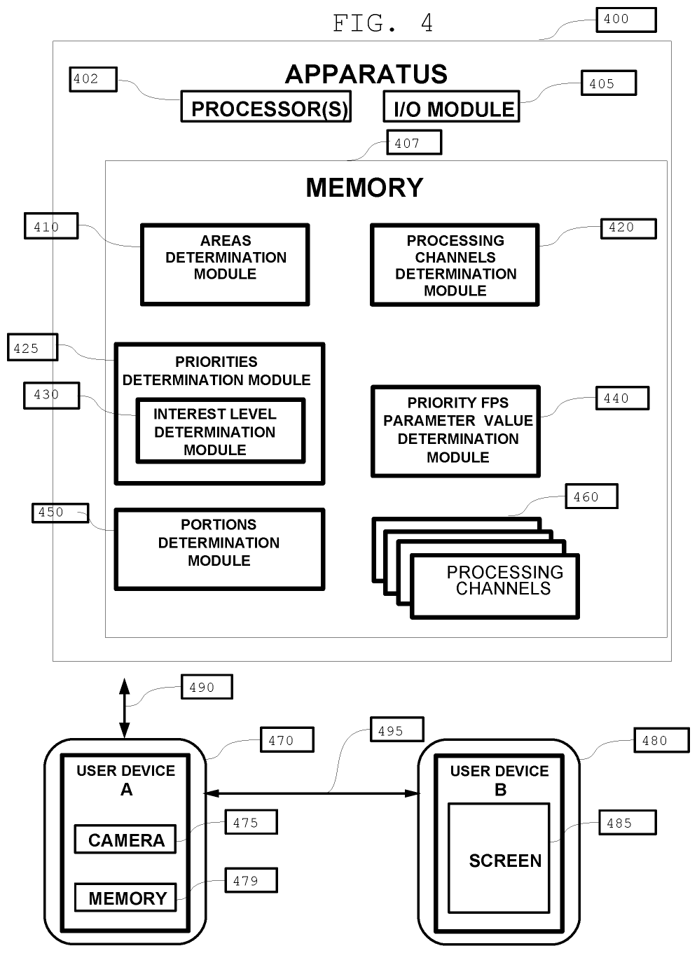

In some exemplary embodiments, a camera application, such as a smartphone camera application, may be configured to obtain one or more video frames or may be configured to stream the one or more video frames to a user. In case that the user presses a button, touches the screen, or the like, a video frame may be retained on a local medium, on a remote medium, attached to a message, or the like. In those embodiments, a producer may be operatively coupled with the camera application. The producer may be configured to perform the Steps of FIG. 2, FIG. 2B3, FIG. 3A6 and, FIG. 3B11, FIG. 4, FIG. 5, or FIG. 6. Additionally or alternatively, another video frame may be retained in response to obtaining an input from a user. In some cases, the producer may stream the one or more video frames to a consumer and the consumer may be configured to retain a video frame upon the user press of the button, touch in the screen, or the like.

In some exemplary embodiments, a VR/AR provider may utilize the disclosed subject matter in order to provide a VR content. In those embodiments, an overlay may be added to an obtained video frame. The overly may be provided as an object, as an area of importance, or the like. As an example, an AR/VR application may be configured to add a description to items displayed by the obtained video frame. The description may be provided with a location to the producer. Additionally or alternatively, the producer may be configured to determine a processing channel to the overlay. Additionally or alternatively, the overlay may be comprised by the portions of the video frame. As an example, the AR/VR application may be configured to add one or more images of one or more people to one or more images of a room in a streaming application. The consumer may be configured to obtain one or more images of the one or more people in one or more consumer processing channels.

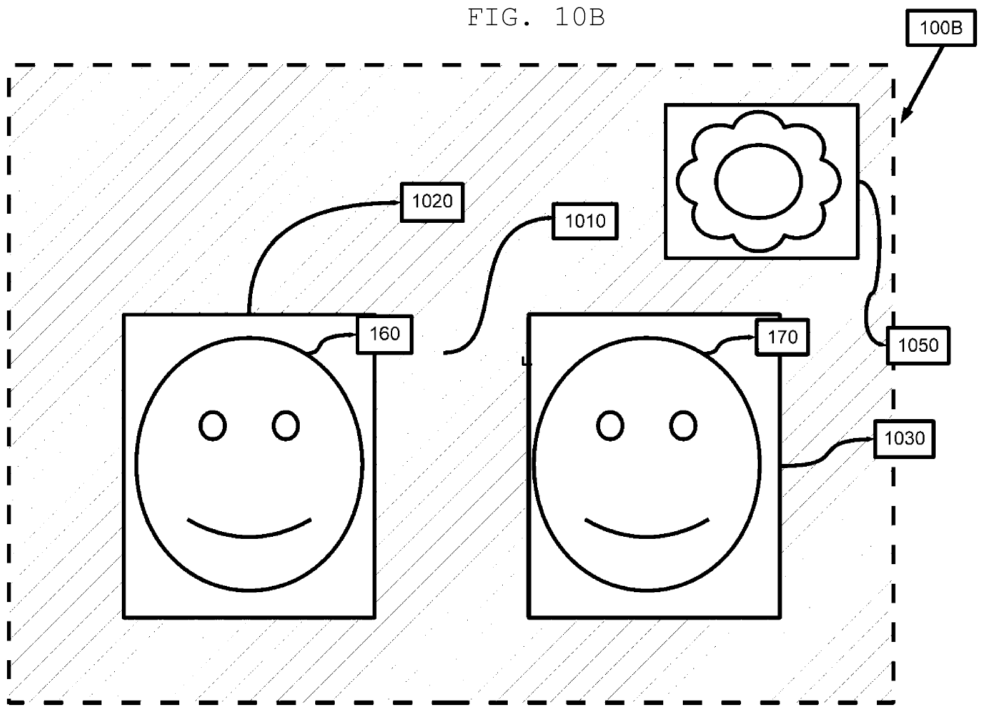

Referring to FIG. 11, showing a flow chart of a method in accordance with the disclosed subject matter.

On Step 1100, a video frame may be obtained. The video frame may be obtained from a light sensor, such as a camera of a smartphone, a webcam of a laptop, a laser scanning system, a street camera, or the like.

On Step 1120, one or more areas of interest of the video frame may be determined. In some exemplary embodiments, determining the areas of interest of the video frame may comprise detecting one or more objects displayed in the video frame. In those embodiments, an area of interest of the video frame may display an object, may display a portion of an image of an object, or the like.

In some exemplary embodiments, a context information may be obtained. The context information may comprise a user information. The user information may comprise data regarding one or more users using one or more computerized devices. A computerized device may utilize the disclosed subject matter. Additionally or alternatively, the user information may comprise context information, may comprise user context information, or the like. As an example, the disclosed subject matter may be utilized by a video chat application. In those embodiments, the user may be a person using a computerized device. A processed video frame comprised by the one or more encoded video frames may comprise one or more processed portions of the video frame. In those embodiments, determining the portions of the video frame may be based on the user context information. The user information may comprise data regarding the user's preferences, the user's interests, or the like.

In some exemplary embodiments, one or more points of gaze of one or more users may be obtained. In those embodiments, the user information may comprise a point of gaze comprised by the one or more points of gaze. As an example, the disclosed subject matter may be utilized by a Virtual Reality (VR) application, by an Augmented Reality (AR) application, or the like. The application may be configured to provide to a user a 360 degrees view of a room. In case that the user is looking at the door, the door and the surrounding of the door may be associated with high priority.

In some exemplary embodiments, the video frame may be provided to a user. The user may point one or more areas in the video frame by clicking a mouse, by clicking a digital pen, or the like. one or more locations of the points of the user within the frame may be obtained. The user information may comprise the one or more locations. As an example, the user may be an editor editing a video. The video frame may comprise one or more images of one or more objects. The user may point a location comprised by a display of an object. In that case, an area within the video frame comprising the object may be an area of interest.

In some exemplary embodiments, the disclosed subject matter may be utilized by a computerized device configured to send one or more video frames. As an example, the computerized device may be a smartphone. The user may use an instant messaging application in order to send the one or more video frames. Additionally or alternatively, another user may be using a smartphone to receive the one or more video frames. In those embodiments, the user context information may comprise data about the user, data about the other user, a combination thereof, or the like. In some cases, an area displaying an object may be an area of interest. As an example, a user may utilize a camera in order to capture an image of one or more people. The user context information may comprise a point of gaze of the user. The user may look at a person comprised by the one or more people. Based on a point of gaze of the user, it may be determined that an area of the video frame displaying the person is an area of interest.

In some exemplary embodiments, a non-interesting area may be determined. In those embodiments, the non-interesting area may be the outcome of subtracting a unification of a portion of the one or more areas of interest from the video frame. In some exemplary embodiments, one or more portions of the video frame may be determined based on the non-interesting area. In those embodiments, the one or more portions may be processed by utilizing one or more processing channels. In some exemplary embodiments, one or more processing channels may be determined to process the one or more portions comprised by the non-interesting area. As an example, in case that the non-interesting area comprises a margin of the video frame, four portions may be determined as exemplified in FIG. 1.

In some exemplary embodiments, as an area of interest may be defined based on an object, the area of interest may be defined as having a minimal size above a predetermined threshold, such as above 4,096 (64×64) pixels, 16,384 (128×128), 1,000,000 (800×1250), or the like. In some cases, the minimal size may be defined based on a relative size to the frame size (e.g., at least 5% of the area of the frame, at least 3% of the width of the frame, at least 10% of the height of the frame, or the like). In case the size is smaller than the predetermined threshold, the shape may not be considered as encompassing an area of interest.

On Step 1130, one or more portions of the video frame may be determined. a portion comprised by the one or more portions may be a portion. In some exemplary embodiments, a unification of the one or more portions of the video frame may be comprised by the video frame, may be smaller than the video frame, or the like. Additionally or alternatively, it may be determined to process each portion comprised by the one or more portions of the video frame, yielding a one-to-one correspondence between the one or more portions of the video frame and the one or more areas of the video frame. Put differently, a portion may be defined based on an area of interest of the video frame. Additionally or alternatively, another portion may be defined based on a non-interesting area. In some exemplary embodiments, determining the one or more portions of the video frame may be based on a user information. As an example, the user information may comprise information regarding an application utilizing the disclosed subject matter. In some exemplary embodiments, the application may be a video chat application. Additionally or alternatively, the user information may indicate that the video chat application is utilized for an online meeting. In those embodiments, portions of the video frame comprising a representation of the faces of the participant may be processed. Additionally or alternatively, portions of the video frame displaying a portion of the margins of the video frame may be excluded from the one or more portions of the video frame.

In some exemplary embodiments, the video frame may comprise an interesting area and a non-interesting area. The interesting area may be determined based on a unification of a portion of the one or more areas of interest. As an example, the video frame may display a number of objects above a threshold. The threshold may be 2 objects, 5 objects, or the like. It may be determined that the 5 largest objects are more interesting than the other objects. The interesting area may comprise a unification of the areas of interest displaying the 5 largest objects. Additionally or alternatively, the unification may comprise an area between the 5 largest objects, yielding that the unification is a continuous area. Additionally or alternatively, the non-interesting area may be determined as the complement of the unification. It may be noted the non-interesting area may comprise an area of interest displaying an object. As an example, a person may take a picture of her family at a wedding. The picture may comprise many people such as 10 people, 20 people, or the like. Only the images of the 5 closest people to the person may be comprised by the interesting area. In those embodiments, two portions may be determined. An interesting portion may be associated with the interesting area. Additionally or alternatively, a non-interesting portion may be associated with the non-interesting area. In some exemplary embodiments, the non-interesting area may comprise a margin of the video frame as exemplified by FIG. 1.

In some exemplary embodiments, an operation parameter may comprise a desired quality of a portion of a video frame, a desired processing time of the portion, the dimensions of the portions of the video frame, or the like.

In some exemplary embodiments, determining the one or more processing channels may comprise determining at least one non-interesting processing channel. The non-interesting processing channel may comprise a non-interesting processing operation. A non-interesting processing operation may be a processing operation associated with a non-interesting processing parameter. A non-interesting processing parameter may be a processing parameter causing the processing channel to process a non-interesting portion more slowly compared to an interesting parameter, causing the processing channel to encode the non-interesting portion in a lower quality compared to an interesting portion, or the like.

In some exemplary embodiments, a non-interesting operation may be a deflating operation. The deflating operation, when performed on a portion of the video frame, may result in a portion comprising less information. The deflating operation may comprise reducing the number of colors, performing Gaussian filtering, or the like. In some exemplary embodiments, the non-interesting operation may be an operation associated with a processing channel. The processing channel may be associated with a non-interesting portion of the video frame, with a margin of the video frame, or the like.

In some exemplary embodiments, an-interesting operation may be an upscaling operation. The upscaling operation, when performed with respect to a portion of the video frame, may result in a portion comprising more information. In some exemplary embodiments, an object displayed in the portion may look better after upscaling. Additionally or alternatively, the portion may comprise more colors. In some exemplary embodiments, the interesting operation may be an operation associated with a processing channel. The processing channel may be associated with an interesting portion of the video frame, or the like.

In some exemplary embodiments, a portion of the video frame may be provided as an input to a processing channel. A portion may be provided to a processing channel based on a location of the portion in the video frame. In case that the video frame is comprised by a sequence of video frames, a portion of the video frame may be provided to a processing channel. Additionally or alternatively, another portion comprised by another video frame may be provided to the processing channel. The portion and the other portion may have a same location in the sequence of video frames. Additionally or alternatively, the portion and the other portion may display a same portion of a same object.

In some exemplary embodiments, determining whether to perform or more Step 1120 after Step 1180 or whether to perform or more Step 1130 after Step 1180 may be based on a difference between the video frame and the other video frame. In case that the difference is above a threshold the other video frame may display different objects compared to the video frame. Additionally or alternatively, an object that may be displayed in the video frame may be displayed in a different location in the other video frame. Additionally or alternatively, the object may appear as if it rotates between the two frames, the light may change, or the like. In those cases, it may be desired to perform or more Step 1120 again in order to re-determine areas of the video frame, portions of the other video frame.

In some exemplary embodiments, determining whether to perform or more Step 1120 after Step 1180 or whether to perform or more Step 1130 after Step 1180 may be based on a difference between an area comprised by the video frame and based on another area comprised by the other video frame. In those embodiments, the area may be associated with a location and a dimension in the video frame. Additionally or alternatively, the other area may be associated with another location and another dimension in the other video frame. Additionally or alternatively, a difference between the location and the other location may be below a threshold. The threshold may be 1 pixel, 5 pixels, 90 pixels, 280 pixels, or the like. Additionally or alternatively, the threshold may be based on a percentage out of the size of the video frame, such as 1%, 3% or the like. Additionally or alternatively, another difference between the dimensions and the other dimension may be below another threshold. Additionally or alternatively, the other threshold may be based on a percentage out of the size of the video frame, such as 1%, 3% or the like.

In some exemplary embodiments, in case that the difference is below the threshold, determining a portion of the other video frame may be based on another portion of the other video frame. In some cases, the portion of the video frame may be associated with a same area as the other portion of the other video frame.

In some exemplary embodiments, determining whether to perform or more Step 1140 or not to perform or more Step 1140 after Step 1180 may be based on a change in the user information. As an example, in case that the user information comprises data regarding a change in the connectivity, indicating that internet packets comprising processed portions may be dropped, a processing channel may be altered. Additionally or alternatively, a new processing channel may be determined. A previous processing channel may comprise an upscaling operation. The new processing channel may not comprise the upscaling operation. Additionally or alternatively the altered processing channel may not comprise the upscaling operation. Additionally or alternatively, an operation parameter may be indicative of an upscaling parameter. The new processing channel may comprise a new upscaling parameter indicative to a smaller upscaling rate. Additionally or alternatively, the operation parameter may be altered to the new operation parameter. Additionally or alternatively, the processing channel may comprise a deflating operation associated with another parameter indicative of a deflating rate. The new processing channel may comprise a new operation parameter indicative of a lower deflating rate. Additionally or alternatively, the other parameter may be altered to the new operation parameter.

Referring now to FIG. 1211 showing a flowchart diagram of a method, in accordance with some exemplary embodiments of the disclosed subject matter.

In some exemplary embodiments, there may be two areas in a sequence of video frames comprised by the video stream. The first area may be an area of interest in the sequence of video frames. The second area may be a non-interesting area in the sequence of video frames. As an example, in case that the video stream is displaying a basketball match, the first area may be an inner area displaying one or more players, a portion of the court, or the like. Additionally or alternatively, the second area may be a non-interesting area such as the margins of one or more video frames comprised by the sequence of video frames.

On Step 12110, the first area and the second area may be determined. In some exemplary embodiments, Step 121110 may comprise Step 121120, Step 12130, or Step 121140.

On Step 121120, a detection counter may be utilized. The detection counter may be indicative to previous object detections that may have been performed with respect to previous frames. A threshold of the detection counter may be calculated based on an activity level of the sequence of video frames. The activity level may measure a difference between two or more video frames comprised by the sequences of video frames. As an example, in case that the video stream is displaying a car race, the difference between two consecutive frames may be larger than another difference of two consecutive video frames comprised by a video stream displaying a person that is lecturing. In the case of the car race it may be desired to perform or more object detection more often compared to the lecturing case. It may be noted that detecting objects with a video frame may yield a location of the objects in the video frame allowing to determine an area of interest comprised by the frame. In some exemplary embodiments, as the objects may move, detecting objects may yield a new interesting area, a new non-interesting area, or the like.

In some exemplary embodiments, in case that the counter is above the threshold Step 121130 may be performed yielding that one or more objects that may be displayed in the video frame may be detected. Additionally or alternatively, in case that the counter value is below the threshold, Step 121140 may be performed. In that case, a previous detection of objects may be utilized. The previous detection may refer to object detection that may have been performed on a previous video frame in the sequence of video frames.

On Step 121150, two processing channels may be determined. Step 2150 1150 may be similar to Step 1140 of FIG. 1. A first processing channel may be determined to process a portion of the video frame that may be defined by the interesting area. Additionally or alternatively, a second processing channel may be determined in order to process another portion of the video frame that may be defined by the non-interesting area of the video frame.

In some exemplary embodiments, Step 121150 may comprise Step 121160. On Step 121160, two priority FPS parameter values may be determined. A first priority FPS parameter value may be utilized by the first processing channel in order to determine whether to process a portion defined by the area of interest. Additionally or alternatively, a second priority FPS parameter value may be determined. The second priority FPS parameter value may be utilized in order to determine whether to process another portion defined by the non-interesting area.

In some exemplary embodiments, Step 121170 may be performed for each portion of the video frame. In case that the associated priority FPS parameter value is above a threshold, Step 121180 may be performed, yielding that the portion is processed based on an associated processing channel. Additionally or alternatively, in case that the priority FPS parameter value is below a threshold, the portion may not be processed.

In some exemplary embodiments, a portion of a video frame may be processed. The portion may be defined based on the first area. Additionally or alternatively, another portion of the video frame may not be processed. The other portion may be defined based on the second area of the video frame. In those embodiments, in order to provide a processed video frame, the producer may utilize a previous portion. The previous portion may be a portion comprised by a previous video frame in the sequence of video frames. Additionally or alternatively, the previous portion may be defined based on the first area. As the first area may be associated with a same area in the video frame and in the previous video frame, a difference between the portion and the previous may be below a difference threshold. Additionally or alternatively, a visual difference between the portion and the previous portion may not be perceived by a human eye. Hence, the processed video frame may be provided, wherein another difference between the video frame and the reconstructed video frame may be below the difference threshold.

In some exemplary embodiments, determining areas of interest, as exemplified in Step 121110, may be based on an execution of an object detection algorithm. Additionally or alternatively, a face detection algorithm may be executed. Executing such algorithms may require computing resources such as Random-Access Memory (RAM), CPU, GPU, or the like. In some exemplary embodiments, detecting objects per each frame may not be feasible.

In some exemplary embodiments, the method exemplified by Figure a may be a recursive method. In those embodiments, a video frame may comprise a number of objects above a threshold, may have a size above a threshold, a footprint above a threshold, or the like. In those embodiments, a processing operation with respect to a portion may comprise performing Step 121110 and following steps with respect to the portion. Put differently, Step 121110 may be performed again, wherein the video frame is the portion.

In some exemplary embodiments, a bounding shape of an object displayed in a video frame may be determined. Additionally or alternatively, the one or more low priority portions of the video frame may comprise another bounding shape. Additionally or alternatively, the other bounding shape may comprise the representation of the non-interesting object within the video frame.

In some exemplary embodiments, in case that a size of the bounding shape is above a threshold, one or more sub-bounding shapes may be determined. A unification of the sub-bounding shapes may comprise the bounding shape. Additionally or alternatively, the bounding shape may comprise the unification. In some exemplary embodiments, one or more additional processing channels may be determined. a sub bounding shape comprised by the one or more bounding shapes may be processed based on an additional processing channel comprised by the one or more processing channels.

Referring now to FIG. 134 showing a block diagram of an apparatus, in accordance with some exemplary embodiments of the disclosed subject matter.

In some exemplary embodiments, Apparatus 13400 may be a computerized device configured to process a video frame. Additionally or alternatively, Apparatus 13400 may be configured to process a sequence of video frames.

In some exemplary embodiments, Apparatus 13400 may comprise one or more Processor(s) 13402. Processor 13402 may be a Central Processing Unit (CPU), a Central Processing Unit (GPU), a microprocessor, an electronic circuit, an Integrated Circuit (IC) or the like. Processor 13402 may be utilized to perform computations required by Apparatus 13400 or any of its subcomponents.

In some exemplary embodiments, Apparatus 13400 may comprise an Input/Output (I/O) module 13405. I/O Module 13405 may be utilized to provide an output and receive input such as, for example to receive one or more video frames from a camera, from a hard-disk, or the like, and to provide one or more processed portions of the video frames to a User Device 13480, or the like. Additionally or alternatively, I/O Module 13405 may be utilized to obtain one or more video frames from a User Device 13470. User Device 13470 may utilize Camera 13475 in order to provide one or more video frames. Additionally or alternatively, User Device 13470 may be configured to provide one or more video frames to Apparatus 13400 by utilizing Memory 13479. As an example, Memory 13479 may retain a prerecorded video, one or more photos, or the like.

In some exemplary embodiments, Apparatus 13400 may comprise Memory 13407. Memory 13407 may be a hard disk drive, a Flash disk, a Random Access Memory (RAM), a memory chip, or the like. In some exemplary embodiments, Memory 13407 may retain program code operative to cause Processor 13402 to perform or more acts associated with any of the subcomponents of Apparatus 13400.

In some exemplary embodiments, Areas Detection Module 13410 may be configured to detect one or more areas of the video frame. An area may display a portion of an object. Additionally or alternatively, the area may not display an object.

In some exemplary embodiments, Areas Detection Module 13410 may be configured to detect one or more objects displayed in the video frame, such as by using object detection algorithms or the like. In some exemplary embodiments, the one or more detected objects may define one or more areas. An area may display a portion of the one or more objects.

In some exemplary embodiments, Areas Detection Module 13410 may be configured to utilize object detection algorithms or other user information related detection algorithms, such as face detection algorithms, bird detection algorithms, or the like, in order to identify the one or more objects. As an example, it may be determined, based on the user information, that the one or more video frames are displaying a national geographic video about birds. Accordingly, a bird detection algorithm may be applied, as birds can be objects of interest in accordance with the context of the video.

Additionally or alternatively, the video frame may be comprised by a sequence of video frames. Areas Detection Module 13410 may be configured to identify the one or more objects based on a previous identification of the one or more objects or one or more objects related thereto in previous video frames. Additionally or alternatively, Areas Detection Module 13410 may be configured to detect a set of objects in the video frame that comprises the one or more objects or one or more objects related thereto, and to continuously track locations of these objects over the video frames. Additionally or alternatively, Areas Detection Module 13410 may be configured to identify objects within the video frames having an interest level above a predetermined threshold, whereby determining that they are objects of interest.

In some exemplary embodiments, based on continuously tracking locations of an object, a path of an object may be determined. Areas Detection Module may be configured to predict, based on the path, a future location of the object in one or more future video frames. A future video frame comprised by the one or more video frames may be a video frame ordered after the video frame in a sequence of video frames. Areas Detection Module 13410 may be configured to detect one or more objects in the next video frame based on one or more locations, to not utilize an object detection algorithm with respect to the next video frame, or the like. In some exemplary embodiments, the next video frame may be an un-obtained video frame, such as another video frame.

In some exemplary embodiments, determining on whether to perform or more object detection in a next video frame may be based on an average of the activity levels of the one or more objects, of the one or more objects of interest, or the like.

In some exemplary embodiments, Areas Detection Module 13410 may be configured to determine, based on one or more activity levels of one or more objects, one or more bounding shapes of the one or more objects. Additionally or alternatively, Areas Detection Module 13410 may be configured to determine the one or more bounding shapes based on one or more paths of the one or more objects. As an example, Areas Detection Module 13410 may be configured to determine a single object displaying a user head. Based on the movements of the head of the user an activity level may be determined. Based on the activity level, a bounding shape of an area displaying the head of the user may be determined. In some exemplary embodiments, the bounding shape may comprise a location displaying the head of the user in a future, an un-obtained video frame.

In some exemplary embodiments, Areas Detection Module 13410 may be configured to utilize a confidence measurement relating to each identified object. In some cases, the object detection algorithm may identify several objects in the video frame, with varying confidence measurements and sizes. Additionally or alternatively, Detection Module 13410 may select the object with the highest confidence measurement for analysis and avoid processing the remaining objects. In some cases, N objects with top confidence measurements may be processed, wherein N is a positive integer. Additionally or alternatively, other objects may not be processed. Additionally or alternatively, only objects with a confidence measurement above a threshold may be processed. Additionally or alternatively, objects with identified area below a minimal predetermined area may be ignored, such as small objects that are represented by rectangles of size 8×8 pixels, 16×16 pixels, 16×64 pixels, or the like, may be ignored and not processed.

In some exemplary embodiments, N, the number of objects to process, may be determined based on a user information. As an example, the user information may comprise a name of the application used for obtaining the video frames. Additionally or alternatively, the user information may comprise audio of a user using User Device A 13470. Additionally or alternatively, the user information may comprise a location of the user. Based on the user information it may be determined that a user is using User Device A 13470 in a park. Additionally or alternatively, it may be determined that the user is using a video chat application, running on User Device A 13470. Additionally or alternatively, it may be determined, based on the audio, that no other user is using User Device A 13470 with the user. As a result, it may be determined that N is equal to 1, yielding that only one object should be processed. It may be noted that as the user in the park there may be many objects displayed in the video frame such as 5 objects, 10 objects, or the like. The objects may be people, dogs, bicycles, trees, or the like.

It may be noted that processing an object may refer to processing a portion of the video frame comprising an image of a portion of the object.

In some exemplary embodiments, User Device B 13480 may be configured to receive the one or more processed portion, one or more encoded processed portion, or the like, from User Device B 13490, and to construct an alternative video frame based thereon. Additionally or alternatively, User Device B 13480 may display one or more alternative video frames, such as by using Screen 13485. An alternative video frame may be a result of decoding an encoded video frame, of decoding an encoded processed video frame, or the like.

In some exemplary embodiments, Priorities Determination Module 13425 may be configured to determine one or more priorities. A priority may be associated with a portion of the video frame. Additionally or alternatively, a priority may be associated with an area of the video frame. In some exemplary embodiments, a portion of the video frame that may be associated with a priority above a threshold, may be upscaled. Additionally or alternatively, in the case that the priority is below the threshold the priority may be deflated.

In some exemplary embodiments, Priorities Determination Module 13425 may comprise Interest Level Determination Module 13430. In some exemplary embodiments, an interest level may be associated with an object. An interest level above an interest threshold may yield an interesting object. In some exemplary embodiments, interesting objects may be determined based on a context information. The context information may comprise a user information. The context information may be obtained from Device 13470, from Device 13490, may be automatically determined based on the application transmitting the video (such as a video meeting from a Zoom™ application), based on the audio of the video, based on spoken phrases within the video, or the like. In some exemplary embodiments, only objects displaying a portion of an object of interest may be assigned with the priority above the interest threshold. In some exemplary embodiments, Areas Detection Module 13410 may be configured to determine one or more non-interesting areas. A non-interesting area may be an area displaying a margin of the video frame, displaying a portion of the margin, displaying a portion of an object with another priority below the interesting threshold, or the like.

In some exemplary embodiments, Interest Level Determination Module 13430 may be configured to utilize an activity level of objects, in order to determine whether an object is an object of interest. For each object in the video frame an activity level may be determined. Objects with activity level above a predetermined threshold may be objects of interest. Determining to process a portion of the video frame may be based on the activity level associated with an object displayed in the video frame.

In some exemplary embodiments, an activity level may be associated with an object. The activity level may be indicative to movements, to activity, or the like, of the object as captured by the capturing device. In some exemplary embodiments, one or more activity levels may be determined for the one or more objects. Additionally or alternatively, an activity level may be determined for a sequence of images displaying an object. In some exemplary embodiments, an activity level may represent a difference in pixels between two or more bounding shapes comprising the sequence of the image. In some exemplary embodiments, in order to determine an activity level of a video frame, a difference between the video frame and a previous video frame may be determined.

In some exemplary embodiments, determining an activity level of an object may be based on a difference between a location of the object in a current frame with respect to another location of the object in a previous video frame. Additionally or alternatively, an activity level associated with an object may be determined based on a difference in size of the object. As an example, the object may be a woman walking away from a camera. As a result, the image of the woman in the sequence of video frames may get smaller and smaller. In one case the woman may walk fast yielding a first activity level. In another case the woman may walk more slowly compared to the first case, yielding a second activity level that may be smaller than the first activity level.

In some exemplary embodiments, an Interest Level Determination Module 13430 may be configured to determine one or more interest levels of one or more areas. In some exemplary embodiments, an area displaying an object may be associated with an interest level. The interest level may be based on an interest of a user in the object. In some exemplary embodiments, the area may display a portion of the object.

In some exemplary embodiments, the interest level may be based on a portion of the object. In case that a size of the portion of the object is below a size threshold the interest level may be below an interesting threshold. The size threshold may be 16 pixels (2×8, 4×4, or the like), 20 pixels, or the like. Additionally or alternatively, the size threshold may be based on the dimensions of the video frame, such as 20%, 10%, 40%, or the like.

Additionally or alternatively, the size threshold may be a relative threshold, relative to a size of the object. The relative threshold may be 10%, 20%, or the like. In some exemplary embodiments, the interest level of the area may be based on a content of the area. As an example, an area displaying an image comprising the head of a person may be associated with a higher interest level compared to an area displaying another image comprising the shoulders of a person.

In some exemplary embodiments, a Priority FPS Parameter Value Determination Module 13440 may be configured to determine a priority FPS parameter value. In some exemplary embodiments a processing channel comprised by Processing Channels 13450 may be configured to determine, based on the processing channel parameter value, whether to process a portion. Additionally or alternatively, Areas Determination Module 13410 may be configured to determine whether to determine one or more areas in another video frame based on the priority FPS parameter value.

In some exemplary embodiments, a Portions Determination Module 13450 may be configured to determine one or more portions of the video frame. A portion of the video frame comprised by the one or more portions may be a portion of the video frame. In some exemplary embodiments, a portion may be a portion of the video frame that may be processed by utilizing a processing channel comprised by Processing Channels 13460.

In some exemplary embodiments, Portions Determination Module a 13450 may utilize, as an input, the one or more areas that may be the output of Areas Determination Module 13410. Additionally or alternatively, Portions Determination Module 13450 may be configured to utilize, as an input, the one or more priorities that may be the output of Priorities Determination Module 13425. Additionally or alternatively, Portions Determination Module 13450 may be configured to utilize, as an input, the one or more interest levels that may be the output of Interest Level Determination Module 13430. Additionally or alternatively, Portions Determination Module 13450 may be configured to utilize, as an input, a video frame. In some exemplary embodiments, Portions Determination Module 13450 may be configured to output one or more portions of the video frame as an input to one or more Processing Channels 13460.

In some exemplary embodiments, a Processing Channels Determination Module 13420 may be configured to determine one or more Processing Channels 13460. Processing Channels Determination Module 13420 may obtain, as an input, a representation of the one or more areas from Areas Detection Module 13410. Additionally or alternatively, Processing Channels Determination Module 13420 may obtain, as an input, the one or more interest levels from Interests Levels Determination Module 13430. Additionally or alternatively, Processing Channels Determination Module 13420 may be configured to utilize, as an input, one or more priorities that may be the output of Priorities Determination Module 13430. Additionally or alternatively, Processing Channels Determination Module 13420 may obtain, as an input, a context information.

In some exemplary embodiments, each area may be associated with a processing channel. For each processing channel, Processing Channels Determination Module 13420 may be configured to determine one or more processing operations. A processing operation may comprise deflating the portion, upscaling the portion, or the like.

In some exemplary embodiments, a difference of an area may be below a threshold. In those embodiments, a single portion may be associated with the area. Additionally or alternatively, in case that each area may be associated with a difference below the threshold, Portions Determination Module 13450 may not be utilized. Each area may be processed based on an associated processing channel.

In some exemplary embodiments, a dimensions threshold may be determined, obtained, or the like. In those embodiments, one or more portions may be determined based on an area that may be associated with dimensions above the dimensions threshold.

In some exemplary embodiments, determining a processing operation may be based on a context information. The context information may comprise information regarding the computerized device configured to execute the producer. As an example, in case that the context information comprises data indicative to an availability of computing resources, such as CPU, GPU, RAM, or the like, Processing Channels Determination Module 13420 may be configured to determining that the processing operation may be based on Learning-Based Upsampling. Additionally or alternatively, in case that the user information comprises data indicative to a low availability of computing resources, Processing Channels Determination Module 13420 may be configured to processing operation may be based on Nearest-neighbor Interpolation.

In some exemplary embodiments determining a processing operation may be based on an interest level associated with an object, with a portion, with an area, or the like. The portion, the object, the area, or the like, may be associated with the processing channel. As an example, a first processing channel associated with a first interesting level may be associated with a first upscale parameter. Additionally, or alternatively, a second processing channel associated with a second interesting level may be associated with a second upscale parameter. In case that the first interest level is larger than the second interest level, the first upscale parameter may be larger than the second upscale parameter.

In some exemplary embodiments, a computerized device such as User Device B 13480 may utilize a remote consumer. The remote consumer may be configured to obtain one or more processed video frames from a camera (not shown) that may be associated with user device 13480. In some exemplary embodiments, the term frames per second and the term priority FPS may be interchangeable.

Referring now to FIG. 145 showing an Apparatus 14500 utilizing Apparatus 13400 of FIG. 10. As can be seen, Apparatus 14500 may be operatively coupled with User Device A 14590. In some exemplary embodiments, Apparatus 14500 may be installed in User Device A 14590. In some exemplary embodiments,

In some exemplary embodiments, Apparatus 14500 may comprise Driver Module 14520. Driver Module 14520 may be a driver, a Device Access Layer, an OS plugin, or the like.

In some exemplary embodiments, Apparatus 14500 may comprise Memory 14507. In some exemplary embodiments, Memory 14507 may comprise Driver Module 14520. In some exemplary embodiments, an operating system (OS) may be installed on User Device A 14590. In some exemplary embodiments Driver Module 14507 may implement an API allowing the OS to discover Apparatus 13400 as a camera device.

In some exemplary embodiments, Memory 14507 may comprise Apparatus 13400, allowing the OS to execute Apparatus 13400.

In some exemplary embodiments, Memory 14507 may comprise Shared Memory 14530. In some exemplary embodiments, Apparatus 14500 may be configured to write alternative video frames to Shared Memory 14530. The alternative video frames may be outputs of Apparatus 13400. In some exemplary embodiments, the OS may utilize a video software such as Zoom®, Google Meet®, iMovie®, VideoPad®, or the like. The video software may be configured to obtain one video frame after the other from a video source. In some exemplary embodiments a user utilizing the video program may choose Apparatus 14500 as the video source. In some exemplary embodiments, the OS may provide video frames to the video software by reading the video frames from Shared Memory 14530. The OS may utilize Driver Module 14520 in order to obtain a memory address of Shared Memory 14520. Additionally or alternatively, the OS may utilize Driver Module 14520 in order to obtain another memory address of a video from in Shared Memory 14530.

In some exemplary embodiments, Apparatus M 14500 may be configured to generate an alternative interesting area. In some exemplary embodiments, one or more video frames comprised by the video stream may display an object. In some exemplary embodiments, Apparatus 14500 may be configured to identify the objects within the video frames and to determine one or more interesting areas comprises an image of the object as displayed in the one or more video frames. In some exemplary embodiments, in some exemplary embodiments, Apparatus 14500 may be configured generate a replacement to the object. An alternative interesting area determined by Apparatus 14500 may comprise the replacement. The replacement may comprise an avatar, a live avatar, or the like. In some exemplary embodiments, the replacement may move as the object move. As an example, the object may be a person. The replacement may appear to move as the person moves, appear to smile as the person smiles, appear to move the lips as the person talk and move the he/her lips, or the like.

In some exemplary embodiments, a user using User Device A 14590 may utilize a video communication software in order to communicate with another user utilizing user Device B 14580. In some exemplary embodiments, Cloud server 14550 may be a cloud server configured to obtain video frames from User Device A and provide the video frames to User Device B 14580. Apparatus 14500 may be configured to utilize Cloud server 14540 to generate the replacement. In some exemplary embodiments, generating an avatar may comprise utilizing computational resources that may not be available for User Device A 14590. Apparatus 14500 may be configured to provide one or more interesting areas to Cloud Server 14540. Additionally or alternatively, Cloud Server 14540 may be configured to generate one or more alternative interesting areas comprising the replacement. Additionally or alternatively Cloud Server 14540 may be configured to provide the interesting alternative areas to Cloud Server 14550. Additionally or alternatively, Cloud Server 14540 may be configured to provide the alternative interesting areas to User Device 14580. In some exemplary embodiments, User Device B 14580 may utilize a consumer with respect to the disclosed subject matter in order to determine one or more alternative frames comprising the one or more alternative interesting areas. An alternative video frame comprised by one or more alternative frames may display the replacement and an alternative non interesting area.

In some exemplary embodiments, Apparatus 14500 may be configured to obtain an avatar from Cloud Server 14540 and write the avatar to Shared Memory 14530 as an interesting alternative video frame.

In some exemplary embodiments, Apparatus 14540 may the replacement may be determined by upscaling an interesting area. In some exemplary embodiments, the video source may provide video frames having a number of pixels below a threshold. In some exemplary embodiments, an upscaled alternative area may be determined by enhancing the interesting area. In those embodiments, Apparatus 14540 may be configured to utilize algorithms such as Filtering with morphological operators, Histogram equalization, Noise removal using a Wiener filter, Linear contrast adjustment, Median filtering, Unsharp mask filtering, Contrast-limited adaptive histogram equalization (CLAHE), Decorrelation stretch, or the like.

In some exemplary embodiments, two processing channels may be determined. A first processing channel may be configured to provide alternative non interesting areas to Cloud Server 14550, to User Device 14580, or the like. Additionally or alternatively, a second processing channel may be determined in order to provide the interesting areas to Cloud Server 14540. Additionally or alternatively, the second processing channel may be configured to provide the alternative interesting areas to Cloud Server 14550.

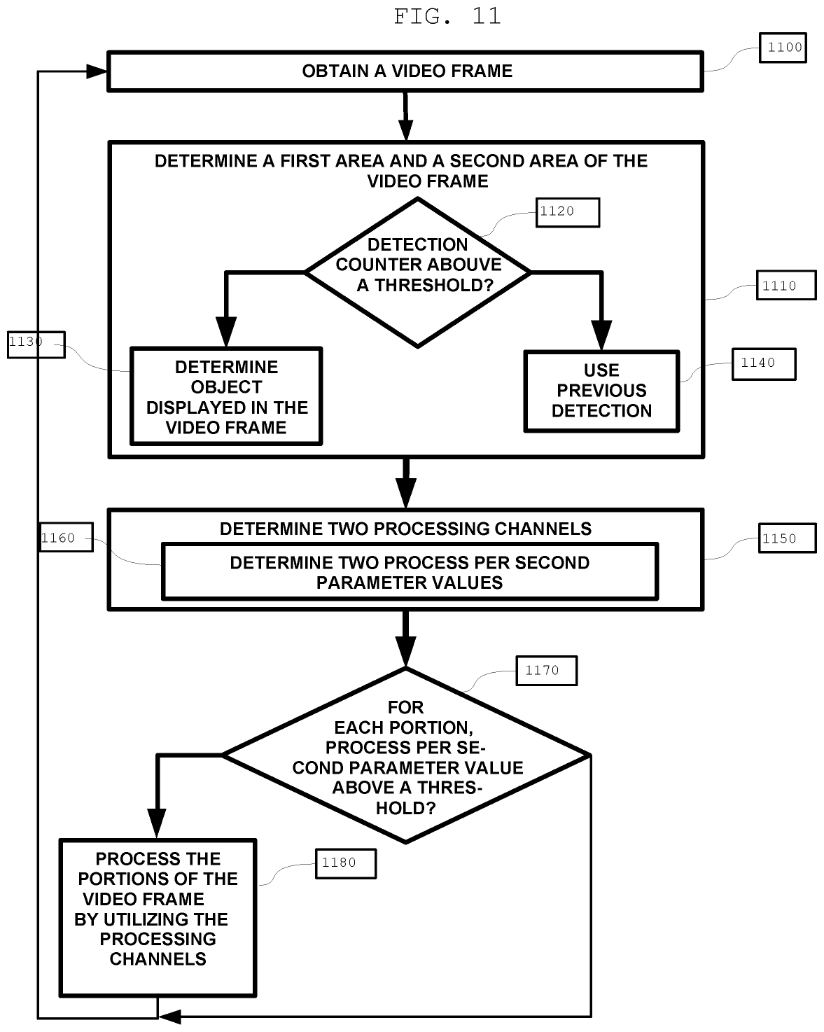

Referring now to FIG. 156, showing a flow chart of a method in accordance with the disclosed subject matter.

On Step 15610, an alternative video stream may be determined. The alternative video stream may be determined based on a video stream. In some exemplary embodiments, determining the alternative video stream may comprise performing steps 15620-15695.

On Step 15620, one or more video frames may be obtained. The video frame may be obtained from a video source, such as a camera, a light sensor, a video file, or the like. In some exemplary embodiments, one or more video frames may be obtained and written to a shared memory location as illustrated by Step 15695. In those embodiments, the one or more video frames may be one or more alternative video frames.

In some exemplary embodiments one or more video frames may be obtained and written to the shared memory location without modifications. As an example, when a user starts a video meeting, he or she may better the light, adjust the camera, or the like.

On Step 15630, a first video frame may be obtained. The first video frame may be obtained from the same video source as in Step 15620.

On Step 15640, a first interesting area may be determined. In some exemplary embodiments, the first interesting area may display an object, a portion of the object, or the like. In some exemplary embodiments, determining the first interesting area may comprised utilizing an object detection model.

On Step 15650, the first video frame may be processed. Processing the first video may yield a first interesting alternative video frame. Additionally or alternatively, processing the video frame may yield a first non-interesting alternative video frame. In some exemplary embodiments, the first interesting alternative video frame may be yielded by cropping the first video frame based on the first interesting area to a cropped video frame. In some exemplary embodiments, the first interesting alternative video frame may be of a width and of a height. Additionally or alternatively, the first interesting area may be of the width and of the height. In some exemplary embodiments, a portion of the first video frame may be upscaled. The portion may the cropped video frame.

In some exemplary embodiments, determining the first interesting area may yield a first non-interesting. In some exemplary embodiments, the first non-interesting area may be a complement of the first interesting area with in the first frame. In some exemplary embodiments, the first video frame may be processed based on the first non-interesting area may comprise deflating a portion of first video frame. The deflated portion may of same size and dimensions as the first non-interesting area. In some exemplary embodiments, processing the first video frame based on the non-interesting area may comprise setting the interesting area to a single value. As an example, the first video frame may show an image of a person. The first interesting area comprise the image of the person. Additionally or alternatively the first non-interesting area may be a margin of the first video frame. The first non-interesting alternative frame may display a deflated margin. Additionally or alternatively, the first non-interesting alternative video frame may display a single color instead of the image of the person. Additionally or alternatively, the single color may be displayed in a of a same width, height and location as the first interesting area.

On Step 15660, the first interesting alternative area may be written to a shared memory location. The shared memory location may be shared between an apparatus, such as Apparatus 14500 of FIG. 145 and between an operating system utilizing Apparatus 14500. In some exemplary embodiments, the first non-interesting alternative video frame may be written to shared memory location. in some exemplary embodiments, Step 15660 may comprise two steps. A first step to write the first interesting alternative video frame and a second step to write the first non-interesting alternative video frame. In some exemplary embodiments, the first step may be performed in a first processing channel and the second step may performed in a second processing channel. Each processing channel may be associated with a different computerized process. The first processing channel may be associated with the interesting area hence the first processing channel may be executed in a computerized processing having a first priority such as “real time” while the second processing channel may be executed in a computerized process having a “background” priority. As a result, the output of the first processing channel and the output of the second processing channel may be ready at different times. As one or more video frames may obtained, the first processing channel may process one or more video frames based on interesting areas. Additionally or alternatively, the second processing channel may process one or more video frames based on non-interesting areas. Each processing channel may write its output to the shared memory location, ensuring that an alternative video frame is always ready for the OS.

On Step 15670, a second video frame may be obtained. The second video frame may be obtained in a similar manner as the first video frame. In some exemplary embodiments, the second video frame may display the same object as the first video frame.

On Step 15675, a second interesting area may be determined. In some exemplary embodiments, a second interesting area may be determined based on the first interesting area. In some exemplary embodiments, it may be determined that the second interesting area comprises an image of the object in the second video frame. As a result, an object detection algorithm may not be utilized. In some exemplary embodiments, determining to base the determination of the second interesting area on the first interesting area may comprise obtain a context information, a suer context information, or the like. As an example, the context information may comprise an identifier of a software utilizing the disclosed subject matter, such as Zoom®, FaceTime®, or the like. The user context information may indicate that a user utilizing the video software is a professor lecturing. Additionally or alternatively, it may be determined, while analyzing the first video frame that the professor is sitting. In some exemplary embodiments, an activity level may be associated with the video stream. The activity level may be updated based on newly captured video frames. As the professor is sitting while giving a lecture it may be determined that the activity level is below a threshold. Hence it may be determined to utilize a previous detection of the object detection algorithm.

On Step 15680, the second video frame may be processed based on the second interesting area, yielding a second interesting alternative video frame. Processing the second video frame based on the second interesting area may comprise utilizing the first processing channel. Additionally or alternatively, the second video frame may be cropped based on the second interesting area. Additionally or alternatively, the cropped video frame may be upscaled.

On Step 15690, the second interesting alternative video frame may be written to the shared memory location. As a result the second alternative video frame may comprise the second interesting alternative video frame and the first non-interesting video frame.

In some exemplary embodiments, a video software utilizing the disclosed subject matter may be configured to encode the alternative video stream. Additionally or alternatively, the video software may be configured to encode the video stream in case that the disclosed subject matter is not utilized, In some exemplary embodiments, as the alternative video stream comprises less information compared to the video stream, the encoded alternative video stream may have a footprint that is 10%, 20%, 25% or the like, compared to a footprint of the encoded video stream.

The inventor made tests to the disclosed subject matter. The test comprised an implementation of the disclosed subject matter on a MacBook Air® running macOS version 12 or 134 and on Windows 10. A first test comprised utilizing a virtual camera in a zoom meeting for one minute (generating the encoded alternative video stream). The video source was Logitech Brio® 4K camera. Another test comprises a Zoom® meeting utilizing Logitech Brio® 4K camera (generating the encoded video stream). At each test the inventor captured internet packets that Zoom® sends in order to measure the footprint of the encoded streams. With bright light, the encoded alternative video stream has a footprint that is 10%-20% than the footprint of the encoded video stream.

In some exemplary embodiments, a video frame obtained from the video source may be a raw format video frame. In some exemplary embodiments the raw format may be a Y′UV format, a Y′UYV format, a Y′UV444 format, a Y′UV422 format, a Y′UV411 format, a Y′UV420p format, a Y′UV420sp format, a Y′CbCr format, or the like. In some exemplary embodiments Y′ may represent a luminance plane comprised by the video frame, a luminance channel comprised by the video frame, a luminance portion comprised by the video frame, or the like.

In some exemplary embodiments, it may be required to determine an RGB representation, an RGBA representation, a GBR representation, or the like, of the video frame in order to utilize an object detection algorithm. In some exemplary embodiments, a partial RGB/RGBA/GBR representation may be determined based on the luminance planes, thereby reducing the complexity of determining the RGB representation. Other planes comprised by the video frame may be set to a constant value such as 0, 255, or the like.

In some exemplary embodiments, there may be one or more interesting areas comprised by a video frame. In those embodiments, the non-interesting area may be the complement of a unification of the interesting areas. In some exemplary embodiments, one or more alternative interesting may be generated.

In some exemplary embodiments, another video source may be utilized. An auxiliary video frame may be obtained from the other video source. The auxiliary video frame may be utilized to determine one or more objects displayed in a video frame, to predict movements of an object, to upscale an interesting area, to calculate an activity level, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer 'ay be connected to the user's 'computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform or more aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a sequence of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform or more the specified functions or acts or carry out combinations of special purpose hardware and computer instructions.

The terminology used herein is for the purpose of describing particular embodiments only and is not intended to be limiting of the invention. As used herein, the singular one or more “a”, “an” and “the” are intended to include the plural one or more as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

An “or” used therein and/or in the claims is an inclusive or. As an example, the sentence “a priority may be based on an interest level or based on an activity level” indicates that the priority can be based on the interest level. Additionally or alternatively, the sentence indicates that the priority can be based on the activity level. Additionally or alternatively, the sentence indicates that the priority can be based on the interest level and on the activity level.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the one or more disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A virtual camera computer product retained a non-transitory computer readable medium, wherein the virtual camera is configured to:
obtain a sequence of video frames from the video source, whereby obtaining a video stream frame by frame;
generate a sequence of alternative frames, whereby generating an alternative video stream;
the virtual camera computer product is implemented using program instructions that are executable by a processor, the virtual camera computer product comprises:
an areas determination module, said area determination module is configured to:
obtain a first frame from the video source, wherein the first frame comprised by the sequence of video frames;
determine a first interesting area comprised by the first video frame, wherein the first interesting area is displaying an image of an object, whereby determining a first non-interesting area, wherein the first non-interesting area is a complement, in the first video frame, of the interesting area;
a first processing channel configured to:
process the first video frame based on the first interesting area, whereby determining a first interesting alternative frame;
write the first interesting alternative video frame to a shared memory location;
a second processing configured to:
process the first video frame based on a non-interesting area, whereby determining a first non-interesting alternative frame;
write the first non-interesting alternative video frame to the shared memory location, whereby generating the first alternative frame of the alternative video stream, wherein the video stream, when encoded, is associated with a first footprint, wherein the alternative video stream, when encoded, is associated with a second footprint, wherein the second footprint is smaller than the first footprint, wherein a video software is configured to obtain the alternative video stream frame by frame.

2. The virtual camera computer product of claim 1, wherein said configured to process the first video frame based on the interesting area comprises cropping the first video, wherein the first interesting alternative frame is of the same width and height as the first interesting area.

3. The virtual camera computer product of claim 1, wherein said configured to process the first video frame based on the interesting area comprises upscaling the first interesting area in the first video frame, wherein the first interesting alternative frame is of the same width and height as the first interesting area.

4. The virtual camera computer product of claim 1, wherein said configured to process the first video frame based on the non-interesting area comprises deflating the non-interesting area in first video frame.

5. The virtual camera computer product of claim 1, wherein said configured to process the first video frame based on the non-interesting area comprises setting the interesting area in first video frame to a single value.

6. The virtual camera computer product of claim 1, wherein a frame comprised by the video stream is of a raw video format, wherein the raw video format comprises a luminance plane, wherein said configured to determine a first interesting area comprised by the first video frame comprises:
determining, based on the luminance plane of the first video frame a partial RGB representation of the frame;
providing the partial RGB representation of the frame to an object detection model; and
obtaining from the object detection model a definition of a rectangle, wherein an image of the object displayed in the first frame is bounded by the rectangle.

7. The virtual camera computer product of claim 6, the virtual camera computer product is configured to:
obtain a second frame from the video source, wherein the second frame comprised by the sequence of video frames, wherein the second frame is ordered after the first frame in the sequence of video frames;
determine, to utilize a dimensions of the first interesting area in order to determine a second interesting area comprised by the second video frame, wherein the second interesting area is displaying another image of the object, whereby avoiding to utilize the object detection algorithm;
determine, based on the frames per seconds parameter to utilize the first non-interesting alternative frame as an alternative to determining a second non-interesting alternative video frame;
write the second interesting alternative area to the shared memory location, whereby generating a second alternative frame of the alternative video stream, wherein the second alternative frame comprises the second interesting alternative area and the first non-interesting alternative area.

8. The virtual camera computer product of claim 7, configured to:
obtain a context information, wherein the context information comprises information regarding utilization of the virtual camera computer product;
wherein said configured to determine a second interesting area comprises:
determining, based on the context information, that an activity level associated with the object is below a threshold, wherein said determine to utilize the first non-interesting alternative frame as an alternative to determining a second non-interesting alternative video frame is based on the activity level and on the threshold.

9. The virtual camera computer product of claim 7, configured to:
obtain a context information, wherein the context comprises information regarding utilization of the virtual camera computer product, wherein the second non interesting area is defined as a complement of the second interesting area;
based on the context information, determining that an activity level associated with the first non-interesting area and the second non interesting area is below a threshold; and
determine to utilize the first non-interesting area as an alternative to the second non-interesting area, whereby avoiding to determine a second non-interesting alternative video frame.

10. The virtual camera computer product of claim 6, wherein the video source is associated with a frames per seconds parameter, wherein said determining to utilize a dimensions of the first interesting area in order to determine a second interesting area is based on the frames per seconds parameter.

11. The virtual camera computer product of claim 1, wherein said area determination module is configured to obtain an auxiliary frame from an auxiliary video source; wherein said area determination module is configured to utilize the auxiliary frame to process an area of the frame.

12. The virtual camera computer program product of claim 1, wherein said first processing channel is configured to replace a person appearing in an area with an avatar.

13. The virtual camera computer program product of claim 12, wherein replacement of the person by the avatar is performed by a cloud computer, wherein the first processing channel is configured to provide the first interesting area to the cloud server, wherein the first processing channel is configured to obtain the avatar therefrom.

14. The virtual camera computer program product of claim 1, wherein said video stream is in first format, wherein said alternative video stream is in a second format, wherein the first format and the second format are different.

15. The virtual camera computer program product of claim 1, wherein the one or more video frames obtained by the area determination module are associated with a frame rate, wherein each video frame comprised by the one or more video frames is associated with a resolution, wherein the one or more alternative video frames are associated with the frame rate, wherein each video frame comprised by the one or more alternative frames is associated with the resolution, wherein encoding a plurality of video frames yields a video stream having a first footprint, wherein encoding a plurality of alternative video frames yields an alternative video stream having a second footprint, whereby the second footprint 20% or less of the first footprint.

16. A method comprising:
obtaining, by a virtual camera implemented in a computerized device, a first video frame, wherein the first video frame is comprised by a sequences of video frames;
determining a first interesting area comprised by the first video frame, wherein the first video frame comprised by the sequences of video frames, wherein the first interesting area is displaying an object, whereby determining a first non-interesting area;
processing the first video frame based on the first interesting area in a first processing channel, whereby determining a first interesting alternative video frame;
writing the first interesting alternative video frame to a shared memory location;
processing the first video frame based on the first non-interesting area in a second processing channel, whereby determining a first non-interesting alternative video frame;
writing the first non-interesting alternative video frame a shared memory location, wherein a video software is configured to utilize the first alternative video frame, wherein utilizing the first alternative video frame comprises encoding the first alternative video frame;
obtaining a second video frame from the video source, wherein the second video frame appears after first video frame in the sequence of video frames;
determining a second interesting area comprised by the second video frame, wherein the second interesting area is displaying the object;
processing the second video frame based on the second interesting area in the first processing channel, whereby determining a second interesting alternative video frame; and
writing the second interesting alternative video frame to the shared memory location, whereby the shared memory location comprises a second alternative video frame, wherein the second alternative video frame comprises the second interesting alternative video frame and the first non-interesting alternative video frame, wherein the video software is configured to utilize the second alternative video frame, wherein utilizing the second alternative video frame comprises encoding the second alternative video frame, wherein a video stream comprising the first and second video frames, when encoded, is associated with a first footprint, wherein an alternative video stream comprising the first and second alternative video frames, when encoded, is associated with a second foot print, wherein the second footprint is smaller than the first footprint.

17. The method of claim 16, wherein a video frame comprised by the sequence of video frames is of a raw format, wherein the raw format comprises a luminance plane, wherein said determining the first interesting area comprises:
determining, based on the luminance portion of the video frame, a partial Red Green Blue (RGB) representation of the first video frame;
providing the partial RGB representation of the first video frame to a computerized apparatus implementing an object detection algorithm; and
obtaining, from the apparatus a definition of a rectangle, wherein the first interesting area comprised by the rectangle.

18. The method of claim 16, wherein said processing the first video frame based on the first interesting area comprises replacing an image object with an avatar of the object.

19. The method of claim 18, wherein said replacing an image of the object with an avatar of the object comprises:
cropping the first video frame to a cropped video frame, wherein said cropping is based on the first interesting area, whereby generating a first cropped video frame;
providing the cropped video frame to a cloud server, wherein the cloud server is configured to generate an avatar based on an image; and
obtaining the avatar from the cloud server, whereby obtaining the first interesting alternative area.

20. The method of claim 16, wherein said processing the first interesting area comprises:
cropping the first video frame to a cropped video frame, wherein said cropping is based on the first interesting area, whereby generating a first cropped video frame;
upscaling the cropped video frame, whereby determining the first interesting alternative video frame, wherein the first alternative video frame is having the same dimensions as the cropped video frame.
